(19) United States
(12) Patent Application Publication
(10) Pub. No.: US 2016/0251496 A1
(43) Pub. Date: Sep. 1, 2016

(54) RESIN COMPOSITION

(71) Applicant: TEIJIN LIMITED, Osaka-shi, Osaka (JP)

(72) Inventors: Yuhei ONO, Yamaguchi (JP); Shinichiro SHOJI, Yamaguchi (JP); Masahiro IWAI, Ehime (JP); Shunsuke KANEMATSU, Yamaguchi (JP); Osamu UEMURA, Yamaguchi (JP); Masaya SHIBANO, Yamaguchi (JP); Kohei ENDO, Yamaguchi (JP)

(73) Assignee: TEIJIN LIMITED, Osaka-shi, Osaka (JP)

(21) Appl. No.: 15/029,089

(22) PCT Filed: Oct. 21, 2014
(86) PCT No.: PCT/JP2014/078428

§ 371 Date: Apr. 13, 2016

(30) Foreign Application Priority Data
Oct. 22, 2013 (JP) 2013-219256
Dec. 27, 2013 (JP) 2013-272491
Mar. 3, 2014 (JP) 2014-040435

(51) Int. Cl. C08K 5/29; C08L 67/04

(52) U.S. Cl. CPC C08K 5/29; C08L 67/04

(57) ABSTRACT

Provided are a resin composition controlled such that after keeping a shape thereof under a severe environment as in high-temperature hot water or in hot water under chemically severe condition, such as an acidic or basic condition, etc., for a fixed period of time, it is quickly decomposed; and a structure thereof.

### TECHNICAL FIELD

The present invention relates to a resin composition containing, as a main component, a water-soluble monomer and having excellent shape retention properties and hydrolysis resistance in high-temperature hot water.

### BACKGROUND ART

In recent years, from the purpose of global environmental protection, resins which are easily decomposed under the natural environment are watched and studied in the world. As the resins which are easily decomposed under the natural environment, biodegradable polymers represented by fatty acid polyesters, such as polylactic acid, polyglycolic acid, poly(3-hydroxybutyrate), polycaprolactone, etc., are known.

Above all, polylactic acid is a polymer material that is high in biological safety and environmentally friendly because it is made of, as a raw material, from lactic acid obtained from a plant-derived raw material, or a derivative thereof. For that reason, utilization as a general-purpose polymer is investigated, and utilization as films, fibers, injection molded articles, and the like is investigated.

Recently, paying attention to easy decomposability of those resins and water solubility of decomposed monomers, practical use for excavation technology in the oil field is investigated (Patent Literatures 1 to 3). In this application, it is required that after keeping the weight and shape of a resin in hot water for a fixed period of time, the resin is quickly decomposed (see FIG. 1). However, in general, since aliphatic polymers and the like are inferior in hydrolysis resistance, though they are usable up to a medium temperature of about 120° C., there is involved such a problem that they are immediately decomposed in high-temperature hot water (see FIG. 2), so that a desired performance cannot be exhibited.

Slowly decomposable resins, such as aromatic polyesters, etc., are not quickly decomposed even in hot water (see FIG. 3), and furthermore, there is involved such a problem that monomers formed through decomposition react with other components of the foregoing application and are deposited in water (Patent Literature 4).

In investigations in the past made by the present inventors, it has been found that by using a hydrolysis inhibitor having characteristic features in water resistance and reactivity with an acidic group, the resulting resin composition is quickly decomposed after keeping the weight and shape of the resin in hot water at a high temperature of 135° C. or higher for a fixed period of time.

However, with respect to the Haynesville Shale which is known as a high-temperature well, as described in the report “High-temperature drilling and completions in the Haynesville Shape”, published in 2011 by Halliburton Company (see Non-Patent Literature 1), it has 370° F. (188° C.). Then, it is considered necessary that members to be used for excavation have hot water resistance at an ultra-high temperature of 188° C. or higher. However, it was the actual situation that a resin composition and fibers exhibiting a desired performance as shown in FIG. 1 in hot water at an ultra-high temperature of 188° C. or higher for a fixed period of time while keeping the shapes thereof has not been obtained yet.

Meanwhile, in order to enhance the hydrolysis resistance of aliphatic polyesters and the like, there is already proposed a method in which a hydrolysis regulator, such as a carbodiimide compound, etc., is used, and an acidic group present initially and generated by decomposition in the resin is sealed, thereby inhibiting the hydrolysis (Patent Literatures 4 to 6).

The acidic group generated by hydrolysis of the aliphatic polyester, such as a carboxyl group, etc., becomes an autocatalyst to promote the hydrolysis, and therefore, it is confirmed that by immediately sealing this by a carbodiimide compound or the like, the hydrolysis resistance under the moist heat environment at about 50 to 120° C. is enhanced.

However, with respect to the hydrolysis inhibition in hot water at a higher temperature than 135° C., there are not made sufficient investigations from the viewpoints of resin or hydrolysis regulator.

In addition, as described in Patent Literatures 8 and 9, a technology in which a high molecular weight component and a low molecular weight component are combined and mixed under a certain condition, thereby enhancing the crystallinity is investigated, and enhancements in crystallinity, such as a crystallization speed, etc., heat resistance, and injection moldability, and applications at ordinary temperature to a relatively low temperature, such as an application to a compost use as a biodegradable resin, an application to a structure, etc., are described. However, a technology for achieving both the heat resistance and hydrolysis resistance in a high temperature region of 135° C. or higher and the strengths during, and even after the decomposition are not mentioned at all. In addition, a melting point in water exhibiting the durability in high-temperature hot water, an aspect of which is considered to be an important problem by the inventors of the present application, is not mentioned at all, too.

### CITATION LIST

### Patent Literature

Patent Literature 1: JP-A-2009-114448

Patent Literature 2: U.S. Pat. No. 7,267,170

Patent Literature 3: U.S. Pat. No. 7,228,904

Patent Literature 4: U.S. Pat. No. 7,275,596

Patent Literature 5: JP-A-2012-12560

Patent Literature 6: JP-A-2009-173582

Patent Literature 7: JP-A-2002-30208

Patent Literature 8: JP-A-2003-96285

Patent Literature 9: JP-A-2006-206868
Non-Patent Literature 1: “A CASE STUDY: High-temperature drilling and completions in the Haynesville”, [online], Halliburton Company [retrieved on Oct. 7, 2013], Internet URL: http://www.halliburton.com/public/lp/contents/Case_Histories/Web/H08637.pdf

### SUMMARY OF INVENTION

### Technical Problem

An object of a first invention of the present application is to provide a resin composition which is quickly decomposed after keeping the weight and shape in hot water at an ultra-high temperature of 188° C. or higher for a fixed period of time and a molded article made of the same.

An object of a second invention of the present application is to provide a resin composition which is quickly decomposed after keeping the weight, shape and strength of the resin in hot water at a higher temperature than 135° C. for a fixed period of time without causing melting or fusion between resins.

### Solution to Problem

The present inventors made extensive and intensive investigations regarding a resin composition which is quickly decomposed after keeping the weight and shape in hot water at an ultra-high temperature of 188° C. or higher for a fixed period of time.

As a result, it has been found that polylactic acid containing a stereocomplex crystal phase (hereinafter sometimes abbreviated to simply as “stereocomplex polylactic acid”) exhibits different values between a melting point in water and a melting point in nitrogen; that the melting point in water exhibits a lower value by about 30° C. than the melting point in nitrogen; and that regulation of this melting point in water to 188° C. or higher is effective for shape retention properties in hot water at an ultra-high temperature of 188° C. or higher.

Furthermore, it has also been found that in order to keep a concentration of an acidic group low during a target time at an ultra-high temperature of 188° C. or higher, it is necessary to add a hydrolysis regulator in a high concentration; however, the melting point of the stereocomplex polylactic acid is also decreased by several ° C.

Meanwhile, the stereocomplex polylactic acid is a material suited for the present use from the viewpoints of easy decomposability, water solubility of decomposed monomers, and heat resistance. However, from the viewpoint of formability at the time of processing of spinning or the like, it was necessary to make a stereocomplex crystallization degree to 100%, and in order to stably forma stereocomplex crystal phase, it was necessary to make an isotactic number-average chain length to less than 50. But, in that case, since a maximum size at which the stereocomplex crystal phase is able to grow is restricted, an upper limit of the melting point in water is about 185° C., and the heat resistance at 188° C. which is considered necessary for the present use could not be realized.

Meanwhile, in the case of making the isotactic number-average chain length to 50 or more, its melting point tends to become high; however, there was involved such a problem that the formability is remarkably deteriorated.

Then, the present inventors further made extensive and intensive investigations. As a result, it has been found that even in stereocomplex polylactic acid having an isotactic number-average chain length of 50 or more, by adding a hydrolysis regulator having plasticity in a specified amount or more, it is possible to allow MFR to fall within a fixed range, whereby its formability is conspicuously improved, leading to the present invention.

Specifically, it is possible to achieve the first object of the present invention by the following.

(1) A resin composition containing polylactic acid containing a stereocomplex crystal phase (component A), an isotactic average chain length (Lᵢ) of which is 50 to 200, in an amount of 70 to 97% by weight on a basis of the whole weight, the resin composition further containing a hydrolysis regulator (component B) in an amount of 3 to 20 parts by weight on a basis of the whole weight and simultaneously satisfying the following requirements (A) to (C):

(A) MFR is in the range of 60 to 300;

(B) A melting point in water (Tmsw) is 188° C. or higher;

and

(C) In hot water at 188° C., a weight of a water-insoluble matter of the resin composition after 1 hour is 50% or more, and a weight of a water-insoluble matter of the resin composition after 6 hours is less than 50%.

In addition, the following are also included in the present invention.

(2) The resin composition as set forth above in (1), further satisfying the following requirement (D):

(D) A weight average molecular weight of the polylactic acid containing a stereocomplex crystal phase (component A) is in the range of 70,000 to 300,000.

(3) The resin composition as set forth above in (1) or (2), wherein a stereocomplex crystallization degree (S) is 5% or more.
(4) The resin composition as set forth above in any one of (1) to (3), wherein the polylactic acid containing a stereocomplex crystal phase (component A) is a composition of poly(L-lactic acid) having an optical purity of 98% or more and poly(D-lactic acid) having an optical purity of 98% or more.
(5) The resin composition as set forth above in any one of (1) to (4), wherein a stereocomplex crystallization rate (Cs) is 10 to 99.9%.
(6) The resin composition as set forth above in any one of (1) to (5), wherein the hydrolysis regulator (component B) is a carbodiimide compound.
(7) The resin composition as set forth above in (6), wherein the hydrolysis regulator (component B) is a carbodiimide compound represented by the following formula:

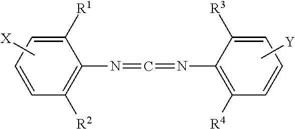

(In the formula, each of R¹ to R⁴ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure.)
(8) The resin composition as set forth above in (7), wherein the hydrolysis regulator (component B) is bis(2,6-diisopropylphenyl)carbodiimide.
(9) A molded article comprising the resin composition as set forth above in any one of (1) to (8).
(10) The molded article as set forth above in (9), wherein a shape thereof is a fiber.

In addition, the present inventors also made extensive and intensive investigations regarding a resin composition which is quickly decomposed after keeping the weight, shape and strength of the resin in hot water at a higher temperature than 135° C., particularly hot water at 180° C. or higher for a fixed period of time without causing melting or fusion between resins.

As a result, it has been found that in an aliphatic polyester containing, as a main component, a water-soluble monomer, in which an optical isomer is present, in the case where a resin having autocatalysis, in which a high molecular weight aliphatic polyester and a low molecular weight polyester which are in a relation of optical isomers with each other are combined and highly crystallized, is used, thereby enabling a concentration of an acidic group to be kept low, not only the melting of the resin and the fusion between the resins are not caused during that time, but also since the hydrolysis is suppressed, and a reduction of the molecular weight becomes gentle, the weight, shape and strength are kept, and at the point of time when the concentration of an acidic group cannot be kept low, the decomposition of the resin is rapidly promoted (see FIG. 4).

In addition, it has been found that by using a hydrolysis regulator having a water resistance at 120° C. of 95% or more and a reactivity with an acidic group at 190° C. of 50% or more for sealing the acidic group, the concentration of an acidic group can be efficiently kept low in hot water at a higher temperature than 135° C., and a timing of rapid decomposition of the resin can be controlled according to its addition amount.

That is, it has been found that by compounding a resin containing, as a main component, a water-soluble monomer and having autocatalysis and a hydrolysis regulator having a water resistance at 120° C. of 95% or more and a reactivity with an acidic group at 190° C. of 50% or more, the resultant is quickly decomposed after keeping the weight, shape and strength of a resin in hot water at a higher temperature than 135° C. for a fixed period of time.

Furthermore, even if the decomposition in high-temperature hot water is suppressed to keep the shape appropriate, when the composition is melted, or the compositions are fused with each other, the original performance cannot be exhibited. Thus, it was necessary to use a composition having a high melting point and a high crystallinity, in which a high molecular weight aliphatic polyester is combined with a low molecular weight aliphatic polyester.

As a result of extensive and intensive investigations, it has been found that it is appropriate to allow an average molecular weight of the low molecular weight component of the aliphatic polyester to fall within the range of 20,000 to 100,000 in terms of a weight average molecular weight. Furthermore, when the average molecular weight is about 50,000, the melting point of the composition becomes maximum, and hence, the average molecular weight is preferably 30,000 to 80,000 from the viewpoint of high melting point.

Meanwhile, as the decomposition of the composition is advanced in high-temperature hot water, the average molecular weight of the composition is decreased, and a reduction of the strength is remarkable. Thus, it is preferred that an initial molecular weight of the composition is higher. For that reason, it is preferred to make the molecular weight of the high molecular weight component of the aliphatic polyester to be combined high as 120,000 to 1,000,000.

Furthermore, in the case where the molecular weight of the high molecular weight component (component AA) is relatively low, it is not necessary to make the molecular weight of the component BB low so much; however, in order to keep the crystallinity, a ratio of (AA)/(BB) is desirably 1.2 or more.

In the light of the above, it has been found that in order to keep the crystallinity and the shape and strength in high-temperature hot water, it is effective to combine a high molecular weight component and a low molecular weight component, leading to accomplishment of the following second invention of the present application.

(11) A resin composition containing a resin containing a water-soluble monomer and having autocatalysis (component CC), which is obtained by mixing, as a high molecular weight component, an aliphatic polyester (component AA) having a weight average molecular weight of 120,000 to 1,000,000 and, as a low molecular weight component, an aliphatic polyester (component BB) having a weight average molecular weight of 20,000 to 100,000 in a compounding ratio of (AA)/(BB) of 90/10 to 10/90, and a hydrolysis regulator (component DD), the resin composition satisfying any one of the following AA1 to AA3:
AA1: In hot water at an arbitrary temperature of 135° C. to 160° C., after 3 hours, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less;
AA2: In hot water at an arbitrary temperature of 160° C. to 180° C., after 2 hours, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less; and
AA3: In hot water at an arbitrary temperature of 180° C. to 220° C., after 1 hour, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less.
(12) The resin composition as set forth above in (11), wherein the component DD has a water resistance at 120° C. of 95% or more and a reactivity with an acidic group at 190° C. of 50% or more.
(13) The resin composition as set forth above in (11) or (12), wherein in hot water at an arbitrary temperature of 135° C. to 220° C., after 100 hours, the weight of the water-insoluble matter of the resin composition is 10% or less.
(14) The resin composition as set forth above in any one of (11) to (13), wherein a heat deformation temperature of the resin composition is 135° C. to 300° C.
(15) The resin composition as set forth above in (14), wherein a main chain of the component CC is composed mainly of a lactic acid unit represented by the following formula:

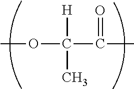

(16) The resin composition as set forth above in (15), wherein the component CC contains a stereocomplex phase formed of poly(L-lactic acid) and poly(D-lactic acid).
(17) The resin composition as set forth above in (16), having a melting point in water of 190° C. or higher.
(18) The resin composition as set forth above in any one of (11) to (17), wherein the component DD is a carbodiimide compound.
(19) The resin composition as set forth above in (18), wherein the component DD is a carbodiimide compound represented by the following formula:

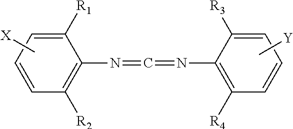

(In the formula, each of R₁ to R₄ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure.)

### Advantageous Effects of Invention

The resin composition and fibers obtained by the first invention of the present application can be quickly decomposed after keeping the weight and shape in hot water at an ultra-high temperature of 188° C. or higher for a fixed period of time.

Furthermore, since the stereocomplex polylactic acid is used, the resin composition is efficiently dissolved in high-temperature hot water after decomposition, and it is possible to significantly reduce deposition or the like to be caused due to a reaction with other component, which is considered problematic in a part of aromatic polyesters. In addition, a timing of decomposition in high-temperature hot water can be controlled according to the addition amount of the hydrolysis regulator.

For that reason, the resin composition of the present invention exhibits a performance in a well at an ultra-high temperature of 188° C. or higher in the oil field and can be suitably used as molded articles of this application, especially fibers.

The resin composition of the second invention of the present application can be quickly decomposed after keeping the weight, shape and strength of the resin in hot water at a higher temperature than 135° C. for a fixed period of time.

Furthermore, since the resin containing, as a main component, a water-soluble monomer and having autocatalysis is used, the resin composition is efficiently dissolved in high-temperature hot water after decomposition, and it is possible to significantly reduce deposition or the like to be caused due to a reaction with other component, which is considered to be problematic in apart of aromatic polyesters. In addition, by using the hydrolysis regulator having a water resistance at 120° C. of 95% or more and a reactivity with an acidic group at 190° C. of 50% or more for sealing the acidic group, the decomposition can be steadily suppressed, and a timing of decomposition of the resin in high-temperature hot water can be controlled according to the addition amount of the hydrolysis regulator.

For that reason, the resin composition of the present invention exhibits a desired performance in the excavation technology in the oil field and can be suitably used as resin molded articles of this application, especially fibers.

### BRIEF DESCRIPTION OF DRAWINGS

FIG. 1 is an image view in which in the case of using a resin in hot water at an ultra-high temperature of 188° C. or higher, the resin is quickly decomposed after keeping the weight and shape of the resin for a fixed period of time and shows a behavior which is achieved in the resin composition of the present invention.

FIG. 2 is an image view in which in the case of using a resin in hot water at an ultra-high temperature of 188° C. or higher, decomposition is rapidly advanced from the early stage and is concerned with a behavior in a general aliphatic polyester.

FIG. 3 is an image view in which in the case of using a resin in hot water at an ultra-high temperature of 188° C. or higher, decomposition is rapidly advanced from the early stage and is concerned with a behavior in a general aromatic polyester.

FIG. 4 is an image view in which in the case of using a resin in hot water at an ultra-high temperature of 188° C. or higher, changes in a molecular weight (m) and an acidic group amount (g) necessary for achieving a behavior of a change of a weight (w) of the resin as in FIG. 1 are expressed and is concerned with a behavior which is achieved in the resin composition of the present invention.

FIG. 5 is an image view in which in the case of using a resin in hot water at a higher temperature than 135° C., the resin is quickly decomposed after keeping the weight and shape of the resin for a fixed period of time and is concerned with a behavior which is achieved in the resin composition of present invention.

FIG. 6 is an image view in which in the case of using a resin in hot water at a higher temperature than 135° C., decomposition is rapidly advanced from the early stage and is concerned with a behavior in a general aliphatic polyester.

FIG. 7 is an image view in which in the case of using a resin in hot water at a higher temperature than 135° C., decomposition is rapidly advanced from the early stage and is concerned with a behavior in a general aromatic polyester.

FIG. 8 is an image view in which in the case of using a resin in hot water at a higher temperature than 135° C., changes in a molecular weight (m) and an acidic group amount (g) necessary for achieving a behavior of a change of a weight (w) of the resin as in FIG. 5 are expressed and is concerned with a behavior which is achieved in the resin composition of the present application.

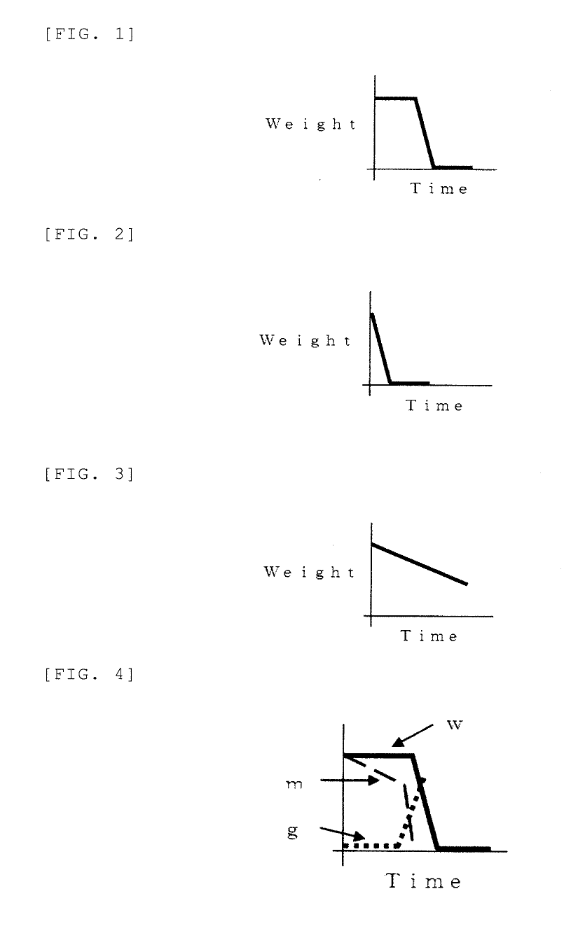

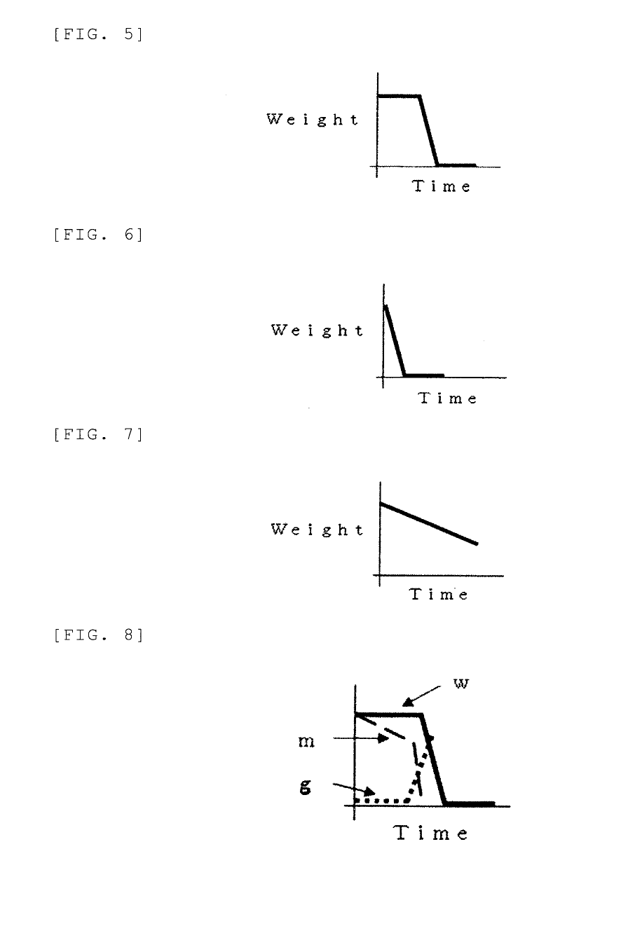

### DESCRIPTION OF EMBODIMENTS

The first invention of the present application is hereunder explained in detail.

### <Polylactic Acid Containing a Stereocomplex Phase (Component A)>

The polylactic acid containing a stereocomplex phase (component A) of the present invention (hereinafter sometimes referred to simply as “polylactic acid (A) component”) is mainly composed of an L-lactic acid unit and a D-lactic acid unit. A proportion of other unit constituting the main chain is in the range of preferably 0 to 10 mol %, more preferably 0 to 5 mol %, and still more preferably 0 to 2 mol %.

Examples of the other unit constituting the main chain include units derived from a dicarboxylic acid, a polyhydric alcohol, a hydroxycarboxylic acid, a lactone, or the like.

Examples of the dicarboxylic acid include succinic acid, adipic acid, azelaic acid, sebacic acid, terephthalic acid, isophthalic acid, and the like. Examples of the polyhydric alcohol include aliphatic polyhydric alcohols, such as ethylene glycol, propylene glycol, butanediol, pentanediol, hexanediol, octanediol, glycerin, sorbitan, neopentyl glycol, diethylene glycol, triethylene glycol, polyethylene glycol, polypropylene glycol, etc.; aromatic polyhydric alcohols, such as bisphenol having ethylene oxide added thereto, etc.; and the like. Examples of the hydroxycarboxylic acid include glycolic acid, hydroxybutyric acid, and the like. Examples of the lactone include glycolide, ε-caprolactone, β-propiolactone, δ-butyrolactone, β- or γ-butyrolactone, pivalolactone, δ-valerolactone, and the like.

An isotactic number-average chain length (Lᵢ) of the polylactic acid (component A) is 50 to 200, preferably 51 to 150, more preferably 52 to 120, and still more preferably 55 to 100. In the case where the isotactic number-average chain length (Lᵢ) of the polylactic acid (component A) is less than 50, a melting point of the stereocomplex crystal phase becomes low, whereas in the case where it is more than 200, it becomes difficult to form the stereocomplex crystal phase.

The isotactic number-average chain length (Lᵢ) is a value defined by the following formula (I) in accordance with Polymer, 33, 2817 (1992) from area ratios (Iᵢᵢᵢ, Iᵢₛᵢ, Iₛᵢᵢ, Iᵢᵢₛ, Iₛᵢₛ, Iₛₛᵢ, Iᵢₛₛ, and Iₛₛₛ) of peaks of a tetrad structure of CH carbons of polylactic acid, which are attributed in accordance with Makromol. Chem., 191, 2287 (1990). “i” indicates an isotactic sequence (LL, DD), and “s” indicates a syndiotactic sequence (LD, DL).

Lᵢ=(3Iᵢᵢᵢ+2Iᵢₛᵢ+2Iₛᵢᵢ+2Iᵢᵢₛ+Iₛᵢₛ+Iₛₛᵢ+Iᵢₛₛ)/(Iᵢₛᵢ+Iᵢᵢₛ+Iₛᵢᵢ+2Iₛᵢₛ+2Iₛₛᵢ+2Iᵢₛₛ+3Iₛₛₛ)+1 (I)

In order to make both hot water durability and formability of a molded article compatible with each other, a weight average molecular weight of the polylactic acid (component A) is in the range of preferably 70,000 to 300,000, more preferably 80,000 to 200,000, still more preferably 90,000 to 180,000, and most preferably 100,000 to 160,000. The weight average molecular weight is a value obtained by measurement by means of gel permeation chromatography (GPC) and conversion into standard polystyrene.

From the viewpoint of keeping the weight after a hot water test, it is preferred that the molecular weight of the polylactic acid (component A) is higher; however, in the case where the molecular weight is high, MFR of the resin composition becomes small. Since the polylactic acid of the present invention is also long in the isotactic number-average chain length, in particular, the fluidity is deteriorated; however, by adding the hydrolysis regulator having a plasticizing effect in an amount of 3 parts by weight or more, its formability is drastically improved.

The melting point of the polylactic acid in water is defined below through measurement by a differential scanning calorimeter (DSC) in a state where a sample is dipped in water and hermetically sealed.

Melting point (Tmsw) of a stereocomplex crystal phase in water: a peak temperature of a peak having largest melting enthalpy heat among peaks having a peak top in the range of 160 to 210° C.

Melting point (Tmhw) of a homogeneous crystal phase in water: a peak temperature of a peak having largest melting enthalpy among peaks having a peak top in the range of 120 to 159° C.

Meanwhile, the melting point in nitrogen is defined below through measurement by a differential scanning calorimeter (DSC) in nitrogen atmosphere.

Melting point (Tmsn) of a stereocomplex crystal phase in nitrogen: a peak temperature of a peak having largest melting enthalpy among peaks having a peak top in the range of 190 to 240° C.

Melting point (Tmhn) of a homogeneous crystal phase in nitrogen: a peak temperature of a peak having largest melting enthalpy among peaks having a peak top in the range of 150 to 189° C.

The melting point (Tmsw) of the stereocomplex crystal phase in water is preferably 188° C. or higher, more preferably 189° C. or higher, still more preferably 190° C. or higher, and most preferably 191° C. or higher.

A stereocomplex crystallization degree (S) is preferably 5% or more, more preferably 10% or more, still more preferably 15% or more, and most preferably 20% or more. In the case where the stereocomplex crystallization degree (S) is lower than the foregoing range, there may be the case where the shape retention properties at high temperatures are deteriorated.

A stereocomplex crystallization rate (Cs) is preferably 10 to 99.9%, more preferably 20 to 99.5%, still more preferably 30 to 99%, and most preferably 30 to 98%. In the case where the stereocomplex crystallization rate (Cs) is lower than the foregoing range, there may be the case where on the occasion when the homogenous crystal phase having a lower melting point than the stereocomplex crystal phase is melted, the shape cannot be retained, whereas in the case where it is higher than the foregoing range, there may be the case where the stereocomplex crystal phase having a high melting point cannot be obtained, and the shape retention properties at high temperatures are deteriorated.

In the polylactic acid (component A), a weight ratio of poly(D-lactic acid) to poly(L-lactic acid) is in the range of preferably 90/10 to 10/90, more preferably 80/20 to 20/80, still more preferably 30/70 to 70/30, and especially preferably 40/60 to 60/40. Theoretically, it is preferred that the weight ratio is close to 1/1 as far as possible.

The poly(L-lactic acid) and poly(D-lactic acid) can be produced by a conventionally known method. For example, the poly(L-lactic acid) and poly(D-lactic acid) can be produced by subjecting L-lactide or D-lactide to ring-opening polymerization, respectively in the presence of a metal-containing catalyst. The poly(L-lactic acid) and poly(D-lactic acid) can also be produced by subjecting a low-molecular weight polylactic acid containing a metal-containing catalyst, after being optionally crystallized or without being crystallized, to solid-phase polymerization under reduced pressure or by pressurization from atmospheric pressure in the presence or absence of an inert gas stream. Furthermore, the poly(L-lactic acid) and poly(D-lactic acid) can be produced by a direct polymerization method of subjecting lactic acid to dehydration condensation in the presence or absence of an organic solvent.

The polymerization reaction can be carried out in a conventionally known reaction vessel, and for example, in the ring-opening polymerization or direct polymerization method, a vertical reactor or horizontal reactor equipped with a high viscosity stirring blade, such as a helical ribbon blade, etc., can be used alone or in parallel. All of a batch type, a continuous type, and a semi-batch type may be used, or these may be combined.

An alcohol may be used as a polymerization initiator. It is preferred that such an alcohol does not hinder the polymerization of polylactic acid and is nonvolatile, and for example, decanol, dodecanol, tetradecanol, hexadecanol, octadecanol, ethylene glycol, trimethylolpropane, pentaerythritol, or the like can be suitably used. It may be said that an embodiment in which the polylactic acid prepolymer used in the solid-phase polymerization method is previously crystallized is preferred from the standpoint of preventing the fusion of resin pellets. The prepolymer is polymerized in a state of solid at a temperature in the range of a glass transition temperature of the prepolymer or higher and lower than a melting point thereof in a fixed vertical reaction vessel or horizontal reaction vessel, or a reaction vessel (rotary kiln, etc.) in which the vessel itself rotates, such as a tumbler or a kiln.

Examples of the metal-containing catalyst include fatty acid salts, carbonates, sulfates, phosphates, oxides, hydroxides, halides, alcoholates, and like of an alkali metal, an alkaline earth metal, a rare-earth element, a transition metal, aluminum, germanium, tin, antimony, titanium, etc. Above all, fatty acid salts, carbonates, sulfates, phosphates, oxides, hydroxides, halides, and alcoholates containing at least one metal selected from tin, aluminum, zinc, calcium, titanium, germanium, manganese, magnesium, and a rare-earth element are preferred.

Specifically, from the standpoints of catalytic activity and less occurrence of a side reaction, tin-containing compounds, such as stannous chloride, stannous boride, stannous iodide, stannous sulfate, stannic oxide, tin myristate, tin octylate, tin stearate, tetraphenyltin, etc., are exemplified as a preferred catalyst. Above all, tin(II) compounds, specifically diethoxytin, dinonyloxytin, tin(II) myristate, tin(II) octylate, tin(II) stearate, tin(II) chloride, and the like, are suitably exemplified.

A use amount of the catalyst is 0.42×10⁻⁴ to 100×10⁻⁴ (mol) per kg of the lactide, and furthermore, taking into consideration the reactivity, the color tone of the obtained polylactide, and the stability, the catalyst is used in an amount of preferably 1.68×10⁻⁴ to 42.1×10⁻⁴ (mol), and especially preferably 2.53×10⁻⁴ to 16.8×10⁻⁴ (mol).

It is preferred that the metal-containing catalyst used for the polymerization of polylactic acid is inactivated with a conventionally known deactivator prior to the use for polylactic acid. Examples of such a deactivator include organic ligands consisting of a group of chelate ligands having an imino group and capable of coordinating to the polymerization metal catalyst.

Low oxidation number phosphoric acids having an acid number of 5 or less, such as dihydride oxophosphoric acid (I), dihydride tetraoxodiphosphoric acid (II, II), hydride trioxophosphoric acid (III), dihydride pentaoxodiphosphoric acid (III), hydride pentaoxodiphosphoric acid (II, IV), dodecaoxohexaphosphoric acid (III), hydride octaoxotriphosphoric acid (III, IV, IV), octaoxotriphosphoric acid (IV, III, IV), hydride hexaoxodiphosphoric acid (III, V), hexaoxodiphosphoric acid (IV), decaoxotetraphosphoric acid (IV), hendecaoxotetraphosphoric acid (IV), and enneaoxotriphosphoric acid (V, IV, IV), etc., are also exemplified.

Orthophosphoric acids represented by the formula: xH₂O.yP₂O₅ and satisfying x/y=3 are also exemplified. Polyphosphoric acids called “diphosphoric acid, triphosphoric acid, tetraphosphoric acid, pentaphosphoric acid, and the like” according to the degree of condensation and satisfying (2>x/y>1), and mixtures thereof are also exemplified. Metaphosphoric acids satisfying x/y=1, especially trimetaphosphoric acid and tetrametaphosphoric acid are also exemplified. Ultraphosphoric acids having a network structure in which a part of the phosphorus pentoxide structure remains and satisfying (1>x/y>0) (may be collectively referred to as “metaphosphoric acid-based compounds”) are also exemplified. Acidic salts of these acids are also exemplified. Partial esters or whole esters of such an acid with a monohydric or polyhydric alcohol, or a polyalkylene glycol are also exemplified.

Phosphono-substituted lower aliphatic carboxylic acid derivatives of these acids, and the like are also exemplified. Above of all, dihexylphosphonoethyl acetate (hereinafter sometimes abbreviated as DHPA) of a phosphono-substituted lower aliphatic carboxylic acid derivative, and the like are suitably used.

From the standpoint of catalyst deactivation ability, orthophosphoric acids represented by the formula: xH₂OyP₂O₅ and satisfying x/y=3 are preferred. Polyphosphoric acids called “diphosphoric acid, triphosphoric acid, tetraphosphoric acid, pentaphosphoric acid, and the like” according to the degree of condensation and satisfying (2>x/y>1), and mixtures thereof are also preferred. Metaphosphoric acids satisfying x/y=1, especially trimetaphosphoric acid and tetrametaphosphoric acid are also preferred. Ultraphosphoric acids having a network structure in which a part of the phosphorus pentoxide structure remains and satisfying (1>x/y>0) (may be collectively referred to as “metaphosphoric acid-based compounds”) are also preferred. Acidic salts of these acids are also preferred. Partial esters of such an acid with a monohydric or polyhydric alcohol, or a polyalkylene glycol are also preferred.

The metaphosphoric acid-based compound which is used in the present invention includes cyclic metaphosphoric acids in which about 3 to 200 phosphoric acid units are condensed, ultra-region metaphosphoric acids having a three-dimensional network structure, and alkali metal salts, alkaline earth metal salts, and onium salts thereof. Above of all, cyclic sodium metaphosphate, ultra-region sodium metaphosphate, dihexylphosphonoethyl acetate (hereinafter sometimes abbreviated as DHPA) of a phosphono-substituted lower aliphatic carboxylic acid derivative, and the like are suitably used.

The polylactic acid is preferably one having a lactide content of 5,000 ppm or less. The lactide contained in the polylactic acid deteriorates the resin and worsens the color tone at the time of melting processing, and as the case may be, there is a concern that it makes the resin unusable as a product.

Although the poly(L-lactic acid) and/or poly(D-lactic acid) immediately after melt ring-opening polymerization generally contains 1 to 5% by weight of the lactide, the content of lactide can be reduced to a preferred range in any stage between the end of polymerization of poly(L-lactic acid) and/or poly(D-lactic acid) and molding of polylactic acid by carrying out conventionally known lactide reduction methods, namely, a vacuum devolatilization method with a single-screw or multi-screw extruder, or a high-vacuum treatment within a polymerizer, or the like alone or in combination. The lower the lactide content, the more enhanced the melt stability and moist heat stability of the resin. However, since the lactide has such an advantage that it reduces the melt viscosity of the resin, it is rational and economical to set the lactide content to a value suitable for a desired purpose.

An optical purity of each of poly(L-lactic acid) and poly(D-lactic acid) constituting the polylactic acid (component A) is preferably 98% or more, more preferably 98.5% or more, still more preferably 99% or more, and most preferably 99.5% or more. In the case where the optical purity is low, there may be the case where the isotactic number-average chain length does not become long, so that the stereocomplex crystal phase having a high melting point cannot be obtained.

When the optical purity is higher, the melting point of the stereocomplex crystal phase obtained by DSC tends to become high, and it is preferably 165° C. or higher, more preferably 170° C. or higher, still more preferably 173° C. or higher, and most preferably 175° C. or higher.

The stereocomplex polylactic acid can be obtained by bringing poly(L-lactic acid) and poly(D-lactic acid) into contact with each other in a weight ratio in the range of 10/90 to 90/10, preferably bringing them into melt contact with each other, and more preferably melt kneading them together. A contact temperature is in the range of preferably 220 to 310° C., more preferably 225 to 300° C., and still more preferably 230 to 290° C. from the viewpoints of enhancements of the stability at the time of melting of polylactic acid and the stereocomplex crystallization degree.

Although the melt kneading method is not particularly limited, a conventionally known batch type or continuous type melt mixer is preferably used. For example, a melt stirring tank, a single-screw or double-screw extruder, a kneader, an anaxial basket-type stirring tank, “VIBOLAC (registered trademark)”, manufactured by Sumitomo Heavy Industries, Inc., N-SCR, manufactured by Mitsubishi Heavy Industries, Ltd., a spectacle blade, a lattice blade, or a Kenix type stirrer, manufactured by Hitachi, Ltd., or a tubular polymerizer equipped with a Sulzer SMLX type static mixer can be used. Above all, an anaxial basket type stirring tank that is a self-cleaning type polymerizer, N-SCR, a double-screw extruder, and the like are preferred from the viewpoint of productivity and quality, especially color tone of the polylactic acid.

### <Hydrolysis Regulator (Component B)>

In the present invention, the hydrolysis regulator (component B) is an agent for sealing an end group of the resin (component A) and an acidic group generated by decomposition. That is, the hydrolysis regulator (component B) is an agent having an effect for inhibiting the autocatalysis of the resin (component A) to delay the hydrolysis.

As the acidic group, at least one member selected from the group consisting of a carboxyl group, a sulfonic acid group, a sulfinic acid group, a phosphonic acid group, and a phosphinic acid group is exemplified. In the present invention, a carboxyl group is especially exemplified.

It is preferred that the component B has a water resistance at 120° C. of 95% or more and a reactivity with an acidic group at 190° C. of 50% or more.

The water resistance at 120° C. as referred to herein is, for example, a value expressed by the following equation by using (1) a calculated value of an agent remaining without being changed 5 hours after the treatment, the value being calculated by means of analysis of a dissolved portion at the time of adding 2 g of water to a system having 1 g of the component B dissolved in 50 mL of dimethyl sulfoxide and stirring the resultant at 120° C. for 5 hours while refluxing, or (2) a calculated value determined by performing the same treatment as that in the foregoing (1) using a solvent capable of dissolving the component B therein and having hydrophilicity in the case where the component B is not soluble in dimethyl sulfoxide.

Water resistance (%)=[(Amount of the agent 5 hours after the treatment)/(Initial amount of the agent)]×100

Incidentally, in (2), when a boiling point of the solvent to be used is lower than 120° C., the solvent was mixed with dimethyl sulfoxide in a range where at least a part of the component B is soluble therein, and 50 mL of the mixed solvent was used. Although a mixing proportion may be generally selected within the range of 1/2 to 2/1, it is not particularly limited so long as the above-described requirement is satisfied. In general, so long as the solvent which is used in (2) is selected from tetrahydrofuran, N,N-dimethylformamide, and ethyl acetate, the component B is soluble therein.

Besides, the water resistance may also be expressed by an equivalent evaluation.

In the case of evaluating an instable agent for the water resistance, a part of the agent is denatured by the hydrolysis, and the sealing ability of the acidic group is lowered. In the case of using such an agent in high-temperature hot water, the agent is deactivated by the water, and the ability for sealing the target acidic group is remarkably lowered. In view of the foregoing, the water resistance at 120° C. is more preferably 97% or more, still more preferably 99% or more, and especially preferably 99.9% or more. That is, when the water resistance is 99.9% or more, namely the agent is stable in high-temperature hot water, the reaction with the acidic group can be performed selectively and efficiently.

The reactivity with an acidic group at 190° C. as referred to herein is, for example, a value obtained by measuring a carboxyl group concentration regarding a resin composition obtained by adding the agent in an amount such that the group of the hydrolysis regulator, reacting with the carboxyl group, is corresponding to 1.5 equivalents to the carboxyl group concentration of the polylactic acid for evaluation to 100 parts by weight of the polylactic acid for evaluation, followed by melt kneading under a nitrogen atmosphere at a resin temperature of 190° C. and at a rotation rate of 30 rpm for 1 minute by using a Labo Plasto mill (manufactured by Toyo Seiki Seisaku-Sho, Ltd.), the value being given according to the following equation.

Reactivity (%)=[{(Carboxyl group concentration of polylactic acid for evaluation)−(Carboxyl group concentration of resin composition)}/(Carboxyl group concentration of polylactic acid for evaluation)]×100

The polylactic acid for evaluation is preferably one having an MW of 120,000 to 200,000 and a carboxyl group concentration of 10 to 30 equivalents/ton. As such polylactic acid, for example, polylactic acid “NW3001D”, manufactured by NatureWorks LLC (MW: 150,000, carboxyl group concentration: 22.1 equivalents/ton) and the like can be suitably used. In that case, a value of the reactivity can be determined by measuring a carboxyl group concentration regarding a resin composition obtained by adding the agent in an amount such that the group of the hydrolysis regulator, reacting with the carboxyl group, is 33.15 equivalents/ton, followed by melt kneading under a nitrogen atmosphere at a resin temperature of 190° C. and at a rotation rate of 30 rpm for 1 minute by using a Labo Plasto mill (manufactured by Toyo Seiki Seisaku-Sho, Ltd.).

Besides, the reactivity with an acidic group may also be given by the equivalent evaluation.

In the case of evaluating a stable agent for the reactivity, even when kneading is performed under the above-described condition, the carboxyl group concentration of the rein composition does not substantially change. In the case of using such an agent in high-temperature hot water, the ability for sealing the target acidic group is not substantially revealed, and therefore, the decomposition of the resin (component A) cannot be inhibited.

In view of the foregoing, the reactivity with an acidic group at 190° C. is more preferably 60% or more, still more preferably 70% or more, and especially preferably 80% or more. That is, when the reactivity is 80% or more, namely the reactivity with an acidic group in high-temperature hot water is high, the reaction with the acidic group can be efficiently performed.

It is important that the hydrolysis regulator (component B) of the present invention has a water resistance at 120° C. of 95% or more and a reactivity with an acidic group at 190° C. of 50% or more. That is, in a very stable agent, though the water resistance is a high value, the reactivity with an acidic group is a low value, and in that case, the ability for sealing the target acidic group in high-temperature hot water is not substantially revealed. In a very instable agent, though the reactivity with an acidic group is a high value, the water resistance is a low value, and in that case, the agent is deactivated with water in high-temperature hot water, and therefore, the ability for sealing the target acidic group is remarkably lowered.

In view of the foregoing, the hydrolysis regulator having high water resistance and reactivity with an acidic group is suitably used in the present invention.

It is preferred that the hydrolysis regulator (component B) of the present invention has a plasticizing effect. “The hydrolysis regulator (component B) has a plasticizing effect” means a characteristic feature that by adding the hydrolysis regulator, a melt viscosity of the resin composition is lowered. It is preferred that the hydrolysis regulator has compatibility with the polylactic acid and has a low molecular weight. Although the molecular weight of the hydrolysis regulator is not particularly limited, it is preferably 5,000 or less, more preferably 1,000 or less, still more preferably 600 or less, and most preferably 300 or less. By using the hydrolysis regulator (component B) having a plasticizing effect, it is not necessary to add separately a plasticizer, the content of the polylactic acid in the resin composition can be increased, a weight retention rate in hot water can be kept high, and the total weight of the additives can be decreased. Therefore, it is possible to keep the melting point high.

Since the polylactic acid containing a stereocomplex crystal phase (component A) of the present invention is long in the isotactic number-average chain length, when used solely, the spinnability is very poor, so that it is difficult to obtain a molded article, such as fibers, etc. However, by adding the hydrolysis regulator (component B) having a plasticizing effect, the formability can be drastically improved.

Specifically, examples of the hydrolysis regulator (component B) include addition reaction type compounds, such as carbodiimide compounds, isocyanate compounds, epoxy compounds, oxazoline compounds, oxazine compounds, aziridine compounds, etc. These compounds can be used in combination of two or more thereof; however, not all of these compounds can be used, it is important to select a compound capable of bringing the effect as the hydrolysis regulator in the present invention.

Among the above-described compounds, from the viewpoint of water resistance or reactivity with an acidic group, carbodiimide compounds are preferably exemplified. However, similar to the above-described matter, not all of these compounds bring the effect as the hydrolysis regulator in the present invention, it is important to select a compound capable of bringing the effect of the present invention among carbodiimide compounds.

As the carbodiimide compound capable of bringing the effect in the present invention, for example, a compound having a basic structure represented by each of the following two general formulae can be exemplified.

R—N═C═N—R′

(In the formula, each of R and R′ is independently an aliphatic group having 1 to 20 carbon atoms, an alicyclic group having 3 to 20 carbon atoms, an aromatic group having 5 to 15 carbon atoms, or a combination thereof, and may contain a hetero atom; and R and R′ may be bonded to each other to form a cyclic structure, and may form two or more cyclic structures

N═C═N—R″ₙ

(In the formula, each R″ is independently an aliphatic group having 1 to 20 carbon atoms, an alicyclic group having 3 to 20 carbon atoms, an aromatic group having 5 to 15 carbon atoms, or a combination thereof, and may contain a hetero atom; and n is an integer of 2 to 1,000.)

From the viewpoint of stability or easiness of handling, aromatic carbodiimide compounds are more preferred. Examples thereof include aromatic carbodiimide compounds represented by the following two formulae.

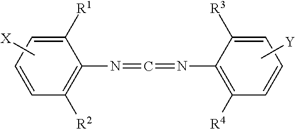

(In the formula, each of R¹ to R⁴ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure, and may form two or more cyclic structures through a spiro structure or the like.)

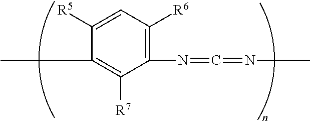

(In the formula, each of R⁵ to R⁷ is independently an aliphatic group having 1 to 20 carbon atoms, an alicyclic group having 3 to 20 carbon atoms, an aromatic group having 5 to 15 carbon atoms, or a combination thereof, and may contain a hetero atom; and n is an integer of 2 to 1,000.)

Specific examples of such an aromatic carbodiimide compound include polycarbodiimides synthesized by subjecting bis(2,6-diisopropylphenyl)carbodiimide or 1,3,5-triisopropylbenzene-2,4-diisocyanate to a decarboxylation condensation reaction, in which the number of carbodiimide groups is 5 or less, a combination thereof, and the like.

### <Resin Composition>

In the resin composition of the present invention, after its shape is kept in hot water at 188° C. for a fixed period of time of 1 hour or more, the effect for sealing the acidic group vanishes, the decomposition of the resin is promoted due to the autocatalysis of the acidic group, and following that, the concentration of the acidic group exponentially increases.

Furthermore, when the decomposition is advanced, the resin becomes a water-soluble monomer and is dissolved in water. The matter that the foregoing phenomenon is caused quickly as far as possible after the weight and shape of the resin are kept for a fixed period of time is suited on the occasion of using the resin composition of the present invention for excavation technology in the oil field, or the like. For that reason, it is necessary that a weight of a water-insoluble matter of the resin composition after 6 hours is less than 50%. It is more preferred that the weight of the water-insoluble matter of the resin composition after 5 hours is less than 50%; it is still more preferred that the weight of the water-insoluble matter of the resin composition after 4 hours is less than 50%; and it is yet still more preferred that the weight of the water-insoluble matter of the resin composition after 3 hours is less than 50%. The weight of the water-insoluble matter of the resin composition after 6 hours is more preferably less than 30%, still more preferably less than 10%, and yet more preferably less than 1%.

In order to keep the shape in hot water at 188° C., it is necessary that the resin composition of the present invention has a melting point of 188° C. or higher in water.

The melting point (Tmsw) of the stereocomplex crystal phase in water is preferably 188° C. or higher, more preferably 189° C. or higher, still more preferably 190° C. or higher, and most preferably 191° C. or higher.

The resin composition of the present invention contains 70 to 97 parts by weight of the polylactic acid (component A) and 3 to 20 parts by weight of the hydrolysis regulator (component B) based on 100 parts by weight of the whole of the resin composition. When the content of the hydrolysis regulator (component B) is less than 3 parts by weight, there may be the case where the formability is deteriorated, or a sufficient sealing effect of the acidic group is not exhibited in hot water at 188° C. When the content of the hydrolysis regulator (component B) is more than 20 parts by weight, there may be the case where the hydrolysis regulator (component B) bleeds out from the resin composition, the formability is deteriorated, or the heat resistance is lowered. From such viewpoints, the addition amount of the hydrolysis regulator (component B) is preferably 3 to 20 parts by weight, more preferably 4 to 15 parts by weight, and most preferably 5 to 10 parts by weight.

In the resin composition of the present invention, since the isotactic number-average chain length of the polylactic acid is long, and the homogenous crystal phase and the stereocomplex crystal phase are coexistent, it is preferred to regulate MFR to 60 or more by an additive. When the MFR is less than 60, there may be the case where the formability is deteriorated, so that for example, in spinning, thread breakage occurs frequently, and yarns cannot be stably collected. From such a viewpoint, the MFR is preferably 60 or more, more preferably 70 or more, still more preferably 80 or more, yet still more preferably 100 or more, and most preferably 120 or more.

### <Production Method of Resin Composition>

The resin composition of the present invention can be produced by melt kneading the polylactic acid containing a stereocomplex crystal phase (component A) and the hydrolysis regulator (component B).

Poly(L-lactic acid), poly(D-lactic acid), and the hydrolysis regulator (component B) are mixed, whereby the stereocomplex polylactic acid is formed, and simultaneously, the resin composition of the present invention can also be produced.

The method of adding the hydrolysis regulator (component B) to the polylactic acid (component A) and mixing them is not particularly limited, and a conventionally known method, such as a method of adding as a solution, a melt, or a master batch of the polylactic acid (component A) to be applied; a method of bringing a solid of the polylactic acid (component A) into contact with a liquid having the hydrolysis regulator (component B) dissolved, dispersed or melted therein, thereby penetrating the hydrolysis regulator (component B) thereinto; and the like can be adopted.

In the case of adopting a method of adding as a solution, a melt, or a master batch of the polylactic acid (component A) to be applied, a method of addition using a conventionally known kneading device can be adopted. On the occasion of kneading, a kneading method in a solution state or a kneading method in a molten state is more preferred from the viewpoint of uniform kneading properties. The kneading device is not particularly limited, and conventionally known vertical reaction vessels, mixing tanks, and kneading tanks, or single-screw or multi-screw horizontal kneading devices, for example, single-screw or multi-screw extruders and kneader, and the like are exemplified. A mixing time is not particularly specified, and though it varies with the mixing device or mixing temperature, a time of 0.1 minutes to 2 hours, preferably 0.2 minutes to 60 minutes, and more preferably 0.2 minutes to 30 minutes is selected.

As the solvent, those which are inert to the polylactic acid (component A) and the hydrolysis regulator (component B) can be used. In particular, a solvent which has an affinity with the both components and at least partially dissolves the both components therein. As the solvent, for example, hydrocarbon-based solvents, ketone-based solvents, ester-based solvents, ether-based solvents, halogen-based solvents, amide-based solvents, and the like can be used. Examples of the hydrocarbon-based solvent include hexane, cyclohexane, benzene, toluene, xylene, heptane, decane, and the like. Examples of the ketone-based solvent include acetone, methyl ethyl ketone, diethyl ketone, cyclohexanone, isophorone, and the like.

Examples of the ester-based solvent include ethyl acetate, methyl acetate, ethyl succinate, methyl carbonate, ethyl benzoate, diethylene glycol diacetate, and the like. Examples of the ether-based solvent include diethyl ether, dibutyl ether, tetrahydrofuran, dioxane, diethylene glycol dimethyl ether, triethylene glycol diethyl ether, diphenyl ether, and the like. Examples of the halogen-based solvent include dichloromethane, chloroform, tetrachloromethane, dichloroethane, 1,1′,2,2′-tetrachloroethane, chlorobenzene, dichlorobenzene, and the like. Examples of the amide-based solvent include formamide, N,N-dimethylformamide, N,N-dimethylacetamide, N-methyl-2-pyrrolidone, and the like. These solvents can be used alone or as a mixed solvent, if desired.

In the present invention, the solvent is applied in an amount in the range of 1 to 1,000 parts by weight based on 100 parts by weight of the resin composition. When the amount of the solvent is less than 1 part by weight, there is no meaning for the application of the solvent. Although an upper limit value of the use amount of the solvent is not particularly limited, it is about 1,000 parts by weight from the viewpoints of operability and reaction efficiency. In the case of adopting a method of bringing a solid of the polylactic acid (component A) into contact with a liquid having the hydrolysis regulator (component B) dissolved, dispersed or melted therein, a method of bringing a solid of the polylactic acid (component A) into contact with the hydrolysis regulator (component B) dissolved in a solvent as described above; a method of bringing a solid of the polylactic acid (component A) into contact with an emulsion liquid of the hydrolysis regulator (component B); and the like can be adopted.

As the contacting method, a method of dipping the polylactic acid (component A); a method of coating the polylactic acid (component A); a method of spraying the polylactic acid (component A); and the like can be suitably adopted.

Although it is possible to perform a sealing reaction of the acidic group of the polylactic acid (component A) with the hydrolysis regulator (component B) at a temperature of room temperature (25° C.) to about 300° C., the sealing reaction is more promoted at a temperature in the range of preferably 50 to 280° C., and more preferably 100 to 280° C. from the viewpoint of reaction efficiency. As for the polylactic acid (component A), the reaction is liable to be more advanced at a temperature at which it is melted; however, in order to inhibit volatilization, decomposition, or the like of the hydrolysis regulator (component B), it is preferred to perform the reaction at a temperature lower than 300° C. For the purposes of lowering the melting temperature of the polylactic acid (component A) and increasing the stirring efficiency, it is effective to apply a solvent.

Although the reaction is sufficiently rapidly advanced in the absence of a catalyst, a catalyst for promoting the reaction can also be used. As the catalyst, catalysts which are generally used for the hydrolysis regulator (component B) can be applied. These can be used alone or in combination of two or more kinds thereof. Although an addition amount of the catalyst is not particularly limited, it is preferably 0.001 to 1 part by weight, more preferably 0.01 to 0.1 parts by weight, and most preferably 0.02 to 0.1 parts by weight based on 100 parts by weight of the resin composition.

In the present invention, the hydrolysis regulator (component B) may be used in a combination of two or more kinds thereof. For example, with respect to the hydrolysis regulator for performing the sealing reaction of the acidic group at the early stage of the polylactic acid (component A) and the hydrolysis regulator (component B) for performing the sealing reaction of the acidic group generated in hot water at a higher temperature than 188° C., separate materials may be used.

Furthermore, it is preferred to jointly use an auxiliary agent of the hydrolysis regulator (component B), namely an agent for assisting the effect of the hydrolysis regulator (component B) for the purpose of delaying the hydrolysis. Although any known material can be used as such an agent, for example, at least one compound selected from hydrotalcite, an alkaline earth metal oxide, an alkaline earth metal hydroxide, and an alkaline earth metal carbonate is exemplified. A content of the auxiliary agent is preferably 0.1 to 30 parts by weight, more preferably 0.5 to 20 parts by weight, and still more preferably 0.7 to 10 parts by weight based on 100 parts by weight of the hydrolysis regulator (component B).

In the resin composition of the present invention, all of known additives and fillers can be added and used within the range where the effects of the invention are not lost. Examples thereof include a stabilizer, a crystallization promoter, a filler, a release agent, an antistatic agent, a plasticizer, an impact resistance-improving agent, a terminal-sealing agent, and the like.

Incidentally, from the viewpoint that the effects of the invention are not lost, with respect to the additives, it is important to not use a component which promotes the decomposition of the polylactic acid (component A), for example, a phosphoric acid component, a phosphite-based additive which is decomposed in the resin composition to generate a phosphoric acid component, or the like, or decrease its amount as far as possible, or to reduce influences thereof by taking a method, such as deactivation, etc. For example, a method of using a component capable of achieving deactivation or retardation together with the hydrolysis regulator (component B), or the like can be suitably adopted.

### <Stabilizer>

The resin composition of the present invention can contain a stabilizer. As the stabilizer, those which are used for a stabilizer of ordinary thermoplastic resins can be used. For example, an antioxidant, a light stabilizer, and the like can be exemplified. By compounding such an agent, a molded article having excellent mechanical properties, formability, heat resistance, and durability can be obtained.

As the antioxidant, a hindered phenol-based compound, a hindered amine-based compound, a phosphite-based compound, a thioether-based compound, and the like can be exemplified.

Examples of the hindered phenol-based compound include n-octadecyl-3-(3′,5′-di-tert-butyl-4′-hydroxyphenyl)-propionate, n-octadecyl-3-(3′-methyl-5′-tert-butyl-4′-hydroxyphenyl)-propionate, n-tetradecyl-3-(3′,5′-di-tert-butyl-4′-hydroxyphenyl)-propionate, 1,6-hexanediol-bis[3-(3,5-di-tert-butyl-4-hydroxyphenyl)-propionate], 1,4-butanediol-bis[3-(3,5-di-tert-butyl-4-hydroxyphenyl)-propionate], 2,2′-methylene-bis(4-methyl-tert-butylphenol), triethylene glycol-bis([3-(3-tert-butyl-5-methyl-4-hydroxyphenyl)-propionate], tetrakis[methylene-3-(3′,5′-di-tert-butyl-4-hydroxyphenyl) propionate]methane, 3,9-bis[2-{3-(3-tert-butyl-4-hydroxy-5-methylphenyl)propio nyloxy}-1,1-dimethylethyl]2,4,8,10-tetraoxaspiro(5,5)undecane, and the like.

Examples of the hindered amine-based compound include N,N′-bis-3-(3′,5′-di-tert-butyl-4′-hydroxyphenyl)propionyl hexamethylenediamine, N,N′-tetramethylene-bis[3-(3′-methyl-5′-tert-butyl-4′-hydr oxyphenyl)propionyl]diamine, N,N′-bis[3-(3,5-di-tert-butyl-4-hydroxyphenyl)-propionyl]hydrazine, N-salicyloyl-N′-salicylidenehydrazine, 3-(N-salicyloyl)amino-1,2,4-triazole, N,N′-bis[2-{3-(3,5-di-tert-butyl-4-hydroxyphenyl)propionyl oxy}ethyl]oxyamide, and the like. Triethylene glycol-bis[3-(3-tert-butyl-5-methyl-4-hydroxyphenyl)-propionate], tetrakis[methylene-3-(3′,5′-di-tert-butyl-4-hydroxyphenyl) propionate]methane, and the like are preferred.

The phosphite-based compound is preferably a compound having at least one P—O bond bonded to an aromatic group. Specifically, examples thereof include tris(2,6-di-tert-butylphenyl)phosphite, tetrakis(2,6-di-tert-butylphenyl)4,4′-biphenylene phosphite, bis(2,6-di-tert-butyl-4-methylphenyl)pentaerythritol-di-phosphite, 2,2-methylenebis(4,6-di-tert-butylphenyl)octylphosphite, 4,4′-butylidene-bis(3-methyl-6-tert-butylphenyl-di-tridecyl)phosphite, 1,1,3-tris(2-methyl-4-ditridecylphosphite-5-tert-butylphenyl)butane, tris(mixed mono- and di-nonylphenyl)phosphite, tris(nonylphenyl)phosphite, 4,4′-isopropylidenebis(phenyl-dialkylphosphite), 2,4,8,10-tetra-tert-butyl-6-[3-(3-methyl-4-hydroxy-5-t-butylphenyl)propoxy]dibenzo[d,f][1,3,2]dioxaphosphepin (SUMILIZER (registered trademark) GP), and the like.

Specific examples of the thioether-based compound include dilauryl thiodipropionate, ditridecyl thiodipropionate, dimyristyl thiodipropionate, distearyl thiodipropionate, pentaerythritol-tetrakis(3-laurylthiopropionate), pentaerythritol-tetrakis(3-dodecylthiopropionate), pentaerythritol-tetrakis(3-octadecylthiopropionate), pentaerythritol-tetrakis(3-myristylthiopropionate), pentaerythritol-tetrakis(3-stearylthiopropionate), and the like.

As the light stabilizer, specifically, for example, a benzophenone-based compound, a benzotriazole-based compound, an aromatic benzoate-based compound, an oxalic anilide-based compound, a cyanoacrylate-based compound, a hindered amine-based compound, and the like can be exemplified.

Examples of the benzophenone-based compound include benzophenone, 2,4-dihydroxybenzophenone, 2,2′-dihydroxybenzophenone, 2,2′,4,4′-tetrahydroxybenzophenone, 2-hydroxy-4-methoxybenzophenone, 2,2′-dihydroxy-4,4′-dimethoxybenzophenone, 2,2′-dihydroxy-4,4′-dimethoxy-5-sulfobenzophenone, 2-hydroxy-4-octoxybenzophenone, 2-hydroxy-4-dodecyloxybenzophenone, 2-hydroxy-4-octoxybenzophenone, 2-hydroxy-4-methoxy-5-sulfobenzophenone, 5-chloro-2-hydroxybenzophenone, 2-hydroxy-4-octoxybenzophenone, 2-hydroxy-4-methoxy-2′-carboxybenzophenone, 2-hydroxy-4-(2-hydroxy-3-methyl-acryloxyisopropoxy)benzophenone, and the like.

Examples of the benzotriazole-based compound include 2-(5-methyl-2-hydroxyphenyl)benzotriazole, 2-(3,5-di-tert-butyl-2-hydroxyphenyl)benzotriazole, 2-(3,5-di-tert-amyl-2-hydroxyphenyl)benzotriazole, 2-(3′,5′-di-tert-butyl-4′-methyl-2′-hydroxyphenyl)benzotriazole, 2-(3,5-di-tert-amyl-2-hydroxyphenyl)-5-chlorobenzotriazole, 2-(5-tert-butyl-2-hydroxyphenyl)benzotriazole, 2-[2′-hydroxy-3′,5′-bis(α,α-dimethylbenzyl)phenyl]benzotriazole, 2-[2′-hydroxy-3′,5′-bis(α,α-dimethylbenzyl)phenyl]-2H-benzotriazole, 2-(4′-octoxy-2′-hydroxyphenyl)benzotriazole, and the like.

Examples of the aromatic benzoate-based compound include alkylphenyl salicylates, such as p-tert-butylphenyl salicylate, p-octylphenyl salicylate, etc. Examples of the oxalic anilide-based compound include 2-ethoxy-2′-ethyloxalic acid bisanilide, 2-ethoxy-5-tert-butyl-2′-ethyloxalic acid bisanilide, 2-ethoxy-3′-dodecyloxalic acid bisanilide, and the like.

Examples of the cyanoacrylate-based compound include ethyl-2-cyano-3,3′-diphenyl acrylate, 2-ethylhexyl-cyano-3,3′-diphenyl acrylate, and the like.

Examples of the hindered amine-based compound include 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-octadecyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl)carbonate, bis(2,2,6,6-tetramethyl-4-piperidyl)oxalate, bis(2,2,6,6-tetramethyl-4-piperidyl)malonate, bis(2,2,6,6-tetramethyl-4-piperidyl)sebacate, bis(2,2,6,6-tetramethyl-4-piperidyl)adipate, bis(2,2,6,6-tetramethyl-4-piperidyl)terephthalate, 1,2-bis(2,2,6,6-tetramethyl-4-piperidyloxy)-ethane, α,α′-bis(2,2,6,6-tetramethyl-4-piperidyloxy)-p-xylene, bis(2,2,6,6-tetramethyl-4-piperidyl)-tolylene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6-tetramethyl-4-piperidyl)-benzene-1,3,4-tricarboxylate, 1-[2-{3-(3,5-di-tert-butyl-4-hydroxyphenyl)propionyloxy}-2,2,6,6-tetramethylpiperidine, a condensate of 1,2,3,4-butane tetracarboxylic acid, 1,2,2,6,6-pentamethyl-4-piperidinol, and β,β,β′,β′-tetramethyl-3,9-[2,4,8,10-tetraoxaspiro(5,5)undecane]dimethanol, and the like.

In the present invention, the stabilizer component may be used alone, or may be used in combination of two or more kinds thereof. As the stabilizer component, a hindered phenol-based compound and/or a benzotriazole-based compound is preferred.

A content of the stabilizer is preferably 0.01 to 3 parts by weight, and more preferably 0.03 to 2 parts by weight based on 100 parts by weight of the polylactic acid (component A).

### <Crystallization Accelerator>

The resin composition of the present invention can contain an organic or inorganic crystallization accelerator. When the resin composition contains the crystallization accelerator, a molded article having excellent mechanical properties, heat resistance, and formability can be obtained.

That is, by applying the crystallization accelerator, a molded article which is enhanced in formability and crystallinity, is thoroughly crystallized even by ordinary injection molding, and is excellent in heat resistance and moist heat stability can be obtained. In addition thereto, the time required for the manufacture of a molded article can be drastically shortened, and its economic effect is large.

A crystal nucleating agent which is generally used for crystalline resins can be used as the crystallization accelerator which is used in the present invention. All of an inorganic crystal nucleating agent and an organic crystal nucleating agent can be used.

Examples of the inorganic crystal nucleating agent include talc, kaolin, silica, synthetic mica, clay, zeolite, graphite, carbon black, zinc oxide, magnesium oxide, titanium oxide, calcium carbonate, calcium sulfate, barium sulfate, calcium sulfide, boron nitride, montmorillonite, neodymium oxide, aluminum oxide, phenylphosphonate metal salts, and the like. Such an inorganic crystal nucleating agent is preferably treated with a dispersion aid of every sort in order to increase its dispersibility in the composition and its effects and highly dispersed to such an extent that its primary particle diameter is about 0.01 to 0.5 μm.

Examples of the organic crystal nucleating agent include organic carboxylic acid metal salts, such as calcium benzoate, sodium benzoate, lithium benzoate, potassium benzoate, magnesium benzoate, barium benzoate, calcium oxalate, disodium terephthalate, dilithium terephthalate, dipotassium terephthalate, sodium laurate, potassium laurate, sodium myristate, potassium myristate, calcium myristate, barium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, sodium β-naphthoate, potassium β-naphthoate, sodium cyclohexanecarboxylate, etc.; and organic sulfonic acid metal salts, such as sodium p-toluenesulfonate, sodium sulfoisophthalate, etc.

Organic carboxylic acid amides, such as stearic acid amide, ethylenebis(lauric amide), palmitic acid amide, hydroxystearic acid amide, erucic acid amide, tris(t-butylamide)trimesate, etc., low-density polyethylene, high-density polyethylene, polyisopropylene, polybutene, poly-4-methylpentene, poly-3-methylbutene-1, polyvinyl cycloalkane, polyvinyl trialkylsilane, branched type polylactic acid, a sodium salt of an ethylene-acrylate copolymer, a sodium salt of a styrene-maleic anhydride copolymer (so-called “ionomer”), benzylidene sorbitol and a derivative thereof, for example, dibenzylidene sorbitol, etc., are exemplified.

Of these, talc and at least one member selected from organic carboxylic acid metal salts are preferably used. The crystallization accelerator which is used in the present invention may be used alone, or may be used in combination of two or more kinds thereof.

A content of the crystallization accelerator is preferably 0.01 to 20 parts by weight, and more preferably 0.05 to 10 parts by weight based on 100 parts by weight of the polylactic acid (component A).

### <Filler>

The resin composition of the present invention can contain an organic or inorganic filler. When the resin composition contains a filler component, a molded article having excellent mechanical properties, heat resistance, and die formability can be obtained.

Examples of the organic filler include chip fillers, such as rice husk chips, wooden chips, bean curd refuse, old paper crushed chips, apparel crushed chips, etc.; fibrous fillers, such as plant fibers including cotton fibers, hemp fibers, bamboo fibers, wooden fibers, kenaf fibers, jute fibers, banana fibers, coconut fibers, and the like, pulp or cellulose fibers processed from these plant fibers, animal fibers including silk, wool, Angora, cashmere, and camel fibers, and the like, and synthetic fibers including polyester fibers, nylon fibers, acrylic fibers, and the like; and powdery fillers, such as paper powders, wooden powders, cellulose powders, rice husk powders, fruit shell powders, chitin powders, chitosan powders, protein powders, starch powders, etc. From the viewpoint of formability, powdery fillers, such as paper powders, wooden powders, bamboo powders, cellulose powders, kenaf powders, rice husk powders, fruit shell powders, chitin powders, chitosan powders, protein powders, starch powders, etc., are preferred, and paper powders, wooden powders, bamboo powders, cellulose powders, and kenaf powders are more preferred. Paper powders and wooden powders are still more preferred. Paper powders are especially preferred.

Although organic fillers collected directly from natural products may be used, organic fillers recycled from waste materials, such as used paper, waste timber, used clothing, etc., may also be used.

Conifers, such as yellow pine, cedar, cypress, fir, etc., and broadleaf trees, such as beech, chinquapin, eucalyptus, etc., and the like are preferred as the timber.

As for paper powders, from the viewpoint of formability, paper powders containing an adhesive, especially an emulsion-based adhesive, such as a vinyl acetate resin-based emulsion, an acrylic resin-based emulsion, etc., which is generally used on the occasion of processing paper, or a hot melt adhesive, such as a polyvinyl alcohol-based adhesive, a polyamide-based adhesive, etc., or the like are preferably exemplified.

In the present invention, though a compounding amount of the organic filler is not particularly limited, from the viewpoints of formability and heat resistance, it is preferably 0.1 to 20 parts by weight, more preferably 0.5 to 15 parts by weight, still more preferably 10 to 150 parts by weight, and especially preferably 1 to 10 parts by weight based on 100 parts by weight of the polylactic acid (component A).

When the compounding amount of the organic filler is less than 0.1 parts by weight, the effect for enhancing the formability of the composition is small, whereas when it is more than 20 parts by weight, it is difficult to disperse the filler uniformly, or there may be a possibility that the strength and appearance as a material as well as formability and heat resistance of the composition are deteriorated, and hence, such is not preferred.

The composition of the present invention may contain an inorganic filler. By containing an inorganic filler, a composition having excellent mechanical properties, heat resistance, and formability can be obtained. As the inorganic filler which is used in the present invention, a fibrous, platy, or powdery filler which is used for reinforcing an ordinary thermoplastic resin can be used.

Specifically, examples thereof include fibrous inorganic fillers, such as carbon nanotubes, glass fibers, asbestos fibers, carbon fibers, graphite fibers, metal fibers, potassium titanate whiskers, aluminum borate whiskers, magnesium-based whiskers, silicon-based whiskers, wollastonite, imogolite, sepiolite, asbestos, slug fibers, zonolite, gypsum fibers, silica fibers, silica-alumina fibers, zirconia fibers, boron nitride fibers, silicon nitride fibers, boron fibers, etc.; and platy or particulate inorganic fillers, such as stratiform silicates, stratiform silicates exchanged with an organic onium ion, glass flakes, non-swelling mica, graphite, metal foils, ceramic beads, talc, clay, mica, sericite, zeolite, bentonite, dolomite, kaolin, powdery silicic acid, feldspar powder, potassium titanate, silas balloon, calcium carbonate, magnesium carbonate, barium sulfate, calcium oxide, aluminum oxide, titanium oxide, aluminum silicate, silicon oxide, gypsum, novaculite, dosonite, carbon nanoparticles including white clay fullerene or the like, etc.

Specific examples of the stratiform silicate include smectite-based clay minerals, such as montmorillonite, beidellite, nontronite, saponite, hectorite, sauconite, etc.; various clay minerals, such as vermiculite, halocite, kanemite, kenyaite, etc.; swelling micas, such as Li type fluorine taeniolite, Na type fluorine taeniolite, Li type tetrasilicon fluorine mica, Na type tetrasilicon fluorine mica, etc.; and the like. These may be natural or synthetic. Of these, smectite-based clay minerals, such as montmorillonite, hectorite, etc., and swelling synthetic micas, such as Li type fluorine taeniolite, Na type tetrasilicon fluorine mica, etc., are preferred.

Of these inorganic fillers, fibrous or platy inorganic fillers are preferred, and glass fibers, wollastonite, aluminum borate whiskers, potassium titanate whiskers, mica, kaolin, and cation-exchanged stratiform silicates are especially preferred. An aspect ratio of the fibrous filler is preferably 5 or more, more preferably 10 or more, and still more preferably 20 or more.

Such a filler may be covered or bundled with a thermoplastic resin, such as an ethylene/vinyl acetate copolymer, etc., or a thermosetting resin, such as an epoxy resin, etc., or treated with a coupling agent, such as aminosilane, epoxysilane, etc.

A compounding amount of the inorganic filler is preferably 0.1 to 20 parts by weight, more preferably 0.5 to 15 parts by weight, still more preferably 10 to 150 parts by weight, and especially preferably 1 to 10 parts by weight based on 100 parts by weight of the polylactic acid (component A).

### <Release Agent>

The resin composition of the present invention can contain a release agent. As the release agent which is used in the present invention, those which are used for ordinary thermoplastic resins can be used.

Specifically, examples of the release agent may include fatty acids, fatty acid metal salts, hydroxy fatty acids, paraffins, low-molecular weight polyolefins, fatty acid amides, alkylene bis-fatty acid amides, aliphatic ketones, fatty acid partially saponified esters, fatty acid lower alcohol esters, fatty acid polyhydric alcohol esters, fatty acid polyglycol esters, modified silicones, and the like. By compounding such a release agent, a polylactic acid molded article having excellent mechanical properties, formability, and heat resistance can be obtained.

As the fatty acid, those having 6 to 40 carbon atoms are preferred, and specifically, examples thereof include oleic acid, stearic acid, lauric acid, hydroxystearic acid, behenic acid, arachidonic acid, linoleic acid, linolenic acid, ricinoleic acid, palmitic acid, montanic acid, and a mixture thereof, and the like. As the fatty acid metal salt, alkali metal salts or alkaline earth metal salts of a fatty acid having 6 to 40 carbon atoms are preferred, and specifically, examples thereof include calcium stearate, sodium montanate, calcium montanate, and the like.

Examples of the hydroxy fatty acid include 1,2-hydroxystearic acid and the like. As the paraffin, those having 18 carbon atoms or more are preferred, and examples thereof include liquid paraffin, natural paraffin, a microcrystalline wax, petrolactam, and the like.

As the low-molecular weight polyolefin, for example, those having a molecular weight of 5,000 or less are preferred, and specifically, examples thereof include a polyethylene wax, a maleic acid modified polyethylene wax, an oxide type polyethylene wax, a chlorinated polyethylene wax, a polypropylene wax, and the like. As the fatty acid amide, those having 6 or more carbon atoms are preferred, and specifically, examples thereof include oleic acid amide, erucic acid amide, behenic acid amide, and the like.

As the alkylene bis-fatty acid amide, those having 6 or more carbon atoms are preferred, and specifically, examples thereof include methylene bis-stearic acid amide, ethylene bis-stearic acid amide, N,N-bis(2-hydroxyethyl)stearic acid amide, and the like. As the aliphatic ketone, those having 6 or more carbon atoms are preferred, and examples thereof include higher aliphatic ketones and the like.

Examples of the fatty acid partially saponified ester include montanic acid partially saponified esters and the like. Examples of the fatty acid lower alcohol ester include stearic acid esters, oleic acid esters, linoleic acid esters, linolenic acid esters, adipic acid esters, behenic acid esters, arachidonic acid esters, montanic acid esters, isostearic acid esters, and the like.

Examples of the fatty acid polyhydric alcohol ester include glycerol tristearate, glycerol distearate, glycerol monostearate, pentaerythritol tetrastearate, pentaerythritol tristearate, pentaerythritol distearate, pentaerythritol monostearate, pentaerythritol adipate stearate, sorbitan monobehenate, and the like. Examples of the fatty acid polyglycol ester include polyethylene glycol fatty acid esters, polypropylene glycol fatty acid esters, and the like.

Examples of the modified silicone include polyether modified silicones, higher fatty acid alkoxy modified silicones, higher fatty acid-containing silicones, higher fatty acid ester modified silicones, methacrylic modified silicones, fluorine modified silicone, and the like.

Of these, fatty acids, fatty acid metal salts, hydroxy fatty acids, fatty acid esters, fatty acid partially saponified esters, paraffins, low-molecular weight polyolefins, fatty acid amides, and alkylene-bis fatty acid amides are preferred, and fatty acid partially saponified esters and alkylene-bis fatty acid amides are more preferred. Above all, montanic acid esters, montanic acid partially saponified esters, polyethylene waxes, oxidized polyethylene waxes, sorbitan fatty acid esters, erucic acid amide, and ethylene bis-stearic acid amide are still more preferred, and montanic acid partially saponified esters and ethylene bis-stearic acid amide are especially preferred.

The release agent may be used alone, or may be used in combination of two or more kinds thereof. A content of the release agent is preferably 0.01 to 3 parts by weight, and more preferably 0.03 to 2 parts by weight based on 100 parts by weight of the polylactic acid (component A).

### <Antistatic Agent>

The resin composition of the present invention can contain an antistatic agent. Examples of the antistatic agent include quaternary ammonium salt-based compounds, sulfonate-based compounds, and alkyl phosphate-based compounds, such as (β-lauramidepropionyl)trimethylammonium sulfate, sodium dodecylbenzenesulfonate, etc., and the like.

In the present invention, the antistatic agent may be used alone, or may be used in combination of two or more kinds thereof. A content of the antistatic agent is preferably 0.05 to 5 parts by weight, and more preferably 0.1 to 5 parts by weight based on 100 parts by weight of the polylactic acid (component A).

### <Plasticizer>

The resin composition of the present invention can contain a plasticizer. As the plasticizer, those which are generally known can be used. Examples thereof include polyester-based plasticizers, glycerin-based plasticizers, multivalent carboxylic acid ester-based plasticizers, phosphoric acid ester-based plasticizers, polyalkylene glycol-based plasticizers, epoxy-based plasticizers, and the like.

Examples of the polyester-based plasticizer include polyesters composed of an acid component, such as adipic acid, sebacic acid, terephthalic acid, isophthalic acid, naphthalenedicarboxylic acid, diphenyldicarboxylic acid, etc., and a diol component, such as ethylene glycol, propylene glycol, 1,3-propanediol, 1,3-butanediol, 1,4-butanediol, 1,6-hexanediol, diethylene glycol, etc.; polyesters composed of a hydroxycarboxylic acid, such as polycaprolactone, etc.; and the like. The ends of such a polyester may be sealed with a monofunctional carboxylic acid or a monofunctional alcohol.

Examples of the glycerin-based plasticizer include glycerin monostearate, glycerin distearate, glycerin monoacetomonolaurate, glycerin monoacetomonostearate, glycerin diacetomonooleate, glycerin monoacetomonomontanate, and the like.

Examples of the multivalent carboxylic acid-based plasticizer include phthalic acid esters, such as dimethyl phthalate, diethyl phthalate, dibutyl phthalate, diheptyl phthalate, dibenzyl phthalate, butylbenzyl phthalate, etc.; trimellitic acid esters, such as tributyl trimellitate, trioctyl trimellitate, trihexyl trimellitate, etc.; adipic acid esters, such as isodecyl adipate, n-decyl-n-octyl adipate, etc.; citric acid esters, such as tributyl acetylcitrate, etc.; azelaic acid esters, such as bis(2-ethylhexyl) azelate, etc.; and sebacic acid esters, such as dibutyl sebacate, bis(2-ethylhexyl) sebacate, etc.

Examples of the phosphoric acid ester-based plasticizer include tributyl phosphate, tris(2-ethylhexyl)phosphate, trioctyl phosphate, triphenyl phosphate, tricresyl phosphate, diphenyl-2-ethylhexyl phosphate, and the like.

Examples of the polyalkylene glycol-based plasticizer include polyalkylene glycols, such as polyethylene glycol, polypropylene glycol, polytetramethylene glycol, poly(ethylene oxide-propylene oxide) block and/or random copolymers, ethylene oxide addition polymers of a bisphenol, tetrahydrofuran addition polymers of a bisphenol, etc.; terminal-sealing compounds, such as terminal epoxy modified compounds, terminal ester modified compounds, and terminal ether modified compounds of these polyalkylene glycols, etc.; and the like.

Examples of the epoxy-based plasticizer include epoxy triglyceride composed of an alkyl epoxystearate and soybean oil, and an epoxy resin obtained from bisphenol A and epichlorohydrin as raw materials.

Specific examples of other plasticizer include benzoic acid esters of an aliphatic polyol, such as neopentyl glycol dibenzoate, diethylene glycol dibenzoate, triethylene glycol-bis(2-ethylbutyrate), etc.; fatty acid amides, such as stearic acid amide, etc.; fatty acid esters, such as butyl oleate, etc.; oxyacid esters, such as methyl acetyl ricinoleate, butyl acetyl ricinoleate, etc.; pentaerythritols; fatty acid esters of a pentaerythritol; various sorbitols; polyacrylic acid esters; silicone oil; paraffins; and the like.

As the plasticizer, at least one member selected from polyester-based plasticizers, polyalkylene-based plasticizers, glycerin-based plasticizers, pentaerythritols, and fatty acid esters of a pentaerythritol can be especially preferably used, and the plasticizer may be used alone or can also be used in combination of two or more kinds thereof.

A content of the plasticizer is preferably 0.01 to 20 parts by weight, more preferably 0.05 to 15 parts by weight, and still more preferably 0.1 to 10 parts by weight based on 100 parts by weight of the polylactic acid (component A). In the present invention, the crystallization nucleating agent and the plasticizer may be used independently, and it is more preferred to use a combination of the both. It is the most preferred to use a material having an effect as a plasticizer for the hydrolysis regulator that is essential in the present application.

### <Impact Resistance-Improving Agent>

The resin composition of the present invention can contain an impact resistance-improving agent. The impact resistance-improving agent is a material which can be used for improving the impact resistance of a thermoplastic resin and is not particularly limited. For example, at least one member selected among the following impact resistance-improving agents.

Specific examples of the impact resistance-improving agent include an ethylene-propylene copolymer, an ethylene-propylene-non-conjugated diene copolymer, an ethylene-butene-1 copolymer, various acrylic rubber, an ethylene-acrylic acid copolymer and an alkali metal salt thereof (so-called “ionomer”), an ethylene-glycidyl(meth)acrylate copolymer, an ethylene-acrylic acid ester copolymer (for example, an ethylene-ethyl acrylate copolymer and an ethylene-butyl acrylate copolymer), a modified ethylene-propylene copolymer, a diene rubber (for example, polybutadiene, polyisoprene, and polychloroprene), a diene-vinyl copolymer (for example, a styrene-butadiene random copolymer, a styrene-butadiene block copolymer, a styrene-butadiene-styrene block copolymer, a styrene-isoprene random copolymer, a styrene-isoprene block copolymer, a styrene-isoprene-styrene block copolymer, a polybutadiene-styrene graft copolymer, and a butadiene-acrylonitrile copolymer), polyisobutylene, a copolymer of isobutylene and butadiene or isoprene, a natural rubber, a Thiokol rubber, a polysulfide rubber, a polyurethane rubber, a polyether rubber, an epichlorohydrin rubber, and the like.

Furthermore, impact resistance-improving agents having a degree of crosslinking of every sort, those having various micro-structures, for example, a cis-structure or a trans-structure, and those having core-shell type multilayer polymers, composed of a core layer and at least one shell layer covering the core layer, with adjacent layers made of different polymers, can also be used.

Furthermore, the various (co)polymers specifically exemplified above may be either a random copolymer or a block copolymer, and these can be used as the impact resistance-improving agent of the present invention.

A content of the impact resistance-improving agent is preferably 0.1 to 20 parts by weight, more preferably 0.5 to 15 parts by weight, and still more preferably 1 to 10 parts by weight based on 100 parts by weight of the polylactic acid (component A).

### <Others>

The resin composition of the present invention may contain a thermosetting resin, such as a phenol resin, a melamine resin, a thermosetting polyester resin, a silicone resin, an epoxy resin, etc., within the range where the gist of the present invention is not deviated.

The resin composition of the present invention may also contain a flame retardant, such as a bromine-based material, a phosphorus-based material, a silicone-based material, an antimony compound, etc., within the range where the gist of the present invention is not deviated.

The resin composition may also contain a colorant including an organic or inorganic dye or pigment, for example, an oxide, such as titanium dioxide, etc., a hydroxide, such as alumina white, etc., a sulfide, such as zinc sulfide, etc., a ferrocyanide compound, such as iron blue, etc., a chromate, such as zinc chromate, etc., a sulfate, such as barium sulfate, etc., a carbonate, such as calcium carbonate, etc., a silicate, such as ultramarine blue, etc., a phosphate, such as manganese violet, etc., carbon, such as carbon black, etc., a metal colorant, such as a bronze powder, an aluminum powder, etc., and the like.

The resin composition may also contain an additive including a nitroso-based colorant, such as Naphthol Green B, etc., a nitro-based colorant, such as Naphthol Yellow S, etc., an azo-based colorant, such as Naphthol Red, Chromophthal Yellow, etc., a phthalocyanine-based colorant, such as Phthalocyanine Blue, Fast Sky Blue, etc., a condensation polycyclic colorant, such as Indanthrene Blue, and the like, and a slidability-improving agent, such as graphite, a fluorine resin, etc.

These additives may be used alone or can also be used in combination of two or more kinds thereof.

### <Molded Article>

In a molded article made of the resin composition of the present invention, it is preferred that the shape retention properties after a hot water test at 188° C. is “good” after keeping for 1 hour.

In the case where the melting point in water is lower than 188° C., the sample is melted and flown during the test, so that the shape cannot be retained. Specifically, though the initial shape is not particularly important, when the hot water test at 188° C. is carried out by using plural (preferably 5 or more) test pieces, the case where after the test, the test pieces become in a single disk-like or spherical form on the bottom of a vessel is defined as “bad”, whereas the case where the respective test pieces come loose with ease is defined as “good”.

A molded article made of the resin composition of the present invention can be formed by means of injection molding, extrusion molding, vacuum or pressure molding, blow molding, or the like. Examples of the molded article include a pellet, a fiber, a cloth, a fiber structure, a film, a sheet, a sheet nonwoven fabric, and the like.

The melt forming method of the pellet made of the resin composition of the present invention is not limited at all, and pellets produced by a known pellet production method can be suitably used.

That is, though methods, such as a method in which the resin composition extruded into a strand or plate is cut in air or water after the resin is completely solidified, or while it is still molten and not completely solidified, etc., are conventionally known, all of those methods can be suitably applied in the present invention.

For the injection molding, molding conditions may be properly set according to the type of the polylactic acid (component A). However, from the viewpoints of promoting the crystallization and the molding cycle of a molded article at the time of injection molding, for example, a die temperature is preferably 30° C. or higher, more preferably 60° C. or higher, and still more preferably 70° C. or higher. However, in order to prevent the deformation of a molded article, the die temperature is preferably 140° C. or lower, more preferably 120° C. or lower, and still more preferably 110° C. or lower.

From the viewpoint of enhancing the hot water resistance, the resulting molded article can be properly subjected to a heat treatment. As the heat treatment, a generally known method can be applied, and for example, a method of bringing a heat source into direct contact with the molded article, a method of heating the molded article in a medium in a gas or liquid state, and the like can be applied. Examples of the heat source on the occasion of direct contact include steam, a hot roller, a heat press, a die, and the like. Examples of the medium include water, an organic solvent, a compound which becomes a melt at the heat treatment temperature, and the like. The melt may be either a low molecular weight compound or a high molecular weight compound. The heat treatment may be performed one time or two or more times, and the treatment may be performed by a combination of several methods. In the case of performing the heat treatment two or more times, the heat treatment temperature may be changed stepwise. As for the method of heating a gas or a liquid, a hot-air oven, a steam oven, an electric heater, an infrared ray heater, microwave irradiation, and the like can be properly selected.

Furthermore, from the viewpoint of suppressing the hydrolysis of the molded article during the hot water test, a method of heat treatment in which a decrease of the hydrolysis regulator (component B) in the molded article is controlled can be suitably applied. For example, a method in which the molded article is heat treated under pressure in a state where it is sealed within a closed vessel; a method in which the molded article is heat treated in the medium into which the hydrolysis regulator (component B) does not elute; a method in which the molded article is heat treated in the medium saturated with the hydrolysis regulator (component B); a method in which the molded article is heat treated in a state where it is physically covered; a combination of these methods; and the like can be suitably applied.

An ultimate heat treatment temperature may be properly set depending upon the melting point of the resin composition; however, from the viewpoint of efficiently enhancing the hot water resistance, a temperature in the range of 180° C. to 240° C., more preferably 190° C. to 235° C., still more preferably 200° C. to 230° C., and especially preferably 210° C. to 220° C. is selected.

A heat treatment time is not particularly specified and varies with the heat treatment method or heat treatment temperature. A time of 0.1 seconds to 120 minutes, preferably 0.1 seconds to 110 minutes, and more preferably 0.1 seconds to 100 minutes is selected.

### <Fiber>

As for the fiber and the fiber structure made of the resin composition of the present invention, materials obtained by ordinary melt spinning and post-processing after that can be suitably used.

That is, the polylactic acid (component A) is melted by an extruder type or pressure melter type melt extruder, weighed by a gear pump, filtered within a pack, and then discharged as a monofilament or a multifilament, or the like from nozzles provided in a spinneret.

The shape and number of spinnerets are not particularly limited, and all of a circular type, an atypical type, a solid type, a hollow type, a conjugated type, and the like can be adopted. The discharged yarn is immediately cooled and solidified, and thereafter, the resultant is bundled, applied with a lubricant, and wound up. Although a winding rate is not particularly limited, it is preferably in the range of 100 m/min to 5,000 m/min.

Although the wound unstretched yarn can be used as it is, it can also be stretched and used.

In the case of using the yarn in an unstretched state, a crystallization treatment may be performed by performing a heat treatment at a temperature lower than the melting point after spinning and before winding up. Arbitrary means, such as a contact type heater, a non-contact hot plate, etc., can be adopted for the heat treatment besides a hot roller.

In the case of performing stretching, a spinning step and a stretching step are not always needed to be separated from each other, and a direct spinning/stretching method in which after spinning, stretching is subsequently performed without once winding up the spun yarn may be adopted.

Stretching may be performed in one stage or two or more multiple stages, and from the viewpoint of fabricating a high-strength fiber, a draw ratio is preferably 3 times or more, and more preferably 4 times or more. The draw ratio is preferably selected from 3 to 10 times. However, when the draw ratio is too high, the fiber is devitrified and whitened, whereby the strength of the fiber is lowered, and rupture elongation becomes too small for a fiber application, and hence, such is not preferred.

As for a preheating method for stretching, besides temperature elevation of a roll, a plate-like or pin-like contact heater, a non-contact hot plate, a heat medium bath, and the like may be adopted. However, commonly used means may be adopted.

A stretching temperature in the range of, for example, 40 to 130° C., preferably 50 to 120° C., and especially preferably 60 to 110° C. is selected.

It is preferred that after spinning, the heat treatment is subsequently performed at a temperature lower than the melting point before winding up. Besides a hot roller, arbitrary means, such as a contact heater, a non-contact hot plate, etc., can be adopted for the heat treatment. A heat treatment temperature in the range of, for example, 100 to 210° C., preferably 110 to 200° C., and especially preferably 120 to 190° C. is selected.

After the stretching treatment, a relaxation treatment can also be performed after the heat treatment. Furthermore, after performing the relaxation treatment, a stretching treatment may be again performed, or a plural number of the relaxation treatment may also be performed.

The fiber obtained from the resin composition of the present invention may be a short fiber. In the case of producing a short fiber, in addition to a stretching method of along fiber, a step of cutting in a prescribed fiber length according to an application by using a rotary cutter or the like is added, and in the case where crimping is further needed, a step of imparting crimps by using a forced crimper or the like is added between a fixed-length heat treatment and a relaxation treatment. On that occasion, in order to increase crimp-imparting properties, preheating can be performed by using steam, an electric heater, or the like before the crimper.

A polylactic acid fiber having a high stereocomplex crystallization degree (S), low heat shrinkage, and a strength of 3.5 cN/dTex or more can also be obtained by heat setting at 170 to 220° C. under a tension after stretching. It is possible to perform this heat setting treatment while also functioning as the “heat treatment” to be performed from the viewpoint of enhancing the water resistance as described later.

So long as the object is achieved, fibers obtained from the resin composition of the present invention may be used as fibers made of the resin composition alone or can be mixed with another type of fibers. Examples of the mixture include not only various combinations with a fibrous structure made of another type of fibers but also a combined filament yarn with another type of fibers, a composite false twisted yarn, a blended yarn, a long/short composite yarn, a fluid processed yarn, a covering yarn, a twisted yarn, a combined weave, a combined knitting, a pile fabric, a cotton mixing/wadding, a long fiber or short fiber mixed nonwoven fabric, a felt, and the like. When another type of fibers are used together, a mixing ratio of the fibers is selected within the range of preferably 1% by weight or more, more preferably 10% by weight or more, and still more preferably 30% by weight in order to exhibit the characteristic features of the resin composition.

Examples of the another type of fibers to be mixed include cellulose fibers, such as cotton, hemp, rayon, and tencel fibers, etc.; wool, silk, acetate, polyester, nylon, acrylic, vinylon, polyolefin, and polyurethane fibers; and the like.

From the viewpoint of enhancing the hot water resistance, the resulting fiber or cloth can be properly subjected to a heat treatment. As the heat treatment, a generally known method can be applied, and for example, a method of bringing a heat source into direct contact with the fiber or cloth, a method of heating the fiber or cloth in a medium in a gas or liquid state, and the like can be applied. Examples of the heat source on the occasion of direct contact include steam, a hot roller, and the like. Examples of the medium include water, an organic solvent, a compound which becomes a melt at the heat treatment temperature, and the like. The melt may be either a low molecular weight compound or a high molecular weight compound. The heat treatment may be performed one time or two or more times, and the treatment may be performed by a combination of several methods. In the case of performing the heat treatment two or more times, the heat treatment temperature may be changed stepwise. As for the method of heating a gas or a liquid, a hot-air oven, a steam oven, an electric heater, an infrared ray heater, microwave irradiation, and the like can be properly selected.

From the viewpoint of suppressing the hydrolysis of the fiber or cloth during the hot water test, a method of heat treatment in which a decrease of the hydrolysis regulator (component B) in the molded article is controlled can be suitably applied. For example, a method in which the fiber or cloth is heat treated under pressured in a state where it is sealed within a closed vessel; a method in which the fiber or cloth is heat treated in the medium into which the hydrolysis regulator (component B) does not elute; a method in which the fiber or cloth is heat treated in the medium saturated with the hydrolysis regulator (component B); a method in which the fiber or cloth is heat treated in a state where it is physically covered; a combination of these methods; and the like can be suitably applied.

An ultimate heat treatment temperature may be properly set depending upon the melting point of the resin composition; however, from the viewpoint of efficiently enhancing the hot water resistance, a temperature in the range of 180° C. to 240° C., more preferably 190° C. to 235° C., still more preferably 200° C. to 230° C., and especially preferably 210° C. to 220° C. is selected.

A heat treatment time is not particularly specified and varies with the heat treatment method or heat treatment temperature. A time of 0.1 seconds to 120 minutes, preferably 0.1 seconds to 110 minutes, and more preferably 0.1 seconds to 100 minutes is selected.

The second invention of the present application is hereunder explained in detail.

### <High Molecular Weight Aliphatic Polyester (Component AA)>

As for a weight average molecular weight of the aliphatic polyester as the high molecular weight component, it is desired to make the molecular weight high as far as possible because when the decomposition is advanced in high-temperature hot water, the strength is lowered, so that not only the shape but also the strength cannot be kept. The weight average molecular weight is preferably in the range of 120,000 to 1,000,000. However, when the molecular weight is excessively high, the crystallinity is lowered, so that the molecular weight is in the range of preferably 120,000 to 500,000, and more preferably 120,000 to 300,000. It is necessary to select an appropriate molecular weight by combining the high molecular weight component with a low molecular weight component, and its ratio ((AA)/(BB)) is 1.2 or more, and preferably 1.3 or more.

### <Low Molecular Weight Aliphatic Polyester (Component BB)>

A weight average molecular weight of the aliphatic polyester as the low molecular weight component is appropriately 20,000 to 100,000.

When the weight average molecular weight is less than 20,000, though the crystallization degree is enhanced, the crystal size becomes small, and the melting point is actually decreased. When the weight average molecular weight is more than 100,000, the molecule size becomes large, so that it may be considered that conversely, the crystallinity is impaired, and the crystal size becomes small, whereby the melting point is decreased.

The weight average molecular weight of the low molecular weight component is appropriately 20,000 to 100,000, and preferably 30,000 to 80,000.

### <Resin Having Autocatalysis (Component CC) in a Composition Composed of a Combination of High and Low Molecular Weight Components>

In the present invention, in the resin containing, as a main component, a water-soluble monomer and having autocatalysis (component CC), the monomer generated by decomposition exhibits solubility in water, and the resin in which an acidic group generated by decomposition has autocatalysis, or at least apart of ends of the resin is sealed by the component B.

The term “water-soluble” referred to herein means that the solubility in water at 25° C. is 0.1 g/L or more. From the viewpoint that the resin composition to be used does not remain after decomposition, the solubility in water of the water-soluble monomer is preferably 1 g/L or more, more preferably 3 g/L or more, and still more preferably 5 g/L or more.

The “main component” means that it occupies 90 mol % or more of the constituent components. A proportion of the main component is preferably 95 to 100 mol %, and more preferably 98 to 100 mol %.

As the component CC, at least one member selected from the group consisting of polyesters, polyamides, polyamide-imides, polyimides, polyurethanes, and polyester amides is exemplified. An aliphatic polyester having optical isomers and capable of forming a stereocomplex crystal through combination thereof is preferred. There is a possibility of alloying of this component CC with a resin of other kind.

Examples of the polyester include polymers or copolymers obtained by polycondensing at least one member selected from a dicarboxylic acid or an ester forming derivative thereof, a diol or an ester forming derivative thereof, a hydroxycarboxylic acid or an ester forming derivative thereof, and a lactone. Preferably, polyesters composed of a hydroxycarboxylic acid or an ester forming derivative thereof are exemplified. More preferably, aliphatic polyesters composed of a hydroxycarboxylic acid or an ester forming derivative thereof are exemplified.

Such a thermoplastic polyester may contain a crosslinking structure treated with a radical generating source, for example, an energy active ray, an oxidizing agent, etc., from the standpoint of formability or the like.

Examples of the dicarboxylic acid or its ester forming derivative include aromatic dicarboxylic acids, such as terephthalic acid, isophthalic acid, phthalic acid, 2,6-naphthalenedicarboxylic acid, 1,5-naphthalenedicarboxylic acid, bis(p-carboxyphenyl)methane, anthracenedicarboxylic acid, 4,4′-diphenyl ether dicarboxylic acid, 5-tetrabutylphosphonium isophthalic acid, 5-sodiumsulfoisophthalic acid, etc. Aliphatic dicarboxylic acids, such as oxalic acid, succinic acid, adipic acid, sebacic acid, azelaic acid, dodecanedioic acid, malonic acid, glutaric acid, dimer acid, etc., are also exemplified. Alicyclic dicarboxylic acids, such as 1,3-cyclohexanedicarboxylic acid, 1,4-cyclohexanedicarboxylic acid, etc., are also exemplified. Ester forming derivatives thereof are also exemplified.

Examples of the diol or its ester forming derivative include aliphatic glycols having 2 to 20 carbon atoms, namely ethylene glycol, 1,3-propanediol, propylene glycol, 1,4-butanediol, neopentyl glycol, 1,5-pentandiol, 1,6-hexanediol, decamethylene glycol, cyclohexanedimethanol, cyclohexanediol, dimer diol, etc.

Long-chain glycols having a molecular weight of 200 to 100,000, namely polyethylene glycol, poly(1,3-propylene glycol), poly(1,2-propylene glycol), polytetramethylene glycol, etc., are also exemplified. Aromatic dioxy compounds, namely 4,4′-dihydroxybiphenyl, hydroquinone, tert-butylhydroquinone, bisphenol A, bisphenol S, bisphenol F, etc., are also exemplified. Ester forming derivatives thereof are also exemplified.

Examples of the hydroxycarboxylic acid include glycolic acid, lactic acid, hydroxypropionic acid, hydroxybutyric acid, hydroxyvaleric acid, hydroxycaproic acid, hydroxybenzoic acid, p-hydroxybenzoic acid, 6-hydroxy-2-naphthoic acid, and ester forming derivatives thereof, and the like. Examples of the lactone include caprolactone, valerolactone, propiolactone, undecalactone, 1,5-oxepan-2-one, and the like.

Examples of the aliphatic polyester include polymers containing an aliphatic hydroxycarboxylic acid as a main constituent component, polymers obtained by polycondensing an aliphatic multivalent carboxylic acid or an ester forming derivative thereof and an aliphatic polyhydric alcohol as main constituent components, and copolymers thereof.

Examples of the polymer containing an aliphatic hydroxycarboxylic acid as a main constituent component may include polycondensates of glycolic acid, lactic acid, hydroxypropionic acid, hydroxybutyric acid, hydroxyvaleric acid, hydroxycaproic acid, or the like, and copolymers thereof. Above all, polyglycolic acid, polylactic acid, poly(3-hydroxycarbonbutyric acid), poly(4-polyhydroxybutyric acid), poly(3-hydroxyhexanoic acid), polycaprolactone, and copolymers thereof, and the like are exemplified. In particular, poly(L-lactic acid), poly(D-lactic acid), stereocomplex polylactic acid, and racemic polylactic acid are exemplified. Stereocomplex polylactic acid is especially preferred because it has a high melting point.

Polymers containing an aliphatic multivalent carboxylic acid and an aliphatic polyhydric alcohol as main constituent components are exemplified. Examples of the multivalent carboxylic acid include aliphatic dicarboxylic acids, such as oxalic acid, succinic acid, adipic acid, sebacic acid, azelaic acid, dodecanedioic acid, malonic acid, glutaric acid, dimer acid, etc.; alicyclic dicarboxylic acid units, such as 1,3-cyclohexanedicarboxylic acid, 1,4-cyclohexanedicarboxylic acid, etc.; and ester forming derivatives thereof. Examples of the diol component include aliphatic glycols having 2 to 20 carbon atoms, such as ethylene glycol, 1,3-propanediol, propylene glycol, 1,4-butanediol, neopentyl glycol, 1,5-pentanediol, 1,6-hexanediol, decamethylene glycol, cyclohexanedimethanol, cyclohexanediol, dimer diol, etc. Long-chain glycols having a molecular weight of 200 to 100,000, namely polyethylene glycol, poly(1,3-proylene glycol), poly(1,2-propylene glycol), and polytetramethylene glycol are exemplified. Specifically, polyethylene adipate, polyethylene succinate, polybutylene adipate, polybutylene succinate, and copolymers thereof, and the like are exemplified.

The polyester can be produced by well-known methods (for example, methods described in Saturated Polyester Resin Handbook (written by Kazuo Yuki, Nikkan Kogyo Shimbun Ltd. (published on Dec. 22, 1989)).

Furthermore, examples of the polyester include, in addition to the above-described polyesters, unsaturated polyester resins obtained by copolymerizing an unsaturated multivalent carboxylic acid or an ester forming derivative; and polyester elastomers containing a low melting-point polymer segment.

Examples of the unsaturated multivalent carboxylic acid include maleic anhydride, tetrahydromaleic anhydride, fumaric acid, endomethylene tetrahydromaleic anhydride, and the like. In such an unsaturated polyester, for the purpose of controlling its curing properties, various monomers are added, and the unsaturated polyester is cured by means of thermal curing, radical curing, or curing with an active energy ray, such as light, electron beams, etc., and then molded.

Furthermore, in the present invention, the polyester may also be a polyester elastomer obtained by copolymerizing a soft component. The polyester elastomer is a block copolymer composed of a high melting-point polyester segment and a low melting-point polymer segment having a molecular weight of 400 to 6,000 as described in publicly known literatures, for example, JP-A-11-92636, or the like. In the case of forming a polymer by using only a high melting-point polyester segment, its melting point is 150° C. or higher, and such a polymer can be suitably used.

The polyester is preferably a polyester composed of a hydroxycarboxylic acid or an ester forming derivative thereof. An aliphatic polyester composed of a hydroxycarboxylic acid or an ester forming derivative thereof is more preferred. Furthermore, it is especially preferred that the aliphatic polyester is poly(L-lactic acid), poly(D-lactic acid), or stereocomplex polylactic acid.

Here, as for the polylactic acid, its main chain is composed of a lactic acid unit represented by the following formula. In this specification, the term “mainly” means that a proportion of the unit is preferably 90 to 100 mol %, more preferably 95 to 100 mol %, and still more preferably 98 to 100 mol %.

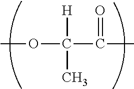

The lactic acid unit represented by the foregoing formula includes an L-lactic acid unit and a D-lactic acid unit, which are an optical isomer each other. It is preferred that a main chain of the polylactic acid is mainly an L-lactic acid unit, a D-lactic acid unit, or a combination thereof.

The polylactic acid is preferably poly(D-lactic acid) in which a main chain thereof is composed mainly of a D-lactic acid unit, or poly(L-lactic acid) in which a main chain thereof is composed mainly of an L-lactic acid unit. A proportion of other unit constituting the main chain is in the range of preferably 0 to 10 mol %, more preferably 0 to 5 mol %, and still more preferably 0 to 2 mol %.

Examples of the other unit constituting the main chain include units derived from a dicarboxylic acid, a polyhydric alcohol, a hydroxycarboxylic acid, a lactone, or the like.

Examples of the dicarboxylic acid include succinic acid, adipic acid, azelaic acid, sebacic acid, terephthalic acid, isophthalic acid, and the like. Examples of the polyhydric alcohol include aliphatic polyhydric alcohols, such as ethylene glycol, propylene glycol, butanediol, pentanediol, hexanediol, octanediol, glycerin, sorbitan, neopentyl glycol, diethylene glycol, triethylene glycol, polyethylene glycol, polypropylene glycol, etc.; aromatic polyhydric alcohols, such as bisphenol having ethylene oxide added thereto, etc.; and the like. Examples of the hydroxycarboxylic acid include glycolic acid, hydroxybutyric acid, and the like. Examples of the lactone include glycolide, ε-caprolactone, β-propiolactone, δ-butyrolactone, β- or γ-butyrolactone, pivalolactone, δ-valerolactone, and the like.

For the purpose of making both mechanical physical properties of a molded article and formability compatible with each other, a weight average molecular weight of the polylactic acid is in the range of preferably 50,000 to 500,000, more preferably 80,000 to 350,000, and still more preferably 120,000 to 250,000 in terms of a weight average molecular weight in average. The weight average molecular weight is a value obtained by measurement by means of gel permeation chromatography (GPC) and conversion into standard polystyrene.

It is preferred that the polylactic acid (component AA or BB) is poly(D-lactic acid) or poly(L-lactic acid) and that when measured by a differential scanning calorimeter (DSC), the polylactic acid has a crystal melting peak (Tmh) at a temperature between 150 to 190° C. and a crystal melting heat (ΔHmsc) of 10 J/g or more in a hydrolysis regulator-incorporated state. When the foregoing ranges of the crystal melting point and crystal melting heat are satisfied, the heat resistance can be increased.

The main chain of the polylactic acid is preferably stereocomplex polylactic acid containing a stereocomplex phase formed of a poly(L-lactic acid) unit and a poly(D-lactic acid) unit.

In the stereocomplex polylactic acid, a stereocomplex crystallization degree (S) as prescribed by the following equation is preferably 90 to 100%.

S=[ΔHms/(ΔHmh+ΔHms)]×100

(Here, ΔHms represents a melting enthalpy of the stereocomplex-phase polylactic acid crystal, and ΔHmh represents a melting enthalpy of the polylactic acid homo-phase crystal.)

The crystallization degree of the stereocomplex polylactic acid, particularly the crystallization degree by the XRD measurement is in the range of preferably at least 5%, more preferably 5 to 60%, still more preferably 7 to 60%, and especially preferably 10 to 60%.

The crystal melting point of the stereocomplex polylactic acid is in the range of preferably 190 to 250° C., and more preferably 220 to 250° C. The crystal melting enthalpy of the stereocomplex polylactic acid by the DSC measurement is in the range of preferably 20 J/g or more, more preferably 20 to 80 J/g, and still more preferably 30 to 80 J/g. When the crystal melting point of the stereocomplex polylactic acid is lower than 190° C., the heat resistance is worsened. In particular, in order that neither melting nor fusion may be caused in high-temperature water, the melting point in a hydrolysis regulator-incorporated state is more preferably 216° C. or higher, and still more preferably 220° C. or higher. When it is higher than 250° C., molding at a high temperature of 250° C. or higher is needed, so that there may be the case where it is difficult to inhibit the heat decomposition of the resin. In consequence, it is preferred that when measured by a differential scanning calorimeter (DSC), the resin composition of the present invention exhibits a crystal melting peak of 220° C. or higher.

Meanwhile, by measuring the melting point in water, the melting or fusion in hot water can be evaluated directly.

In particular, in order to prevent the fusion in hot water at 170° C. or higher, the melting point in water is preferably 190° C. or higher, more preferably 192° C. or higher, and still more preferably 194° C. or higher.

In the stereocomplex polylactic acid, a weight ratio of poly(D-lactic acid) to poly(L-lactic acid) is in the range of preferably 90/10 to 10/90, more preferably 80/20 to 20/80, still more preferably 30/70 to 70/30, and especially preferably 40/60 to 60/40. Theoretically, it is preferred that the weight ratio is close to 1/1 as far as possible.

A weight average molecular weight of the stereocomplex polylactic acid is in the range of preferably 70,000 to 500,000, more preferably 80,000 to 350,000, and still more preferably 120,000 to 250,000. The weight average molecular weight is a value obtained by measurement by means of gel permeation chromatography (GPC) and conversion into standard polystyrene.

The poly(L-lactic acid) and poly(D-lactic acid) can be produced by a conventionally known method. For example, the poly(L-lactic acid) and poly(D-lactic acid) can be produced by subjecting L-lactide or D-lactide to ring-opening polymerization, respectively in the presence of a metal-containing catalyst. The poly(L-lactic acid) and poly(D-lactic acid) can also be produced by subjecting a low-molecular weight polylactic acid containing a metal-containing catalyst, after being optionally crystallized or without being crystallized, to solid-phase polymerization under reduced pressure or by pressurization from atmospheric pressure in the presence or absence of an inert gas stream. Furthermore, the poly(L-lactic acid) and poly(D-lactic acid) can be produced by a direct polymerization method of subjecting lactic acid to dehydration condensation in the presence or absence of an organic solvent.

The polymerization reaction can be carried out in a conventionally known reaction vessel, and for example, in the ring-opening polymerization or direct polymerization method, a vertical reactor or horizontal reactor equipped with a high viscosity stirring blade, such as a helical ribbon blade, etc., can be used alone or in parallel. All of a batch type, a continuous type, and a semi-batch type may be used, or these may be combined.

An alcohol may be used as a polymerization initiator. It is preferred that such an alcohol does not hinder the polymerization of polylactic acid and is nonvolatile, and for example, decanol, dodecanol, tetradecanol, hexadecanol, octadecanol, ethylene glycol, trimethylolpropane, pentaerythritol, or the like can be suitably used. It may be said that an embodiment in which the polylactic acid prepolymer used in the solid-phase method is previously crystallized is preferred from the standpoint of preventing the fusion of resin pellets. The prepolymer is polymerized in a state of solid at a temperature in the range of a glass transition temperature of the prepolymer or higher and lower than a melting point thereof in a fixed vertical reaction vessel or horizontal reaction vessel, or a reaction vessel (rotary kiln, etc.) in which the vessel itself rotates, such as a tumbler or a kiln.

Examples of the metal-containing catalyst include fatty acid salts, carbonates, sulfates, phosphates, oxides, hydroxides, halides, alcoholates, and like of an alkali metal, an alkaline earth metal, a rare-earth element, a transition metal, aluminum, germanium, tin, antimony, titanium, etc. Above all, fatty acid salts, carbonates, sulfates, phosphates, oxides, hydroxides, halides, and alcoholates containing at least one metal selected from tin, aluminum, zinc, calcium, titanium, germanium, manganese, magnesium, and a rare-earth element are preferred.

Specifically, from the standpoints of catalytic activity and less occurrence of a side reaction, tin-containing compounds, such as stannous chloride, stannous boride, stannous iodide, stannous sulfate, stannic oxide, tin myristate, tin octylate, tin stearate, tetraphenyltin, etc., are exemplified as a preferred catalyst. Above all, tin(II) compounds, specifically diethoxytin, dinonyloxytin, tin(II) myristate, tin(II) octylate, tin(II) stearate, tin(II) chloride, and the like, are suitably exemplified.

A use amount of the catalyst is 0.42×10⁻⁴ to 100×10⁻⁴ (mol) per kg of the lactide, and furthermore, taking into consideration the reactivity, the color tone of the obtained polylactide, and the stability, the catalyst is used in an amount of preferably 1.68×10⁻⁴ to 42.1×10⁻⁴ (mol), and especially preferably 2.53×10⁻⁴ to 16.8×10⁻⁴ (mol).

It is preferred that the metal-containing catalyst used for the polymerization of polylactic acid is inactivated with a conventionally known deactivator prior to the use for polylactic acid. Examples of such a deactivator include organic ligands consisting of a group of chelate ligands having an imino group and capable of coordinating to the polymerization metal catalyst.

Low oxidation number phosphoric acids having an acid number of 5 or less, such as dihydride oxophosphoric acid (I), dihydride tetraoxodiphosphoric acid (II, II), hydride trioxophosphoric acid (III), dihydride pentaoxodiphosphoric acid (III), hydride pentaoxodiphosphoric acid (II, IV), dodecaoxohexaphosphoric acid (III), hydride octaoxotriphosphoric acid (III, IV, IV), octaoxotriphosphoric acid (IV, III, IV), hydride hexaoxodiphosphoric acid (III, V), hexaoxodiphosphoric acid (IV), decaoxotetraphosphoric acid (IV), hendecaoxotetraphosphoric acid (IV), and enneaoxotriphosphoric acid (V, IV, IV), etc., are also exemplified.

Orthophosphoric acids represented by the formula: xH₂O.yP₂O₅ and satisfying x/y=3 are also exemplified. Polyphosphoric acids called “diphosphoric acid, triphosphoric acid, tetraphosphoric acid, pentaphosphoric acid, and the like” according to the degree of condensation and satisfying (2>x/y>1), and mixtures thereof are also exemplified. Metaphosphoric acids satisfying x/y=1, especially trimetaphosphoric acid and tetrametaphosphoric acid are also exemplified. Ultraphosphoric acids having a network structure in which a part of the phosphorus pentoxide structure remains and satisfying (1>x/y>0) (may be collectively referred to as “metaphosphoric acid-based compounds”) are also exemplified. Acidic salts of these acids are also exemplified. Partial esters or whole esters of such an acid with a monohydric or polyhydric alcohol, or a polyalkylene glycol are also exemplified.

Phosphono-substituted lower aliphatic carboxylic acid derivatives of these acids, and the like are also exemplified.

From the standpoint of catalyst deactivation ability, orthophosphoric acids represented by the formula: xH₂O.yP₂O₅ and satisfying x/y=3 are preferred. Polyphosphoric acids called “diphosphoric acid, triphosphoric acid, tetraphosphoric acid, pentaphosphoric acid, and the like” according to the degree of condensation and satisfying (2>x/y>1), and mixtures thereof are also preferred. Metaphosphoric acids satisfying x/y=1, especially trimetaphosphoric acid and tetrametaphosphoric acid are also preferred. Ultraphosphoric acids having a network structure in which a part of the phosphorus pentoxide structure remains and satisfying (1>x/y>0) (may be collectively referred to as “metaphosphoric acid-based compounds”) are also preferred. Acidic salts of these acids are also preferred. Partial esters of such an acid with a monohydric or polyhydric alcohol, or a polyalkylene glycol are also preferred.

The metaphosphoric acid-based compound which is used in the present invention includes cyclic metaphosphoric acids in which about 3 to 200 phosphoric acid units are condensed, ultra-region metaphosphoric acids having a three-dimensional network structure, and (alkali metal salts, alkaline earth metal salts, and onium salts) thereof. Above of all, cyclic sodium metaphosphate, ultra-region sodium metaphosphate, dihexylphosphonoethyl acetate (hereinafter sometimes abbreviated as DHPA) of a phosphono-substituted lower aliphatic carboxylic acid derivative, and the like are suitably used.

The polylactic acid is preferably one having a lactide content of 5,000 ppm or less. The lactide contained in the polylactic acid deteriorates the resin and worsens the color tone at the time of melting processing, and as the case may be, there is a concern that it makes the resin unusable as a product.

Although the poly(L-lactic acid) and/or poly(D-lactic acid) immediately after melt ring-opening polymerization generally contains 1 to 5% by weight of the lactide, the content of lactide can be reduced to a preferred range in any stage between the end of polymerization of poly(L-lactic acid) and/or poly(D-lactic acid) and molding of polylactic acid by carrying out conventionally known lactide reduction methods, namely, a vacuum devolatilization method with a single-screw or multi-screw extruder, or a high-vacuum treatment within a polymerizer, or the like alone or in combination.

The lower the lactide content, the more enhanced the melt stability and moist heat stability of the resin. However, since the lactide has such an advantage that it reduces the melt viscosity of the resin, it is rational and economical to set the lactide content to a value suitable for a desired purpose. That is, it is rational to set the lactide content to 1,000 ppm or less so as to achieve practical melt stability. The lactide content is selected within the range of more preferably 700 ppm or less, still more preferably 500 ppm or less, and especially preferably 100 ppm or less. When the polylactic acid component has the lactide content of the foregoing range, there are brought such advantages that the stability of the resin at the time of melt forming of a molded article of the present invention is enhanced; and that the molded article can be efficiently produced, and the moist heat stability and low gas properties of the molded article can be increased.

The stereocomplex polylactic acid can be obtained by bringing poly(L-lactic acid) and poly(D-lactic acid) into contact with each other in a weight ratio in the range of 10/90 to 90/10, preferably bringing them into melt contact with each other, and more preferably melt kneading them together. A contact temperature is in the range of preferably 220 to 290° C., more preferably 220 to 280° C., and still more preferably 225 to 275° C. from the viewpoints of enhancements of the stability at the time of melting of polylactic acid and the stereocomplex crystallization degree.

Although the melt kneading method is not particularly limited, a conventionally known batch type or continuous type melt mixer is preferably used. For example, a melt stirring tank, a single-screw or double-screw extruder, a kneader, an anaxial basket-type stirring tank, “VIBOLAC (registered trademark)”, manufactured by Sumitomo Heavy Industries, Inc., N-SCR, manufactured by Mitsubishi Heavy Industries, Ltd., a spectacle blade, a lattice blade, or a Kenix type stirrer, manufactured by Hitachi, Ltd., or a tubular polymerizer equipped with a Sulzer SMLX type static mixer can be used. Above all, an anaxial basket type stirring tank that is a self-cleaning type polymerizer, N-SCR, a double-screw extruder, and the like are preferred from the viewpoint of productivity and quality, especially color tone of the polylactic acid.

### <Hydrolysis Regulator (Component DD)>

In the present invention, the hydrolysis regulator (component DD) is an agent for sealing an end group of the resin (component CC) and an acidic group generated by decomposition. That is, the hydrolysis regulator (component DD) is an agent having an effect for inhibiting the autocatalysis of the resin (component CC) to delay the hydrolysis.

As the acidic group, at least one member selected from the group consisting of a carboxyl group, a sulfonic acid group, a sulfinic acid group, a phosphonic acid group, and a phosphinic acid group is exemplified. In the present invention, a carboxyl group is especially exemplified.

Since the requirement for use is concerned with the use in hot water at a higher temperature than 135° C., it is preferred that the component CC has a water resistance at 120° C. of 95% or more and a reactivity with an acidic group at 190° C. of 50% or more.

The water resistance at 120° C. as referred to herein is, for example, a value expressed by the following equation by using 1) a calculated value of an agent remaining without being changed 5 hours after the treatment, the value being calculated by means of analysis of a dissolved portion at the time of adding 2 g of water to a system having 1 g of the component B dissolved in 50 mL of dimethyl sulfoxide and stirring the resultant at 120° C. for 5 hours while refluxing, or 2) a calculated value determined by performing the same treatment as that in the foregoing 1) using a solvent capable of dissolving the component CC therein and having hydrophilicity in the case where the component B is not soluble in dimethyl sulfoxide.

Water resistance (%)=[(Amount of the agent 5 hours after the treatment)/(Initial amount of the agent)]×100

Incidentally, in 2), when a boiling point of the solvent to be used is lower than 120° C., the solvent was mixed with dimethyl sulfoxide in a range where at least a part of the component CC is soluble therein, and 50 mL of the mixed solvent was used. Although a mixing proportion may be generally selected within the range of 1/2 to 2/1, it is not particularly limited so long as the above-described requirement is satisfied. In general, so long as the solvent which is used in 2) is selected from tetrahydrofuran, N,N-dimethylformamide, and ethyl acetate, the component CC is soluble therein.

Besides, the water resistance may also be expressed by an equivalent evaluation.

In the case of evaluating an instable agent for the water resistance, a part of the agent is denatured by the hydrolysis, and the sealing ability of the acidic group is lowered. In the case of using such an agent in high-temperature hot water, the agent is deactivated by the water, and the ability for sealing the target acidic group is remarkably lowered. In view of the foregoing, the water resistance at 120° C. is more preferably 97% or more, still more preferably 99% or more, and especially preferably 99.9% or more. That is, when the water resistance is 99.9% or more, namely the agent is stable in high-temperature hot water, the reaction with the acidic group can be performed selectively and efficiently.

The reactivity with an acidic group at 190° C. as referred to herein is, for example, a value obtained by measuring a carboxyl group concentration regarding a resin composition obtained by adding the agent in an amount such that the group of the hydrolysis regulator, reacting with the carboxyl group, is corresponding to 1.5 equivalents to the carboxyl group concentration of the polylactic acid for evaluation to 100 parts by weight of the polylactic acid for evaluation, followed by melt kneading under a nitrogen atmosphere at a resin temperature of 190° C. and at a rotation rate of 30 rpm for 1 minute by using a Labo Plasto mill (manufactured by Toyo Seiki Seisaku-Sho, Ltd.), the value being given according to the following equation.

Reactivity (%)=[{(Carboxyl group concentration of polylactic acid for evaluation)−(Carboxyl group concentration of resin composition)}/(Carboxyl group concentration of polylactic acid for evaluation)]×100

The polylactic acid for evaluation is preferably one having an MW of 120,000 to 200,000 and a carboxyl group concentration of 10 to 30 equivalents/ton. As such polylactic acid, for example, polylactic acid “NW3001D”, manufactured by NatureWorks LLC (MW: 150,000, carboxyl group concentration: 22.1 equivalents/ton) and the like can be suitably used. In that case, a value of the reactivity can be determined by measuring a carboxyl group concentration regarding a resin composition obtained by adding the agent in an amount such that the group of the hydrolysis regulator, reacting with the carboxyl group, is 33.15 equivalents/ton, followed by melt kneading under a nitrogen atmosphere at a resin temperature of 190° C. and at a rotation rate of 30 rpm for 1 minute by using a Labo Plasto mill (manufactured by Toyo Seiki Seisaku-Sho, Ltd.).

Besides, the reactivity with an acidic group may also be given by the equivalent evaluation.

In the case of evaluating a stable agent for the reactivity, even when kneading is performed under the above-described condition, the carboxyl group concentration of the resent composition does not substantially change. In the case of using such an agent in high-temperature hot water, the ability for sealing the target acidic group is not substantially revealed, and therefore, the decomposition of the resin (component CC) cannot be inhibited.

In view of the foregoing, the reactivity with an acidic group at 190° C. is more preferably 60% or more, still more preferably 70% or more, and especially preferably 80% or more. That is, when the reactivity is 80% or more, namely the reactivity with an acidic group in high-temperature hot water is high, the reaction with the acidic group can be efficiently performed.

It is important that the hydrolysis regulator (component DD) of the present invention has a water resistance at 120° C. of 95% or more and a reactivity with an acidic group at 190° C. of 50% or more. That is, in a very stable agent, though the water resistance is a high value, the reactivity with an acidic group is a low value, and in that case, the ability for sealing the target acidic group in high-temperature hot water is not substantially revealed. In a very instable agent, though the reactivity with an acidic group is a high value, the water resistance is a low value, and in that case, the agent is deactivated with water in high-temperature hot water, and therefore, the ability for sealing the target acidic group is remarkably lowered.

In view of the foregoing, the hydrolysis regulator having high water resistance and reactivity with an acidic group is suitably used in the present invention.

Examples of the component DD include addition reaction type compounds, such as carbodiimide compounds, isocyanate compounds, epoxy compounds, oxazoline compounds, oxazine compounds, aziridine compounds, etc. These compounds can be used in combination of two or more thereof. From the viewpoints of water resistance and reactivity with an acidic group, carbodiimide compounds are preferably exemplified.

As the carbodiimide compound, a compound having a basic structure represented by each of the following two general formulae can be exemplified.

R—N═C═N—R′

(In the formula, each of R and R′ is independently an aliphatic group having 1 to 20 carbon atoms, an alicyclic group having 3 to 20 carbon atoms, an aromatic group having 5 to 15 carbon atoms, or a combination thereof, and may contain a hetero atom; and R and R′ may be bonded to each other to form a cyclic structure, and may form two or more cyclic structures through a spiro structure or the like.)

N═C═N—R″ₙ

(In the formula, each R″ is independently an aliphatic group having 1 to 20 carbon atoms, an alicyclic group having 3 to 20 carbon atoms, an aromatic group having 5 to 15 carbon atoms, or a combination thereof, and may contain a hetero atom; and n is an integer of 2 to 1,000.)

From the viewpoint of stability or easiness of handling, aromatic carbodiimide compounds are more preferred. Examples thereof include aromatic carbodiimide compounds represented by the following two formulae.

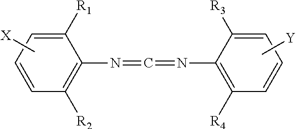

(In the formula, each of R₁ to R₄ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure, and may form two or more cyclic structures through a spiro structure or the like.)

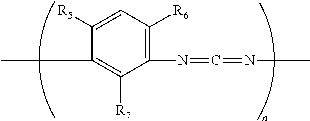

(In the formula, each of R₅ to R₇ is independently an aliphatic group having 1 to 20 carbon atoms, an alicyclic group having 3 to 20 carbon atoms, an aromatic group having 5 to 15 carbon atoms, or a combination thereof, and may contain a hetero atom; and n is an integer of 2 to 1,000.)

Specific examples of such an aromatic carbodiimide compound include polycarbodiimides synthesized by subjecting bis(2,6-diisopropylphenyl)carbodiimide or 1,3,5-triisopropylbenzene-2,4-diisocyanate to a decarboxylation condensation reaction, a combination of these two kinds, and the like.

### <Resin Composition>

The resin composition of the present invention satisfies any one of the following AA1 to AA3:

AA1: In hot water at an arbitrary temperature of 135° C. to 160° C., after 3 hours, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less;
AA2: In hot water at an arbitrary temperature of 160° C. to 180° C., after 2 hour, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less; and
AA3: In hot water at an arbitrary temperature of 180° C. to 220° C., after 1 hour, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less.

In order that the resin composition of the present invention may exhibit the desired performance, it is important to control the resin composition so as to be quickly decomposed after keeping the weight and shape of the resin in hot water at a higher temperature than 135° C. for a fixed period of time.

Although the fixed period of time is determined according to an application, it is preferably any of 10 minutes to 12 hours. From the viewpoint of exhibiting the desired performance, the fixed period of time is more preferably any of 30 minutes to 6 hours, and still more preferably any of 30 minutes to 4 hours.

As for the matter of keeping the weight and shape of the resin, it is preferred that the weight of the water-insoluble matter of the resin composition is 50% or more; and that the amount of volume change expressing the shape is 50% or less. For example, even when the weight of the water-insoluble matter of the resin composition is 50% or more, it may not be said in the completely hydrolyzed state that the weight and shape of the resin are kept. From the viewpoint of exhibiting the desired performance, the weight of the water-insoluble matter of the resin composition is more preferably 70% or more, and still more preferably 90% or more. The amount of volume change expressing the shape is more preferably 30% or less, and still more preferably 10% or less.

Here, the weight and the amount of volume change of the shape of the resin are, for example, values given by the following evaluations.

A closed melting crucible (manufactured by OM Lab-Tech Co., Ltd., MR-28, capacity: 28 mL) preheated at 110° C. is charged with 300 mg of the resin composition and 12 mL of distilled water and hermetically sealed, and the crucible is allowed to stand within a hot air dryer (manufactured by Koyo Thermo Systems Co., Ltd., KLO-45M,) previously kept at a prescribed temperature.

After allowing the crucible to stand, a time when the temperature in the interior of the crucible reaches a prescribed test temperature after the crucible is allowed to stand in the hot air dryer is defined as a point of time of starting the test, and at a point of time when a certain period of time elapses from this point of time of starting the test, the crucible is taken out from the hot air dryer. The crucible taken out from the hot air dryer is air-cooled for 20 minutes and then cooled to ordinary temperature for 10 minutes by means of water cooling, and thereafter, the crucible is opened to recover the sample and water in the interior of the crucible.

The sample and water in the interior of the crucible are subjected to filtration using a filter paper (in conformity with JIS P3801:1995, class 5A); the resin composition remaining on the filter paper is dried at 60° C. under a vacuum of 133.3 Pa or less for 3 hours; thereafter, the weight of the resin composition and the volume of the shape are measured; and the weight (%) and the amount of volume change of the shape (%) of the resin are determined according to the following equations.

Weight (%)=[(Weight of resin composition after treatment for a fixed period of time)/(Weight of resin composition at the initial stage)]×100

Amount of volume change of shape (%)=[(Volume of resin composition after treatment for a fixed period of time)/(Volume of resin composition at the initial stage)]×100

Here, the volume of the shape is a value determined by measuring the resin composition by a stereoscopic microscope.

As the stereomicroscope, M205C, manufactured by Leica Microsystems, and the like can be used.

Incidentally, in this evaluation, with respect to the size of the resin composition, for example, so far as a pellet-like material is concerned, those close to a cube or rectangular parallelepiped of 0.5 mm to 5 mm in each side; so far as a fibrous material is concerned, fibers having a yarn thickness of 1 μm to 1,000 μm and a yarn length of 1 mm to 40 mm; and so far as a filmy material is concerned, films having a thickness of 50 μm to 1,000 μm and the length and the width each of 5 mm to 50 mm, can be generally used.

Besides, the weight and the amount of volume change of the shape of the resin may also be given by the equivalent evaluation.

The matter that the resin is quickly decomposed means the state in which the hydrolysis of the component CC is promoted by the autocatalysis, and the concentration of the acidic group exponentially increases. Conversely, during the period when the concentration of the acidic group is kept lower by the component DD, the decomposition of the component AA becomes gentle. For that reason, during the period when the weight and shape of the resin are kept, it is preferred that the concentration of the acidic group derived from the resin composition is 30 equivalents/ton or less.

In the case where the concentration of the acidic group is more than 30 equivalents/ton, the hydrolysis of the component CC is promoted due to the autocatalysis, and the effect of the component DD is not sufficiently exhibited. When the concentration of the acidic group is lower, the change of the weight or the shape of the resin composition can be inhibited. Therefore, from the viewpoint that the desired performance is exhibited, during the period when the weight and shape of the resin are kept, the concentration of the acidic group derived from the resin composition is more preferably 20 equivalents/ton or less, still more preferably equivalents/ton or less, and especially preferably 3 equivalents/ton or less.

Here, the concentration of the acidic group derived from the resin composition can be, for example, determined by preparing a resin composition in the same manner as that used in the above-described evaluation for determining the weight and the amount of volume change of the shape of the resin and measuring the resulting resin composition by means of ¹H-NMR.

The resin composition of the present invention can be suitably used in hot water at an arbitrary temperature of 135° C. to 220° C. When the temperature is 135° C. or lower, there may be the case where the desired performance can be exhibited by using only the component CC. In addition, when even the temperature is higher than 220° C., there may be the case where the resin composition of the present invention is immediately decomposed, so that the desired performance cannot be exhibited. For that reason, the resin composition of the present invention can be more suitably used in hot water at an arbitrary temperature of 150° C. to 220° C., can be still more suitably used in hot water at an arbitrary temperature of 170° C. to 210° C., and can be yet still more suitably used in hot water at an arbitrary temperature of 190° C. to 210° C.

The resin composition of the present invention satisfies any one of the following AA1 to AA3:

AA1: In hot water at an arbitrary temperature of 135° C. to 160° C., after 3 hours, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less;
AA2: In hot water at an arbitrary temperature of 160° C. to 180° C., after 2 hour, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less; and
AA3: In hot water at an arbitrary temperature of 180° C. to 220° C., after 1 hour, not only a resin composition-derived acidic group concentration is 30 equivalents/ton or less, but also a weight of a water-insoluble matter of the resin composition is 50% or more, and after 24 hours, a weight of a water-insoluble matter of the resin composition is 50% or less.

The range where the resin composition of the present invention can be suitably used varies with the temperature. In AA1 to AA3, at a time faster than the prescribed fixed period of time (1 hour, 2 hours, or 3 hours), it is preferred that the resin composition-derived acidic group concentration is equivalents/ton or less, but also the weight of the water-insoluble matter of the resin composition is 50% or more.

In AA1, the fixed period of time is 3 hours, and it is expressed that during that time, the weight and shape of the resin are kept. From the viewpoint of exhibiting the desired performance in the excavation technology in the oil field or the like, in hot water at an arbitrary temperature of 135° C. to 160° C., after a fixed period of time longer than 2 hours as defined in the present invention, the resin composition-derived acidic group concentration may be 30 equivalents/ton or less, and the weight of the water-insoluble matter of the resin composition may be 50% or more.

In AA2, the fixed period of time is 2 hours, and it is expressed that during that time, the weight and shape of the resin are kept. From the viewpoint of exhibiting the desired performance in the excavation technology in the oil field or the like, in hot water at an arbitrary temperature of 160° C. to 180° C., after a fixed period of time longer than 2 hours as defined in the present invention, the resin composition-derived acidic group concentration may be 30 equivalents/ton or less, and the weight of the water-insoluble matter of the resin composition may be 50% or more.

In AA3, the fixed period of time is 1 hour, and it is expressed that during that time, the weight and shape of the resin are kept. From the viewpoint of exhibiting the desired performance in the excavation technology in the oil field or the like, in hot water at an arbitrary temperature of 180° C. to 220° C., after a fixed period of time longer than 1 hour as defined in the present invention, the resin composition-derived acidic group concentration may be 30 equivalents/ton or less, and the weight of the water-insoluble matter of the resin composition may be 50% or more.

After the fixed period of time prescribed in each of AA1 to AA3 (1 hour, 2 hours, or 3 hours), the effect for sealing the acidic group by the component BB vanishes, the decomposition of the resin is promoted due to the autocatalysis of the acidic group, and following that, the concentration of the acidic group exponentially increases. Furthermore, when the decomposition proceeds, the resin becomes a water-soluble monomer, whereby it becomes soluble in water. The matter that the instant phenomenon occurs quickly as far as possible after the weight and shape of the resin are kept for a fixed period of time is suitable on the occasion of using the resin composition of the present invention in the excavation technology in the oil field or the like. For that reason, it is preferred that after 24 hours, the weight of the water-insoluble matter of the resin composition is 50% or less. For the foregoing reason, it is more preferred that after 18 hours, the weight of the water-insoluble matter of the resin composition is 50% or less; it is still more preferred that after 12 hours, the weight of the water-insoluble matter of the resin composition is 50% or less; and it is yet still more preferred that after 6 hours, the weight of the water-insoluble matter of the resin composition is 50% or less.

As for the resin composition of the present invention, it is preferred that in hot water at an arbitrary temperature of 135° C. to 220° C., after 100 hours, the weight of the water-insoluble matter of the resin composition is 10% or less. For example, on the occasion of using the resin composition in the excavation technology in the oil field or the like, the resin composition is dissolved in water quickly after keeping the weight and shape of the resin for a fixed period of time, whereby it can effectively work. For that reason, it is preferred that in hot water at an arbitrary temperature of 135° C. to 220° C., after 100 hours, the weight of the water-insoluble matter of the resin composition is 10% or less. From the viewpoints of treatment in water after the use and exhibition of the desired performance, it is desirable that the water-insoluble matter is low as far as possible, and after 100 hours, the weight of the water-insoluble matter of the resin composition is more preferably 5% or less, and still more preferably 1% or less.

It is preferred that a heat deformation temperature of the resin composition of the present invention is 135° C. to 300° C. Here, the heat deformation temperature refers to a melting point or softening point of the resin composition. Since the resin composition is supposed to be used in hot water at a higher temperature than 135° C., when the heat deformation temperature of the resin composition is higher, the resin composition can be used in a wide temperature region. Meanwhile, when the heat deformation temperature is 300° C. or less, molding of the resin composition of the present invention is relatively easy. For that reason, the heat deformation temperature of such a resin composition is more preferably 150° C. to 300° C., still more preferably 165° C. to 300° C., yet still more preferably 170° C. to 300° C., even yet still more preferably 175° C. to 285° C., and especially preferably 180° C. to 285° C.

In the resin composition of the present invention, an addition amount of the component DD is 1 to 30 parts by weight based on 100 parts by weight of a total sum of the component CC and the component DD. When the addition amount of the component B is less than 1 part by weight, there may be the case where the sufficient effect for sealing the acidic group is not exhibited in hot water at a higher temperature than 135° C. When it is more than 30 parts by weight, there may be the case where bleedout of the component B from the resin composition, worsening of formability, or degeneration of properties of a substrate takes place. From such viewpoints, the addition amount of the component DD is preferably 1.5 to 20 parts by weight, more preferably 2 to 15 parts by weight, still more preferably 2.5 to 12.5 parts by weight, and especially preferably 3.0 to 10 parts by weight based on 100 parts by weight of a total sum of the component CC and the component DD.

### <Production Method of Resin Composition>

The resin composition of the present invention can be produced by melt kneading the resin containing, as a main component, a water-soluble monomer and having autocatalysis (component CC) and the hydrolysis regulator (component DD).

Incidentally, in the case of adopting polylactic acid as the resin containing, as a main component, a water-soluble monomer and having autocatalysis (component CC), poly(L-lactic acid) and poly(D-lactic acid), each of which is the resin containing, as a main component, a water-soluble monomer and having autocatalysis (component CC), and the hydrolysis regulator (component DD) are mixed to form a stereocomplex polylactic acid, and simultaneously, the resin composition of the present invention can also be produced. The resin composition of the present invention can also be produced by mixing poly(L-lactic acid) and poly(D-lactic acid) to form stereocomplex polylactic acid and then mixing the hydrolysis regulator (component DD).

The method of adding the hydrolysis regulator (component DD) to the resin containing, as a main component, a water-soluble monomer and having autocatalysis (component CC) and mixing them is not particularly limited, and a conventionally known method, such as a method of adding as a solution, a melt, or a master batch of the resin containing, as a main component, a water-soluble monomer and having autocatalysis (component CC) to be applied; a method of bringing a solid of the resin containing, as a main component, a water-soluble monomer and having autocatalysis (component CC) into contact with a liquid having the hydrolysis regulator (component DD) dissolved, dispersed or melted therein, thereby penetrating the hydrolysis regulator (component DD) thereinto; and the like can be adopted.

In the case of adopting a method of adding as a solution, a melt, or a master batch of the resin containing, as a main component, a water-soluble monomer and having autocatalysis (component CC) to be applied, a method of addition using a conventionally known kneading device can be adopted. On the occasion of kneading, a kneading method in a solution state or a kneading method in a molten state is more preferred from the viewpoint of uniform kneading properties. The kneading device is not particularly limited, and conventionally known vertical reaction vessels, mixing tanks, and kneading tanks, or single-screw or multi-screw horizontal kneading devices, for example, single-screw or multi-screw extruders and kneader, and the like are exemplified. A mixing time is not particularly specified, and though it varies with the mixing device or mixing temperature, a time of 0.1 minutes to 2 hours, preferably 0.2 minutes to 60 minutes, and more preferably 0.2 minutes to 30 minutes is selected.

As the solvent, those which are inert to the resin containing, as a main component, a water-soluble monomer and having autocatalysis (component CC) and the hydrolysis regulator (component DD) can be used. In particular, a solvent which has an affinity with the both components and at least partially dissolves the both components therein, is preferred.

As the solvent, for example, hydrocarbon-based solvents, ketone-based solvents, ester-based solvents, ether-based solvents, halogen-based solvents, amide-based solvents, and the like can be used.

Examples of the hydrocarbon-based solvent include hexane, cyclohexane, benzene, toluene, xylene, heptane, decane, and the like. Examples of the ketone-based solvent include acetone, methyl ethyl ketone, diethyl ketone, cyclohexanone, isophorone, and the like.

Examples of the ester-based solvent include ethyl acetate, methyl acetate, ethyl succinate, methyl carbonate, ethyl benzoate, diethylene glycol diacetate, and the like. Examples of the ether-based solvent include diethyl ether, dibutyl ether, tetrahydrofuran, dioxane, diethylene glycol dimethyl ether, triethylene glycol diethyl ether, diphenyl ether, and the like. Examples of the halogen-based solvent include dichloromethane, chloroform, tetrachloromethane, dichloroethane, 1,1′,2,2′-tetrachloroethane, chlorobenzene, dichlorobenzene, and the like. Examples of the amide-based solvent include formamide, N,N-dimethylformamide, N,N-dimethylacetamide, N-methyl-2-pyrrolidone, and the like. These solvents can be used alone or as a mixed solvent, if desired.

In the present invention, the solvent is applied in an amount in the range of 1 to 1,000 parts by weight based on 100 parts by weight of the resin composition. When the amount of the solvent is less than 1 part by weight, there is no meaning for the application of the solvent. Although an upper limit value of the use amount of the solvent is not particularly limited, it is about 1,000 parts by weight from the viewpoints of operability and reaction efficiency.

In the case of adopting a method of bringing a solid of the resin containing, as a main component, a water-soluble monomer and having autocatalysis (component CC) into contact with a liquid having the hydrolysis regulator (component DD) dissolved, dispersed or melted therein, a method of bringing a solid of the resin containing, as a main component, a water-soluble monomer and having autocatalysis (component CC) into contact with the hydrolysis regulator (component DD) dissolved in a solvent as described above; a method of bringing a solid of the resin containing, as a main component, a water-soluble monomer and having autocatalysis (component CC) into contact with an emulsion liquid of the hydrolysis regulator (component DD); and the like can be adopted.

As the contacting method, a method of dipping the resin containing, as a main component, a water-soluble monomer and having autocatalysis (component CC); a method of coating the resin containing, as a main component, a water-soluble monomer and having autocatalysis (component CC); a method of spraying the resin containing, as a main component, a water-soluble monomer and having autocatalysis (component CC); and the like can be suitably adopted.

Although it is possible to perform a sealing reaction of the acidic group of the resin containing, as a main component, a water-soluble monomer and having autocatalysis (component CC) with the hydrolysis regulator (component DD) at a temperature of room temperature (25° C.) to about 300° C., the sealing reaction is more promoted at a temperature in the range of preferably 50 to 280° C., and more preferably 100 to 280° C. from the viewpoint of reaction efficiency. As for the resin containing, as a main component, a water-soluble monomer and having autocatalysis (component CC), the reaction is liable to be more advanced at a temperature at which it is melted; however, in order to inhibit volatilization, decomposition, or the like of the hydrolysis regulator (component DD), it is preferred to perform the reaction at a temperature lower than 300° C. For the purposes of lowering the melting temperature of the resin containing, as a main component, a water-soluble monomer and having autocatalysis (component CC) and increasing the stirring efficiency, it is effective to apply a solvent.

Although the reaction is sufficiently rapidly advanced in the absence of a catalyst, a catalyst for promoting the reaction can also be used. As the catalyst, catalysts which are generally used for the hydrolysis regulator (component DD) can be applied. These can be used alone or in combination of two or more kinds thereof. Although an addition amount of the catalyst is not particularly limited, it is preferably 0.001 to 1 part by weight, more preferably 0.01 to 0.1 parts by weight, and most preferably 0.02 to 0.1 parts by weight based on 100 parts by weight of the resin composition.

In the present invention, the hydrolysis regulator (component DD) may be used in a combination of two or more kinds thereof. For example, with respect to the hydrolysis regulator (component DD) for performing the sealing reaction of the acidic group at the early stage of the resin containing, as a main component, a water-soluble monomer and having autocatalysis (component CC) and the hydrolysis regulator (component DD) for performing the sealing reaction of the acidic group generated in hot water at a higher temperature than 135° C., separate materials may be used.

Furthermore, it is preferred to jointly use an auxiliary agent of the hydrolysis regulator (component DD), namely an agent for assisting the effect of the component B for the purpose of delaying the hydrolysis. Although any known material can be used as such an agent, for example, at least one compound selected from hydrotalcite, an alkaline earth metal oxide, an alkaline earth metal hydroxide, and an alkaline earth metal carbonate is exemplified. A content of the auxiliary agent is preferably 0.1 to 30 parts by weight, more preferably 0.5 to 20 parts by weight, and still more preferably 0.7 to 10 parts by weight based on 100 parts by weight of the hydrolysis regulator (component DD).

In the resin composition of the present invention, all of known additives and fillers can be added and used within the range where the effects of the invention are not lost. Examples thereof include a stabilizer, a crystallization promoter, a filler, a release agent, an antistatic agent, a plasticizer, an impact resistance-improving agent, a terminal-sealing agent, and the like.

Incidentally, from the viewpoint that the effects of the invention are not lost, with respect to the additives, it is important to not use a component which promotes the decomposition of the resin containing, as a main component, a water-soluble monomer and having autocatalysis (component CC), for example, a phosphoric acid component, a phosphite-based additive which is decomposed in the resin composition to generate a phosphoric acid component, or the like, or decrease its amount as far as possible, or to reduce influences thereof by taking a method, such as deactivation, etc. For example, a method of using a component capable of achieving deactivation or retardation together with the hydrolysis regulator (component DD), or the like can be suitably adopted.

### <Stabilizer>

The resin composition of the present invention can contain a stabilizer. As the stabilizer, those which are used for a stabilizer of ordinary thermoplastic resins can be used. For example, an antioxidant, a light stabilizer, and the like can be exemplified. By compounding such an agent, a molded article having excellent mechanical properties, formability, heat resistance, and durability can be obtained.

As the antioxidant, a hindered phenol-based compound, a hindered amine-based compound, a phosphite-based compound, a thioether-based compound, and the like can be exemplified.

Examples of the hindered phenol-based compound include n-octadecyl-3-(3′,5′-di-tert-butyl-4′-hydroxyphenyl)-propionate, n-octadecyl-3-(3′-methyl-5′-tert-butyl-4′-hydroxyphenyl)-propionate, n-tetradecyl-3-(3′,5′-di-tert-butyl-4′-hydroxyphenyl)-propionate, 1,6-hexanediol-bis[3-(3,5-di-tert-butyl-4-hydroxyphenyl)-propionate], 1,4-butanediol-bis[3-(3,5-di-tert-butyl-4-hydroxyphenyl)-propionate], 2,2′-methylene-bis(4-methyl-tert-butylphenol), triethylene glycol-bis([3-(3-tert-butyl-5-methyl-4-hydroxyphenyl)-propionate], tetrakis[methylene-3-(3′,5′-di-tert-butyl-4-hydroxyphenyl) propionate]methane, 3,9-bis[2-{3-(3-tert-butyl-4-hydroxy-5-methylphenyl)propio nyloxy}-1,1-dimethylethyl]2,4,8,10-tetraoxaspiro(5,5)undecane, and the like.

Examples of the hindered amine-based compound include N,N′-bis-3-(3′,5′-di-tert-butyl-4′-hydroxyphenyl)propionyl hexamethylenediamine, N,N′-tetramethylene-bis[3-(3′-methyl-5′-tert-butyl-4′-hydr oxyphenyl)propionyl]diamine, N,N′-bis[3-(3,5-di-tert-butyl-4-hydroxyphenyl)-propionyl]hydrazine, N-salicyloyl-N′-salicylidenehydrazine, 3-(N-salicyloyl)amino-1,2,4-triazole, N,N′-bis[2-{3-(3,5-di-tert-butyl-4-hydroxyphenyl)propionyl oxy}ethyl]oxyamide, and the like. Triethylene glycol-bis[3-(3-tert-butyl-5-methyl-4-hydroxyphenyl)-propionate], tetrakis[methylene-3-(3′,5′-di-tert-butyl-4-hydroxyphenyl) propionate]methane, and the like are preferred.

The phosphite-based compound is preferably a compound having at least one P—O bond bonded to an aromatic group. Specifically, examples thereof include tris(2,6-di-tert-butylphenyl)phosphite, tetrakis(2,6-di-tert-butylphenyl)4,4′-biphenylene phosphite, bis(2,6-di-tert-butyl-4-methylphenyl)pentaerythritol-di-phosphite, 2,2-methylenebis(4,6-di-tert-butylphenyl)octylphosphite, 4,4′-butylidene-bis(3-methyl-6-tert-butylphenyl-di-tridecyl)phosphite, 1,1,3-tris(2-methyl-4-ditridecylphosphite-5-tert-butylphenyl)butane, tris(mixed mono- and di-nonylphenyl)phosphite, tris(nonylphenyl)phosphite, 4,4′-isopropylidenebis(phenyl-dialkylphosphite), 2,4,8,10-tetra-tert-butyl-6-[3-(3-methyl-4-hydroxy-5-t-butylphenyl)propoxy]dibenzo[d,f][1,3,2]dioxaphosphepin (SUMILIZER (registered trademark) GP), and the like.

Specific examples of the thioether-based compound include dilauryl thiodipropionate, ditridecyl thiodipropionate, dimyristyl thiodipropionate, distearyl thiodipropionate, pentaerythritol-tetrakis(3-laurylthiopropionate), pentaerythritol-tetrakis(3-dodecylthiopropionate), pentaerythritol-tetrakis(3-octadecylthiopropionate), pentaerythritol-tetrakis(3-myristylthiopropionate), pentaerythritol-tetrakis(3-stearylthiopropionate), and the like.

As the light stabilizer, specifically, for example, a benzophenone-based compound, a benzotriazole-based compound, an aromatic benzoate-based compound, an oxalic anilide-based compound, a cyanoacrylate-based compound, a hindered amine-based compound, and the like can be exemplified.

Examples of the benzophenone-based compound include benzophenone, 2,4-dihydroxybenzophenone, 2,2′-dihydroxybenzophenone, 2,2′,4,4′-tetrahydroxybenzophenone, 2-hydroxy-4-methoxybenzophenone, 2,2′-dihydroxy-4,4′-dimethoxybenzophenone, 2,2′-dihydroxy-4,4′-dimethoxy-5-sulfobenzophenone, 2-hydroxy-4-octoxybenzophenone, 2-hydroxy-4-dodecyloxybenzophenone, 2-hydroxy-4-octoxybenzophenone, 2-hydroxy-4-methoxy-5-sulfobenzophenone, 5-chloro-2-hydroxybenzophenone, 2-hydroxy-4-octoxybenzophenone, 2-hydroxy-4-methoxy-2′-carboxybenzophenone, 2-hydroxy-4-(2-hydroxy-3-methyl-acryloxyisopropoxy)benzophenone, and the like.

Examples of the benzotriazole-based compound include 2-(5-methyl-2-hydroxyphenyl)benzotriazole, 2-(3,5-di-tert-butyl-2-hydroxyphenyl)benzotriazole, 2-(3,5-di-tert-amyl-2-hydroxyphenyl)benzotriazole, 2-(3′,5′-di-tert-butyl-4′-methyl-2′-hydroxyphenyl)benzotriazole, 2-(3,5-di-tert-amyl-2-hydroxyphenyl)-5-chlorobenzotriazole, 2-(5-tert-butyl-2-hydroxyphenyl)benzotriazole, 2-[2′-hydroxy-3′,5′-bis(α,α-dimethylbenzyl)phenyl]benzotriazole, 2-[2′-hydroxy-3′,5′-bis(α,α-dimethylbenzyl)phenyl]-2H-benzotriazole, 2-(4′-octoxy-2′-hydroxyphenyl)benzotriazole, and the like.

Examples of the aromatic benzoate-based compound include alkylphenyl salicylates, such as p-tert-butylphenyl salicylate, p-octylphenyl salicylate, etc.

Examples of the oxalic anilide-based compound include 2-ethoxy-2′-ethyloxalic acid bisanilide, 2-ethoxy-5-tert-butyl-2′-ethyloxalic acid bisanilide, 2-ethoxy-3′-dodecyloxalic acid bisanilide, and the like.

Examples of the cyanoacrylate-based compound include ethyl-2-cyano-3,3′-diphenyl acrylate, 2-ethylhexyl-cyano-3,3′-diphenyl acrylate, and the like.

Examples of the hindered amine-based compound include 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-octadecyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl)carbonate, bis(2,2,6,6-tetramethyl-4-piperidyl)oxalate, bis(2,2,6,6-tetramethyl-4-piperidyl)malonate, bis(2,2,6,6-tetramethyl-4-piperidyl)sebacate, bis(2,2,6,6-tetramethyl-4-piperidyl)adipate, bis(2,2,6,6-tetramethyl-4-piperidyl)terephthalate, 1,2-bis(2,2,6,6-tetramethyl-4-piperidyloxy)-ethane, α,α′-bis(2,2,6,6-tetramethyl-4-piperidyloxy)-p-xylene, bis(2,2,6,6-tetramethyl-4-piperidyl)-tolylene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6-tetramethyl-4-piperidyl)-benzene-1,3,4-tricarboxylate, 1-[2-{3-(3,5-di-tert-butyl-4-hydroxyphenyl)propionyloxy}-2,2,6,6-tetramethylpiperidine, a condensate of 1,2,3,4-butane tetracarboxylic acid, 1,2,2,6,6-pentamethyl-4-piperidinol, and β,β,β′,β′-tetramethyl-3,9-[2,4,8,10-tetraoxaspiro(5,5)undecane]dimethanol, and the like.

In the present invention, the stabilizer component may be used alone, or may be used in combination of two or more kinds thereof. As the stabilizer component, a hindered phenol-based compound and/or a benzotriazole-based compound is preferred.

A content of the stabilizer is preferably 0.01 to 3 parts by weight, and more preferably 0.03 to 2 parts by weight based on 100 parts by weight of the resin containing, as a main component, a water-soluble monomer and having autocatalysis (component CC).

### <Crystallization Accelerator>

The resin composition of the present invention can contain an organic or inorganic crystallization accelerator. When the resin composition contains the crystallization accelerator, a molded article having excellent mechanical properties, heat resistance, and formability can be obtained.

That is, by applying the crystallization accelerator, a molded article which is enhanced in formability and crystallinity, is thoroughly crystallized even by ordinary injection molding, and is excellent in heat resistance and moist heat stability can be obtained. In addition thereto, the time required for the manufacture of a molded article can be drastically shortened, and its economic effect is large.

A crystal nucleating agent which is generally used for crystalline resins can be used as the crystallization accelerator which is used in the present invention. All of an inorganic crystal nucleating agent and an organic crystal nucleating agent can be used.

Examples of the inorganic crystal nucleating agent include talc, kaolin, silica, synthetic mica, clay, zeolite, graphite, carbon black, zinc oxide, magnesium oxide, titanium oxide, calcium carbonate, calcium sulfate, barium sulfate, calcium sulfide, boron nitride, montmorillonite, neodymium oxide, aluminum oxide, phenylphosphonate metal salts, and the like. Such an inorganic crystal nucleating agent is preferably treated with a dispersion aid of every sort in order to increase its dispersibility in the composition and its effects and highly dispersed to such an extent that its primary particle diameter is about 0.01 to 0.5 μm.

Examples of the organic crystal nucleating agent include organic carboxylic acid metal salts, such as calcium benzoate, sodium benzoate, lithium benzoate, potassium benzoate, magnesium benzoate, barium benzoate, calcium oxalate, disodium terephthalate, dilithium terephthalate, dipotassium terephthalate, sodium laurate, potassium laurate, sodium myristate, potassium myristate, calcium myristate, barium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, zinc salicylate, aluminum dibenzoate, sodium β-naphthoate, potassium β-naphthoate, sodium cyclohexanecarboxylate, etc.; and organic sulfonic acid metal salts, such as sodium p-toluenesulfonate, sodium sulfoisophthalate, etc.

Organic carboxylic acid amides, such as stearic acid amide, ethylenebis(lauric amide), palmitic acid amide, hydroxystearic acid amide, erucic acid amide, tris(t-butylamide)trimesate, etc., low-density polyethylene, high-density polyethylene, polyisopropylene, polybutene, poly-4-methylpentene, poly-3-methylbutene-1, polyvinyl cycloalkane, polyvinyl trialkylsilane, branched type polylactic acid, a sodium salt of an ethylene-acrylate copolymer, a sodium salt of a styrene-maleic anhydride copolymer (so-called “ionomer”), benzylidene sorbitol and a derivative thereof, for example, dibenzylidene sorbitol, etc., are exemplified.

Of these, talc and at least one member selected from organic carboxylic acid metal salts are preferably used. The crystallization accelerator which is used in the present invention may be used alone, or may be used in combination of two or more kinds thereof.

A content of the crystallization accelerator is preferably 0.01 to 30 parts by weight, and more preferably 0.05 to 20 parts by weight based on 100 parts by weight of the resin containing, as a main component, a water-soluble monomer and having autocatalysis (component CC).

### <Filler>

The resin composition of the present invention can contain an organic or inorganic filler. When the resin composition contains a filler component, a molded article having excellent mechanical properties, heat resistance, and die formability can be obtained.

Examples of the organic filler include chip fillers, such as rice husk chips, wooden chips, bean curd refuse, old paper crushed chips, apparel crushed chips, etc.; fibrous fillers, such as plant fibers including cotton fibers, hemp fibers, bamboo fibers, wooden fibers, kenaf fibers, jute fibers, banana fibers, coconut fibers, and the like, pulp or cellulose fibers processed from these plant fibers, animal fibers including silk, wool, Angora, cashmere, and camel fibers, and the like, and synthetic fibers including polyester fibers, nylon fibers, acrylic fibers, and the like; and powdery fillers, such as paper powders, wooden powders, cellulose powders, rice husk powders, fruit shell powders, chitin powders, chitosan powders, protein powders, starch powders, etc. From the viewpoint of formability, powdery fillers, such as paper powders, wooden powders, bamboo powders, cellulose powders, kenaf powders, rice husk powders, fruit shell powders, chitin powders, chitosan powders, protein powders, starch powders, etc., are preferred, and paper powders, wooden powders, bamboo powders, cellulose powders, and kenaf powders are more preferred. Paper powders and wooden powders are still more preferred. Paper powders are especially preferred.

Although organic fillers collected directly from natural products may be used, organic fillers recycled from waste materials, such as used paper, waste timber, used clothing, etc., may also be used.

Conifers, such as yellow pine, cedar, cypress, fir, etc., and broadleaf trees, such as beech, chinquapin, eucalyptus, etc., and the like are preferred as the timber.

From the viewpoint of formability, paper powders containing an adhesive, especially an emulsion-based adhesive, such as a vinyl acetate resin-based emulsion, an acrylic resin-based emulsion, etc., which is generally used on the occasion of processing paper, or a hot melt adhesive, such as a polyvinyl alcohol-based adhesive, a polyamide-based adhesive, etc., or the like are preferably exemplified.

In the present invention, though a compounding amount of the organic filler is not particularly limited, from the viewpoints of formability and heat resistance, it is preferably 1 to 300 parts by weight, more preferably 5 to 200 parts by weight, still more preferably 10 to 150 parts by weight, and especially preferably 15 to 100 parts by weight based on 100 parts by weight of the resin containing, as a main component, a water-soluble monomer and having autocatalysis (component CC).

When the compounding amount of the organic filler is less than 1 part by weight, the effect for enhancing the formability of the composition is small, whereas when it is more than 300 parts by weight, it is difficult to disperse the filler uniformly, or there may be a possibility that the strength and appearance as well as formability and heat resistance of the composition as a material are deteriorated, and hence, such is not preferred.

It is preferred that the composition of the present invention contains an inorganic filler. By containing an inorganic filler, a composition having excellent mechanical properties, heat resistance, and formability can be obtained. As the inorganic filler which is used in the present invention, a fibrous, platy, or powdery filler which is used for reinforcing an ordinary thermoplastic resin can be used.

Specifically, examples thereof include fibrous inorganic fillers, such as carbon nanotubes, glass fibers, asbestos fibers, carbon fibers, graphite fibers, metal fibers, potassium titanate whiskers, aluminum borate whiskers, magnesium-based whiskers, silicon-based whiskers, wollastonite, imogolite, sepiolite, asbestos, slug fibers, zonolite, gypsum fibers, silica fibers, silica-alumina fibers, zirconia fibers, boron nitride fibers, silicon nitride fibers, boron fibers, etc.; and platy or particulate inorganic fillers, such as stratiform silicates, stratiform silicates exchanged with an organic onium ion, glass flakes, non-swelling mica, graphite, metal foils, ceramic beads, talc, clay, mica, sericite, zeolite, bentonite, dolomite, kaolin, powdery silicic acid, feldspar powder, potassium titanate, silas balloon, calcium carbonate, magnesium carbonate, barium sulfate, calcium oxide, aluminum oxide, titanium oxide, aluminum silicate, silicon oxide, gypsum, novaculite, dosonite, carbon nanoparticles including white clay fullerene or the like, etc.

Specific examples of the stratiform silicate include smectite-based clay minerals, such as montmorillonite, beidellite, nontronite, saponite, hectorite, sauconite, etc.; various clay minerals, such as vermiculite, halocite, kanemite, kenyaite, etc.; swelling micas, such as Li type fluorine taeniolite, Na type fluorine taeniolite, Li type tetrasilicon fluorine mica, Na type tetrasilicon fluorine mica, etc.; and the like. These may be natural or synthetic. Of these, smectite-based clay minerals, such as montmorillonite, hectorite, etc., and swelling synthetic micas, such as Li type fluorine taeniolite, Na type tetrasilicon fluorine mica, etc., are preferred.

Of these inorganic fillers, fibrous or platy inorganic fillers are preferred, and glass fibers, wollastonite, aluminum borate whiskers, potassium titanate whiskers, mica, kaolin, and cation-exchanged stratiform silicates are especially preferred. An aspect ratio of the fibrous filler is preferably 5 or more, more preferably 10 or more, and still more preferably 20 or more.

Such a filler may be covered or bundled with a thermoplastic resin, such as an ethylene/vinyl acetate copolymer, etc., or a thermosetting resin, such as an epoxy resin, etc., or treated with a coupling agent, such as aminosilane, epoxysilane, etc.

A compounding amount of the inorganic filler is preferably 0.1 to 200 parts by weight, more preferably 0.5 to 100 parts by weight, still more preferably 1 to 50 parts by weight, especially preferably 1 to 30 parts by weight, and most preferably 1 to 20 parts by weight based on 100 parts by weight of the resin containing, as a main component, a water-soluble monomer and having autocatalysis (component CC).

### <Release Agent>

The resin composition of the present invention can contain a release agent. As the release agent which is used in the present invention, those which are used for ordinary thermoplastic resins can be used.

Specifically, examples of the release agent may include fatty acids, fatty acid metal salts, hydroxy fatty acids, paraffins, low-molecular weight polyolefins, fatty acid amides, alkylene bis-fatty acid amides, aliphatic ketones, fatty acid partially saponified esters, fatty acid lower alcohol esters, fatty acid polyhydric alcohol esters, fatty acid polyglycol esters, modified silicones, and the like. By compounding such a release agent, a polylactic acid molded article having excellent mechanical properties, formability, and heat resistance can be obtained.

As the fatty acid, those having 6 to 40 carbon atoms are preferred, and specifically, examples thereof include oleic acid, stearic acid, lauric acid, hydroxystearic acid, behenic acid, arachidonic acid, linoleic acid, linolenic acid, ricinoleic acid, palmitic acid, montanic acid, and a mixture thereof, and the like. As the fatty acid metal salt, alkali metal salts or alkaline earth metal salts of a fatty acid having 6 to 40 carbon atoms are preferred, and specifically, examples thereof include calcium stearate, sodium montanate, calcium montanate, and the like.

Examples of the hydroxy fatty acid include 1,2-hydroxystearic acid and the like. As the paraffin, those having 18 carbon atoms or more are preferred, and examples thereof include liquid paraffin, natural paraffin, a microcrystalline wax, petrolactam, and the like.

As the low-molecular weight polyolefin, for example, those having a molecular weight of 5,000 or less are preferred, and specifically, examples thereof include a polyethylene wax, a maleic acid modified polyethylene wax, an oxide type polyethylene wax, a chlorinated polyethylene wax, a polypropylene wax, and the like. As the fatty acid amide, those having 6 or more carbon atoms are preferred, and specifically, examples thereof include oleic acid amide, erucic acid amide, behenic acid amide, and the like.

As the alkylene bis-fatty acid amide, those having 6 or more carbon atoms are preferred, and specifically, examples thereof include methylene bis-stearic acid amide, ethylene bis-stearic acid amide, N,N-bis(2-hydroxyethyl)stearic acid amide, and the like. As the aliphatic ketone, those having 6 or more carbon atoms are preferred, and examples thereof include higher aliphatic ketones and the like.

Examples of the fatty acid partially saponified ester include montanic acid partially saponified esters and the like. Examples of the fatty acid lower alcohol ester include stearic acid esters, oleic acid esters, linoleic acid esters, linolenic acid esters, adipic acid esters, behenic acid esters, arachidonic acid esters, montanic acid esters, isostearic acid esters, and the like.

Examples of the fatty acid polyhydric alcohol ester include glycerol tristearate, glycerol distearate, glycerol monostearate, pentaerythritol tetrastearate, pentaerythritol tristearate, pentaerythritol distearate, pentaerythritol monostearate, pentaerythritol adipate stearate, sorbitan monobehenate, and the like. Examples of the fatty acid polyglycol ester include polyethylene glycol fatty acid esters, polypropylene glycol fatty acid esters, and the like.

Examples of the modified silicone include polyether modified silicones, higher fatty acid alkoxy modified silicones, higher fatty acid-containing silicones, higher fatty acid ester modified silicones, methacrylic modified silicones, fluorine modified silicone, and the like.

Of these, fatty acids, fatty acid metal salts, hydroxy fatty acids, fatty acid esters, fatty acid partially saponified esters, paraffins, low-molecular weight polyolefins, fatty acid amides, and alkylene-bis fatty acid amides are preferred, and fatty acid partially saponified esters and alkylene-bis fatty acid amides are more preferred. Above all, montanic acid esters, montanic acid partially saponified esters, polyethylene waxes, oxidized polyethylene waxes, sorbitan fatty acid esters, erucic acid amide, and ethylene bis-stearic acid amide are still more preferred, and montanic acid partially saponified esters and ethylene bis-stearic acid amide are especially preferred.

The release agent may be used alone, or may be used in combination of two or more kinds thereof. A content of the release agent is preferably 0.01 to 3 parts by weight, and more preferably 0.03 to 2 parts by weight based on 100 parts by weight of the resin containing, as a main component, a water-soluble monomer and having autocatalysis (component CC).

### <Antistatic Agent>

The resin composition of the present invention can contain an antistatic agent. Examples of the antistatic agent include quaternary ammonium salt-based compounds, sulfonate-based compounds, and alkyl phosphate-based compounds, such as (β-lauramidepropionyl)trimethylammonium sulfate, sodium dodecylbenzenesulfonate, etc., and the like.

In the present invention, the antistatic agent may be used alone, or may be used in combination of two or more kinds thereof. A content of the antistatic agent is preferably 0.05 to 5 parts by weight, and more preferably 0.1 to 5 parts by weight based on 100 parts by weight of the resin containing, as a main component, a water-soluble monomer and having autocatalysis (component CC).

### <Plasticizer>

The resin composition of the present invention can contain a plasticizer. As the plasticizer, those which are generally known can be used. Examples thereof include polyester-based plasticizers, glycerin-based plasticizers, multivalent carboxylic acid ester-based plasticizers, phosphoric acid ester-based plasticizers, polyalkylene glycol-based plasticizers, epoxy-based plasticizers, and the like.

Examples of the polyester-based plasticizer include polyesters composed of an acid component, such as adipic acid, sebacic acid, terephthalic acid, isophthalic acid, naphthalenedicarboxylic acid, diphenyldicarboxylic acid, etc., and a diol component, such as ethylene glycol, propylene glycol, 1,3-propanediol, 1,3-butanediol, 1,4-butanediol, 1,6-hexanediol, diethylene glycol, etc.; polyesters composed of a hydroxycarboxylic acid, such as polycaprolactone, etc.; and the like. The ends of such a polyester may be sealed with a monofunctional carboxylic acid or a monofunctional alcohol.

Examples of the glycerin-based plasticizer include glycerin monostearate, glycerin distearate, glycerin monoacetomonolaurate, glycerin monoacetomonostearate, glycerin diacetomonooleate, glycerin monoacetomonomontanate, and the like.

Examples of the multivalent carboxylic acid-based plasticizer include phthalic acid esters, such as dimethyl phthalate, diethyl phthalate, dibutyl phthalate, diheptyl phthalate, dibenzyl phthalate, butylbenzyl phthalate, etc.; trimellitic acid esters, such as tributyl trimellitate, trioctyl trimellitate, trihexyl trimellitate, etc.; adipic acid esters, such as isodecyl adipate, n-decyl-n-octyl adipate, etc.; citric acid esters, such as tributyl acetylcitrate, etc.; azelaic acid esters, such as bis(2-ethylhexyl) azelate, etc.; and sebacic acid esters, such as dibutyl sebacate, bis(2-ethylhexyl) sebacate, etc.

Examples of the phosphoric acid ester-based plasticizer include tributyl phosphate, tris(2-ethylhexyl)phosphate, trioctyl phosphate, triphenyl phosphate, tricresyl phosphate, diphenyl-2-ethylhexyl phosphate, and the like.

Examples of the polyalkylene glycol-based plasticizer include polyalkylene glycols, such as polyethylene glycol, polypropylene glycol, polytetramethylene glycol, poly(ethylene oxide-propylene oxide) block and/or random copolymers, ethylene oxide addition polymers of a bisphenol, tetrahydrofuran addition polymers of a bisphenol, etc.; terminal-sealing compounds, such as terminal epoxy modified compounds, terminal ester modified compounds, and terminal ether modified compounds of these polyalkylene glycols, etc.; and the like.

Examples of the epoxy-based plasticizer include epoxy triglyceride composed of an alkyl epoxystearate and soybean oil, and an epoxy resin obtained from bisphenol A and epichlorohydrin as raw materials.

Specific examples of other plasticizer include benzoic acid esters of an aliphatic polyol, such as neopentyl glycol dibenzoate, diethylene glycol dibenzoate, triethylene glycol-bis(2-ethylbutyrate), etc.; fatty acid amides, such as stearic acid amide, etc.; fatty acid esters, such as butyl oleate, etc.; oxyacid esters, such as methyl acetyl ricinoleate, butyl acetyl ricinoleate, etc.; pentaerythritols; fatty acid esters of a pentaerythritol; various sorbitols; polyacrylic acid esters; silicone oil; paraffins; and the like.

As the plasticizer, at least one member selected from polyester-based plasticizers, polyalkylene-based plasticizers, glycerin-based plasticizers, pentaerythritols, and fatty acid esters of a pentaerythritol can be especially preferably used, and the plasticizer may be used alone or can also be used in combination of two or more kinds thereof.

A content of the plasticizer is preferably 0.01 to 30 parts by weight, more preferably 0.05 to 20 parts by weight, and still more preferably 0.1 to 10 parts by weight based on 100 parts by weight of the resin containing, as a main component, a water-soluble monomer and having autocatalysis (component CC). In the present invention, the crystallization nucleating agent and the plasticizer may be used independently, and it is more preferred to use a combination of the both.

### <Impact Resistance-Improving Agent>

The resin composition of the present invention can contain an impact resistance-improving agent. The impact resistance-improving agent is a material which can be used for improving the impact resistance of a thermoplastic resin and is not particularly limited. For example, at least one member selected among the following impact resistance-improving agents.

Specific examples of the impact resistance-improving agent include an ethylene-propylene copolymer, an ethylene-propylene-non-conjugated diene copolymer, an ethylene-butene-1 copolymer, various acrylic rubber, an ethylene-acrylic acid copolymer and an alkali metal salt thereof (so-called “ionomer”), an ethylene-glycidyl(meth)acrylate copolymer, an ethylene-acrylic acid ester copolymer (for example, an ethylene-ethyl acrylate copolymer and an ethylene-butyl acrylate copolymer), a modified ethylene-propylene copolymer, a diene rubber (for example, polybutadiene, polyisoprene, and polychloroprene), a diene-vinyl copolymer (for example, a styrene-butadiene random copolymer, a styrene-butadiene block copolymer, a styrene-butadiene-styrene block copolymer, a styrene-isoprene random copolymer, a styrene-isoprene block copolymer, a styrene-isoprene-styrene block copolymer, a polybutadiene-styrene graft copolymer, and a butadiene-acrylonitrile copolymer), polyisobutylene, a copolymer of isobutylene and butadiene or isoprene, a natural rubber, a Thiokol rubber, a polysulfide rubber, a polyurethane rubber, a polyether rubber, an epichlorohydrin rubber, and the like.

Furthermore, impact resistance-improving agents having a degree of crosslinking of every sort, those having various micro-structures, for example, a cis-structure or a trans-structure, and those having core-shell type multilayer polymers composed of a core layer and at least one shell layer covering the core layer adjacent layers made of different polymers, can also be used.

Furthermore, the various (co)polymers specifically exemplified above may be either a random copolymer or a block copolymer, and these can be used as the impact resistance-improving agent of the present invention.

A content of the impact resistance-improving agent is preferably 1 to 30 parts by weight, more preferably 5 to 20 parts by weight, and still more preferably 10 to 20 parts by weight based on 100 parts by weight of the resin containing, as a main component, a water-soluble monomer and having autocatalysis (component CC).

### <Others>

The resin composition of the present invention may contain a thermosetting resin, such as a phenol resin, a melamine resin, a thermosetting polyester resin, a silicone resin, an epoxy resin, etc., within the range where the gist of the present invention is not deviated.

The resin composition of the present invention may also contain a flame retardant, such as a bromine-based material, a phosphorus-based material, a silicone-based material, an antimony compound, etc., within the range where the gist of the present invention is not deviated.

The resin composition may also contain a colorant including an organic or inorganic dye or pigment, for example, an oxide, such as titanium dioxide, etc., a hydroxide, such as alumina white, etc., a sulfide, such as zinc sulfide, etc., a ferrocyanide compound, such as iron blue, etc., a chromate, such as zinc chromate, etc., a sulfate, such as barium sulfate, etc., a carbonate, such as calcium carbonate, etc., a silicate, such as ultramarine blue, etc., a phosphate, such as manganese violet, etc., carbon, such as carbon black, etc., a metal colorant, such as a bronze powder, an aluminum powder, etc., and the like.

The resin composition may also contain an additive including a nitroso-based colorant, such as Naphthol Green B, etc., a nitro-based colorant, such as Naphthol Yellow S, etc., an azo-based colorant, such as Naphthol Red, Chromophthal Yellow, etc., a phthalocyanine-based colorant, such as Phthalocyanine Blue, Fast Sky Blue, etc., a condensation polycyclic coolant, such as Indanthrene Blue, and the like, and a slidability-improving agent, such as graphite, a fluorine resin, etc. These additives may be used alone or can also be used in combination of two or more kinds thereof.

### <Molded Article>

A molded article made of the resin composition of the present invention can be formed by means of injection molding, extrusion molding, vacuum or pressure molding, blow molding, or the like. Examples of the molded article include a pellet, a fiber, a cloth, a fiber structure, a film, a sheet, a sheet nonwoven fabric, and the like.

The melt forming method of the pellet made of the resin composition of the present invention is not limited at all, and pellets produced by a known pellet production method can be suitably used.

That is, though methods, such as a method in which the resin composition extruded into a strand or plate is cut in air or water after the resin is completely solidified, or while it is still molten and not completely solidified, etc., are conventionally known, all of those methods can be suitably applied in the present invention.

For the injection molding, molding conditions may be properly set according to the type of the resin containing, as a main component, a water-soluble monomer and having autocatalysis (component CC). However, from the viewpoints of promoting the crystallization and the molding cycle of a molded article at the time of injection molding, for example, when the resin containing, as a main component, a water-soluble monomer and having autocatalysis (component CC) is polylactic acid, a die temperature is preferably 30° C. or higher, more preferably 60° C. or higher, and still more preferably 70° C. or higher. However, in order to prevent the deformation of a molded article, the die temperature is preferably 140° C. or lower, more preferably 120° C. or lower, and still more preferably 110° C. or lower.

Examples of such a molded article include various housings, electric and electronic parts, such as toothed wheels, gears, etc., construction members, civil engineering members, agricultural materials, automobile parts (interior and exterior parts, etc.), parts for daily use, and the like.

As for the fiber and the fiber structure made of the resin composition of the present invention, materials obtained by ordinary melt spinning and post-processing after that can be suitably used.

That is, the resin containing, as a main component, a water-soluble monomer and having autocatalysis (component CC) is melted by an extruder type or pressure melter type melt extruder, weighed by a gear pump, filtered within a pack, and then discharged as a monofilament or a multifilament, or the like from nozzles provided in a spinneret.

The shape and number of spinnerets are not particularly limited, and all of a circular type, an atypical type, a solid type, a hollow type, and the like can be adopted. The discharged yarn is immediately cooled and solidified, and thereafter, the resultant is bundled, applied with a lubricant, and wound up. Although a winding rate is not particularly limited, it is preferably in the range of 100 m/min to 5,000 m/min because a stereocomplex crystal is easily formed when the resin containing, as a main component, a water-soluble monomer and having autocatalysis (component CC) is stereocomplex polylactic acid.

Although the wound unstretched yarn can be used as it is, it can also be stretched and used.

In the case of using the yarn in an unstretched state, it is preferred to perform a heat treatment at a temperature equal to or higher than the glass transition temperature (Tg) and lower than the melting point of the resin containing, as a main component, a water-soluble monomer and having autocatalysis (component CC) after spinning and before winding up. Arbitrary means, such as a contact type heater, a non-contact hot plate, etc., can be adopted for the heat treatment besides a hot roller.

In the case of performing stretching, a spinning step and a stretching step are not always needed to be separated from each other, and a direct spinning/stretching method in which after spinning, stretching is subsequently performed without once winding up the spun yarn may be adopted.

Stretching may be performed in one stage or two or more multiple stages, and from the viewpoint of fabricating a high-strength fiber, a draw ratio is preferably 3 times or more, and more preferably 4 times or more. The draw ratio is preferably selected from 3 to 10 times. However, when the draw ratio is too high, the fiber is devitrified and whitened, whereby the strength of the fiber is lowered, and rupture elongation becomes too small for a fiber application, and hence, such is not preferred.

As for a preheating method for stretching, besides temperature elevation of a roll, a plate-like or pin-like contact heater, a non-contact hot plate, a heat medium bath, and the like may be adopted. However, commonly used means may be adopted.

It is preferred that after spinning, the heat treatment is subsequently performed at a temperature equal to or higher than the glass transition temperature (Tg) and lower than the melting point of the resin containing, as a main component, a water-soluble monomer and having autocatalysis (component CC) before winding up.

Besides a hot roller, arbitrary means, such as a contact heater, a non-contact hot plate, etc., can be adopted for the heat treatment.

For example, when the resin containing, as a main component, a water-soluble monomer and having autocatalysis (component CC) is polylactic acid, a stretching temperature is selected within the range of the glass transition temperature (Tg) to 170° C., preferably 60° C. to 140° C., and especially preferably 70° C. to 130° C.

The fiber obtained from the resin composition of the present invention may be a short fiber. In the case of producing a short fiber, in addition to a stretching method of along fiber, a step of cutting in a prescribed fiber length according to an application by using a rotary cutter or the like is added, and in the case where crimping is further needed, a step of imparting crimps by using a forced crimper or the like is added between a fixed-length heat treatment and a relaxation treatment. On that occasion, in order to increase crimp-imparting properties, preheating can be performed by using steam, an electric heater, or the like before the crimper.

When the resin containing, as a main component, a water-soluble monomer and having autocatalysis (component CC) is stereocomplex polylactic acid, a polylactic acid fiber having a high stereocomplex crystallization degree (S), low heat shrinkage, and a strength of 3.5 cN/dTex or more can also be obtained by heat setting at 170 to 220° C. under a tension after stretching.

Fibers and fiber structures obtained from the resin composition of the present invention may be used as fibers made of the resin composition alone or can be mixed with another type of fibers. Examples of the mixture include not only various combinations with fiber structures made of another type of fibers but also a combined filament yarn with another type of fibers, a composite false twisted yarn, a blended yarn, a long/short composite yarn, a fluid processed yarn, a covering yarn, a twisted yarn, a combined weave, a combined knitting, a pile fabric, a cotton mixing/wadding, a long fiber or short fiber mixed nonwoven fabric, a felt, and the like. When another type of fibers are used together, a mixing ratio of the fibers is selected within the range of preferably 1% by weight or more, more preferably 10% by weight or more, and still more preferably 30% by weight in order to exhibit the characteristic features of the resin composition.

Examples of the another type of fibers to be mixed include cellulose fibers, such as cotton, hemp, rayon, and tencel fibers, etc.; wool, silk, acetate, polyester, nylon, acrylic, vinylon, polyolefin, and polyurethane fibers; and the like.

The film or sheet obtained from the resin composition of the present invention can be formed by a conventionally known method. For example, in the film or sheet, molding techniques, such as extrusion molding, cast molding, etc., can be adopted. That is, molding can be performed by extruding an unstretched film by using an extruder having a T die or circular die or the like installed therein, or the like and further stretching and heating. At this time, the unstretched film can be directly put into practical use as a sheet. In forming a film, not only a material obtained by melt kneading the resin composition and the above-described various components in advance can be used, but also these components can be formed through melt kneading at the time of extrusion molding. An unstretched film having few surface defects can be obtained by compounding an electrostatic adhesive, such as a quaternary phosphonium sulfonate, etc. with the molten resin at the time of extruding an unstretched film.

An unstretched film can also be cast formed by dissolving the resin composition and the additive components in a common solvent, for example, chloroform, methylene dichloride, or the like, and casting the resulting solution, followed by drying for solidification.

The unstretched film can be subjected to vertical uniaxial stretching in a mechanical flow direction or horizontal uniaxial stretching in a direction orthogonal to the mechanical flow direction. A biaxially stretched film can be produced by performing a sequential biaxial stretching method of roller stretching and tenter stretching, a simultaneous biaxial stretching method by tenter stretching, a biaxial stretching method by tubular stretching, or other means. Furthermore, the film is generally heat set after stretching for the purpose of suppressing its heat shrinkage or the like. If desired, the thus-obtained stretched film may also be subjected to a surface activation treatment, such as a plasma treatment, an amine treatment, or a corona treatment, in accordance with a conventionally known method.

The film or sheet of the present invention may be used alone or in combination with another type of a film or sheet. As aspects of the combination, there may be mentioned, not only combinations with a film or sheet made of another material to obtain, for example, a stack, a laminate, and the like, but also combinations with another form, such as an injection molded article, a fiber structure, etc. The film or molded body can also be used as a fibrous material by slitting or as flakes by using a pulverizer or the like.

### EXAMPLES

The first invention of the present application is hereunder more specifically explained by reference to Examples, but it should be construed that the present invention is not limited thereto at all. The respective physical properties were measured by the following methods.

(1) Weight average molecular weight (Mw) and number average molecular weight (Mn):

A weight average molecular weight and a number average molecular weight of a polymer were measured by means of gel permeation chromatography (GPC) and converted into standard polystyrene.

As for the GPC measurement, the following detector and column were used, chloroform was used as an eluant, and 10 μL of a sample in a concentration of 1 mg/mL (chloroform containing 1% hexafluoroisopropanol) was injected at a temperature of 40° C. and at a flow rate of 1.0 mL/min and measured.

Detector: Differential refractometer (manufactured by Shimadzu Corporation), RID-6A

Column: Column in which TSKgel G3000HXL, TSKgel G4000HXL, TSKgel G5000HXL, and TSKguardcolumn HXL-L (all of which are manufactured by Tosoh Corporation) are connected in series, or column in which TSKgel G2000HXL, TSKgel G3000HXL, and TSKguardcolumn HXL-L (all of which are manufactured by Tosoh Corporation) are connected in series.

(2) Measurement of melting point (Tmhw) in water:

1.5 mg of a sample and 25 μL of pure water were sealed in a cell using a high-pressure capsule (manufactured by TA Instruments, 900815.901,) and a high-pressure capsule seal (manufactured by TA Instruments, 900814.901).

The sample was subjected to temperature rise to 230° C. in a temperature rise rate of 5° C./min by using DSC (manufactured by TA Instruments, DSC2920), and a peak temperature of a peak having largest melting enthalpy among peaks having a peak top in the range of 160 to 210° C. was defined as a melting point (Tmsw) of a stereocomplex crystal phase in water. In addition, a peak temperature of a peak having largest melting enthalpy among peaks having a peak top in the range of 120 to 159° C. was defined as a melting point (Tmhw) of a homogeneous crystal phase in water.

(3) Measurement of melting point (Tmhn) in nitrogen:

A sample was subjected to temperature rise to 260° C. under a nitrogen gas stream in a temperature rise rate of 20° C./min by using DSC (manufactured by TA Instruments, Q200), and a peak temperature of a peak having largest melting enthalpy among peaks having a peak top in the range of 190 to 240° C. was defined as a melting point (Tmsn) of a stereocomplex crystal phase in nitrogen. In addition, a peak temperature of a peak having largest melting enthalpy among peaks having a peak top in the range of 150 to 189° C. was defined as a melting point (Tmhn) of a homogeneous crystal phase in nitrogen.

(4) Isotactic number-average chain length:

A sample was dissolved in an HFIP/chloroform (1/1) mixed solvent and then reprecipitated from methanol. This reprecipitated polymer component was washed with methanol and centrifugation thereof is repeated five times, thereby removing impurities and the solvent component. Thereafter, the resultant was dried over night with a vacuum dryer, and a polylactic component capable of becoming a measurement sample was extracted.

Using the thus extracted sample, an isotactic number-average chain length was measured in the following manner.

¹³C-NMR apparatus: ECA600, manufactured by JEOL Ltd.

Sample: 50 mg/0.6 mL

Measurement solvent: Deuterochloroform

Internal standard: Tetramethylsilane (TMS) 1% (v/v)

Measurement temperature: Room temperature

Measurement frequency: 150 MHz

1) The whole was defined as a peak integrated area I_{ch} at 68.6 to 69.9 ppm. Then, an integral (hereinafter referred to as “area”) of iss (69.5 ppm) and sss (69.3 ppm) peaks free from an overlap of peaks was taken.

2) A peak area ratio between two sss and isi (69.2 ppm) peaks was calculated according to the cut-and-weight method, and a peak area of isi in the whole was calculated by using the peak area of sss in 1).

3) As for a sample, poly(L-lactic acid) and poly(D-lactic acid) were raw material polymers, and on the assumption that these undergo ester interchange at random according to the Bernoulli statistics, relations of (iss=ssi=sis) and (iis=sii=isi) are satisfied. Thus, peak areas of ssi, iis, sii, and sis in the whole, which cannot be quantitated directly, were calculated by utilizing these relations.

4) A residue obtained by subtracting the areas of the above-described seven sequences from the area of the whole was defined as a peak area of iii.

5) An isotactic average-number chain length Lᵢ was calculated according to the following equation. Incidentally, the isotactic chain length as referred to herein means the number of lactic acid units chained in the isotactic. Here, Pᵢ was defined as a molar fraction of i; Pₛ was defined as a molar fraction of s, and I was defined as a ratio of a peak area of each of the above-estimated sequences to the whole peak area I_{ch}. Incidentally, i represents an isotactic sequence (LL, DD), and s represents a syndiotactic sequence (LD, DL).

Lᵢ=1/Pₛ=(P₁+Pₛ)/Pₛ=(P₁/Pₛ)+1=(Iᵢ/Iₛ)+1=(3Iᵢᵢᵢ+2Iᵢₛᵢ+2Iₛᵢᵢ+2Iᵢᵢₛ+Iₛᵢₛ+Iₛₛᵢ+Iᵢₛₛ)/(Iᵢₛᵢ+Iᵢᵢₛ+Iₛᵢᵢ+2Iₛᵢₛ+2Iₛₛᵢ+2Iᵢₛₛ+3Iₛₛₛ)+1 (IV)

(5) Stereocomplex crystallization degree (S) and stereocomplex crystallization rate (Cs): As for a sample having been heat treated at 100° C. for 5 minutes, a two-dimensional data obtained with an image plate by using NANO-Viewer, manufactured by Rigaku Corporation was converted into a 2θ profile, and a range of 2θ=5 to 30° was subjected to peak fitting.

A stereocomplex crystallization degree (S) and a stereocomplex crystallization rate (Cs) were determined from a sum total ΣIₛ of integrated intensities of diffraction peaks derived from stereocomplex crystal phases appearing in the neighborhoods of 2θ=12.0°, 20.7°, and 24.0°, an integrated intensity Iₕ of a diffraction peak derived from a homogeneous crystal phase appearing in the neighborhood of 2θ=16.5°, and an integrated intensity Iₐ of an amorphous component according to the following equations.

### Measurement Conditions:

Generator: ultrax18

Tube voltage/tube current: 45 kV/60 mA

X-ray source: CuKα

Camera length: 120 mm

Measurement time: 10 minutes

Detector: Image plate

S=[ΣIₛ/(ΣIₛ+Iₕ+Iₐ)]×100

Cs=[ΣIₛ/(ΣIₛ+Iₕ)]×100

### (6) MFR:

MFR was measured at 230° C. with a load of 2.16 kg in conformity with ISO 1133-1 (2011).

(7) High-temperature hot water test:

An autoclave (manufactured by OM Lab-Tech Co., Ltd., MMJ-500-HC, internal volume: 500 mL) equipped with a stirring blade and a thermocouple protection tube capable of measuring an internal temperature was charged with 750 mg of a sample and 150 mL of distilled water, pressurized with a pure nitrogen gas to a gauge pressure of 0.9 MPa, and then hermetically sealed.

Heating by a coil heater from the outside of the vessel was started while stirring at 100 rpm, and the internal temperature was reached to 188±1° C. over 30 minutes. After keeping a prescribed time, the coil heater was removed, the internal temperature was reduced to 50° C. over 50 minutes by means of cooling from the outside, and the system was exposed to the atmosphere, thereby recovering the sample and water in the interior.

The sample and water in the interior were subjected to filtration using a filter paper (in conformity with JIS P3801:1995, class 5A); the filter cake remaining on the filter paper was dried at 25° C. under a vacuum of 133.3 Pa or less for 3 hours; and thereafter, the weight was measured. The weight was determined according to the following equation.

Weight (%)=[(Weight of filter cake after the test)/750 (Weight of sample)]×100

With respect to the shape retention properties, though the initial shape is not particularly important, when the hot water test was carried out by using plural (preferably 5 or more) test pieces, the case where after the test, the test pieces became in a single disk-like or spherical form on the bottom of a vessel was defined as “bad”, whereas the case where the respective test pieces came loose with ease was defined as “good”.

(8) Carboxyl group concentration:

A carboxyl group concentration of each resin was confirmed by means of ¹H-NMR. ECA600, manufactured by JEOL Ltd. was used for the NMR. The measurement was performed by using deuterochloroform and hexafluoroisopropanol as a solvent and adding hexylamine thereto.

With respect to other samples, each sample was dissolved in purified o-cresol under a nitrogen gas stream, and the solution was titrated with a 0.05N ethanol solution of potassium hydroxide while using Bromocresol Blue as an indicator.

Compounds used in the present Examples are hereunder explained.

### <Polylactic Acid (Component A)>

The following polylactic acids were produced and used as the polylactic acid (component A).

### Production Example 1

### Poly(L-Lactic Acid) Resin

To 100 parts by weight of L-lactide (manufactured by Musashino Chemical Laboratory, Ltd., optical purity: 100%), 0.005 parts by weight of tin octylate and 0.1 parts by weight of stearyl alcohol were added; the contents were allowed to react with each other under a nitrogen atmosphere at 180° C. for 2 hours by a reactor equipped with a stirring blade; phosphoric acid of 1.2 times by equivalent relative to the tin octylate was added; and thereafter, the remaining lactide was removed at 13.3 Pa, followed by chipping, thereby obtaining a poly(L-lactic acid) resin.

The obtained poly(L-lactic acid) resin had a weight average molecular weight of 180,000, a melting point(Tmhn) of 175° C., and a carboxyl group concentration of 13 equivalents/ton.

### Production Example 2

### Poly(D-Lactic Acid) Resin

The same operations as those in Production Example 1 were followed, except that in Production Example 1, D-lactide (manufactured by Musashino Chemical Laboratory, Ltd., optical purity: 100%) was used in place of the L-lactide, thereby obtaining a poly(D-lactic acid) resin.

The obtained poly(D-lactic acid) resin had a weight average molecular weight of 180,000, a melting point(Tmh) of 175° C., and a carboxyl group concentration of 14 equivalents/ton.

### Production Example 3

### Stereocomplex Polylactic Acid (A1)

50 parts by weight of the poly(L-lactic acid) resin and 50 parts by weight of the poly(D-lactic acid) resin obtained in Production Examples 1 and 2, respectively were dried at 110° C. for 5 hours and then supplied into a vent type double-screw extruder having a diameter of 30 mmφ (manufactured by The Japan Steel Works, LTD., TEX30XSST); and the resultant was melt extruded at a cylinder temperature of 280° C., a screw rotation rate of 300 rpm, a discharge amount of 7 kg/h, and a vent reduced pressure of 3 kPa to form pellets, thereby obtaining stereocomplex polylactic acid (A1).

The obtained stereocomplex polylactic acid resin (A1) had a weight average molecular weight of 135,000, a melting point(Tmh) of 221° C., a carboxyl group concentration of 16 equivalents/ton, and a stereocomplex crystallization degree (S) of 51%.

### Production Example 4

### Stereocomplex Polylactic Acid (A2)

100 parts by weight in total of a polylactic acid resin consisting of 50 parts by weight of the poly(L-lactic acid) resin and 50 parts by weight of the poly(D-lactic acid) resin obtained in Production Examples 1 and 2, respectively and 0.04 parts by weight of phosphoric acid-2,2′-methylenebis(4,6-di-tert-butylphenyl) sodium (“ADEKASTAB (registered trademark)” NA-11, manufactured by ADEKA Corporation) were mixed by a blender; thereafter, the mixture was dried at 110° C. for 5 hours and then supplied into a vent type double-screw extruder having a diameter of 30 mmφ (manufactured by The Japan Steel Works, LTD., TEX30XSST); and the resultant was melt extruded at a cylinder temperature of 280° C., a screw rotation rate of 300 rpm, a discharge amount of 7 kg/h, and a vent reduced pressure of 3 kPa to form pellets, thereby obtaining stereocomplex polylactic acid (A2).

The obtained stereocomplex polylactic acid resin (A2) had a weight average molecular weight of 130,000, a melting point (Tms) of 216° C., a carboxyl group concentration of 16 equivalents/ton, and a stereocomplex crystallization degree (S) of 100%.

### <Hydrolysis Regulator (Component B)>

The following additives were used as the hydrolysis regulator (component B).

B1: DIPC (carbodiimide compound, manufactured by Kawaguchi Chemical Industry Co., Ltd.)
B2: “CARBODILITE (registered trademark)” LA-1 (carbodiimide compound, manufactured by Nisshinbo Chemical Inc.)
B1 had a water resistance of 100% and a reactivity with an acidic group of 85.7%, and B2 had a water resistance of 82.6% and a reactivity with an acidic group of 87.3%.

### Example 1

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.) and then heat treated at 100° C. for 1 minute, thereby obtaining a resin composition. The evaluation results of the obtained resin composition are shown in Table 1.

Incidentally, the obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec. As a result, the fiber could be wound up for 10 minutes or more without causing thread breakage, so that the spinnability was good.

### Example 2

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.), thereby obtaining a resin composition. The obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec, thereby obtaining an unstretched yarn.

On this occasion, the yarn could be wound up for 10 minutes or more without causing thread breakage, so that the spinnability was good. Furthermore, this unstretched yarn was stretched 3.5 times at 85° C. and then brought into contact with a heat roll at 190° C. for 0.3 seconds, thereby obtaining a fiber having a diameter of 15 μm. The evaluation results of the obtained fiber are shown in Table 1.

### Example 3

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.), thereby obtaining a resin composition. The obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports were drawn up at a rate of 400 m/min while quenching by blowing air at 25° C. and at a rate of 5 m/sec, thereby obtaining an unstretched yarn.

On this occasion, the yarn could be wound up for 10 minutes or more without causing thread breakage, so that the spinnability was good. Furthermore, this unstretched yarn was stretched 4 times at 80° C. and then brought into contact with a heat roll at 190° C. for 0.3 seconds, thereby obtaining a fiber having a diameter of 15 μm. Furthermore, this fiber was heat treated at 150° C. for 3 minutes in a state where both ends thereof were fixed so as not to cause contraction. The evaluation results of the obtained fiber are shown in Table 1.

### Example 4

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.) and then heat treated at 100° C. for 2 minutes, thereby obtaining a resin composition. The evaluation results of the obtained resin composition are shown in Table 1.

Incidentally, the obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec. As a result, the fiber could be wound up for 10 minutes or more without causing thread breakage, so that the spinnability was good.

### Example 5

The unstretched yarn obtained in Example 2 was stretched 4 times at 75° C. and then brought into contact with a heat roll at 160° C. for 3 seconds, thereby obtaining a fiber having a diameter of 12 μm. A closed melting crucible (manufactured by OM Lab-Tech Co., Ltd., MR-28, capacity: 28 mL) was charged with 100 mg of the obtained stretched yarn and hermetically sealed. In a state where the crucible was allowed to stand within a hot air dryer (manufactured by Koyo Thermo Systems Co., Ltd., KLO-45M), the temperature was raised from room temperature to 215° C. over 30 minutes, and after keeping that temperature for 10 minutes, the resultant was cooled within the oven to 50° C. over 30 minutes.

The evaluation results of the obtained yarn are shown in Table 1. Furthermore, this sample was subjected to a high-temperature hot water test under conditions at 191° C. for 2 hours. As a result, the weight retention rate was 87%, and the shape retention properties were good.

### Comparative Example 1

The stereocomplex polylactic acid (A2) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.), thereby obtaining a resin composition. The obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec, thereby obtaining an unstretched yarn.

On this occasion, the yarn could be wound up for 10 minutes or more without causing thread breakage, so that the spinnability was good. Furthermore, this unstretched yarn was stretched 3.5 times at 85° C. and then brought into contact with a heat roll at 190° C. for 0.3 seconds, thereby obtaining a fiber having a diameter of 15 μm. The evaluation results of the obtained fiber are shown in Table 1.

### Comparative Example 2

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.) and then heat treated at 100° C. for 1 minute, thereby obtaining a resin composition. The evaluation results of the obtained resin composition are shown in Table 1.

Incidentally, the obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec. As a result, the stringiness was poor, and the thread breakage was frequently generated, so that a yarn sample could not be obtained.

### Comparative Example 3

The stereocomplex polylactic acid (A1) was heat treated at 100° C. for 2 minutes, thereby obtaining a resin composition. The evaluation results of the obtained resin composition are shown in Table 1.

Incidentally, the obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec. As a result, the stringiness was poor, and the thread breakage was frequently generated, so that a yarn sample could not be obtained.

### Comparative Example 4

The stereocomplex polylactic acid (A1) and the hydrolysis regulator (B2) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.) and then heat treated at 100° C. for 1 minute, thereby obtaining a resin composition. The evaluation results of the obtained resin composition are shown in Table 1. Incidentally, the obtained resin composition was dehumidified and dried at 40° C. for 8 hours and then melted at 230° C. The resultant was discharged in an amount of 5 g/min from a nozzle having 24 pores having a pore diameter of 0.2 mm, and a fiber having come out from the discharge ports was drawn up at a rate of 400 m/min while quenching by blowing air at 25° C. and at a rate of 5 m/sec. As a result, the stringiness was poor, and the thread breakage was frequently generated, so that a yarn sample could not be obtained.

### Comparative Example 5

The stereocomplex polylactic acid (A1) and the hydrolysis regulator (B1) were mixed in weight parts shown in Table 1 and melt kneaded under a nitrogen atmosphere at a resin temperature of 230° C. and at a rotation rate of 30 rpm for 2 minutes by using a Labo Plasto mill (manufactured by Toyo Seiki Seisaku-Sho, Ltd.). The resin composition was very low in viscosity, so that it was difficult to collect a sample in a molten state.

TABLE 1

| | Composition | | | | | | | | |
|---|---|---|---|---|---|---|---|---|---|
| | Component A | | Component B | | | | | | |
| | A1 | A2 | B1 | B2 | | | | | |
| | Parts by | Parts by | Parts by | Parts by | | MFR | Tmsw | Tmsn | S |
| | weight | weight | weight | weight | Lᵢ | g/10 min | ° C. | ° C. | % |
| Example 1 | 93.0 | 0.0 | 7.0 | 0.0 | 77.0 | 126.8 | 191.0 | 218.5 | 11.6 |
| Example 2 | 91.0 | 0.0 | 9.0 | 0.0 | 66.4 | 160.0 | 189.1 | 216.8 | 25.7 |
| Example 3 | 82.0 | 0.0 | 18.0 | 0.0 | 69.2 | 190.4 | 188.5 | 215.9 | 33.2 |
| Example 4 | 96.0 | 0.0 | 4.0 | 0.0 | 75.9 | 74.8 | 191.8 | 219.9 | 19.1 |
| Example 5 | 94.0 | 0.0 | 6.0 | 0.0 | 66.4 | — | 194.5 | 224.7 | 59.1 |
| Comparative | 0.0 | 91.0 | 9.0 | 0.0 | 41.9 | 51.5 | 184.5 | 210.9 | 35.6 |
| Example 1 | | | | | | | | | |
| Comparative | 98.0 | 0.0 | 2.0 | 0.0 | 75.5 | 64.4 | 191.9 | 219.9 | 12.4 |
| Example 2 | | | | | | | | | |
| Comparative | 100.0 | 0.0 | 0.0 | 0.0 | 80.5 | 43.5 | 192.4 | 221.0 | 23.1 |
| Example 3 | | | | | | | | | |
| Comparative | 93.0 | 0.0 | 0.0 | 7.0 | 74.3 | 37.1 | 190.1 | 217.5 | 14.5 |
| Example 4 | | | | | | | | | |
| Comparative | 70.0 | 0.0 | 30.0 | 0.0 | — | — | — | — | — |
| Example 5 | | | | | | | | | |

| | | | | | Shape |
|---|---|---|---|---|---|
| | | | | | retention |
| | | | | | properties after |
| | | Weight retention rate after hot | | | hot water test |
| | | water test at 188° C. | | | at 188° C. |
| | Cs | After keeping | After keeping | | After keeping |
| | % | for 1 hour | for 6 hours | Spinnability | for 1 hour |
| Example 1 | 49.6 | 94% | Less than 1% | Good | Good |
| Example 2 | 76.0 | 91% | Less than 1% | Good | Good |
| Example 3 | 80.8 | 90% | Less than 1% | Good | Good |
| Example 4 | 48.5 | 88% | Less than 1% | Good | Good |
| Example 5 | 100 | 93% | Less than 1% | — | Good |
| Comparative | 100.0 | 92% | Less than 1% | Good | Bad |
| Example 1 | | | | | |
| Comparative | 52.3 | Less than 1% | Less than 1% | Bad | Bad |
| Example 2 | | | | | |
| Comparative | 52.3 | Less than 1% | Less than 1% | Bad | Bad |
| Example 3 | | | | | |
| Comparative | 53.1 | Less than 1% | Less than 1% | Bad | Bad |
| Example 4 | | | | | |
| Comparative | — | — | — | — | — |
| Example 5 | | | | | |

The second invention of the present application is hereunder more specifically explained by reference to Examples. The respective physical properties were measured by the following methods.

(9) Weight average molecular weight (Mw) and number average molecular weight (Mn):

A weight average molecular weight and a number average molecular weight of a polymer were measured by means of gel permeation chromatography (GPC) and converted into standard polystyrene.

As for the GPC measurement, the following detector and column were used, chloroform was used as an eluant, and 10 μL of a sample in a concentration of 1 mg/mL (chloroform containing 1% hexafluoroisopropanol) was injected at a temperature of 40° C. and at a flow rate of 1.0 mL/min and measured.

Detector: Differential refractometer (manufactured by Shimadzu Corporation), RID-6A

Column: Column in which TSKgel G3000HXL, TSKgel G4000HXL, TSKgel G5000HXL, and TSKguardcolumn HXL-L (all of which are manufactured by Tosoh Corporation) are connected in series, or column in which TSKgel G2000HXL, TSKgel G3000HXL, and TSKguardcolumn HXL-L (all of which are manufactured by Tosoh Corporation) are connected in series.

(10) Carboxyl group concentration:

A carboxyl group concentration of each of resin compositions of the Examples was confirmed by means of ¹H-NMR. ECA600, manufactured by JEOL Ltd. was used for the NMR. The measurement was performed by using deuterochloroform and hexafluoroisopropanol as a solvent and adding hexylamine thereto.

With respect to other samples, each sample was dissolved in purified o-cresol under a nitrogen gas stream, and the solution was titrated with a 0.05N ethanol solution of potassium hydroxide while using Bromocresol Blue as an indicator.

(11) DSC measurement of stereocomplex crystallization degree [S (%)], crystal melting temperature, and the like:

Using DSC (manufactured by TA Instruments, TA-2920), in a first cycle, a sample was subjected to temperature elevation to 250° C. at a rate of 10° C./min under a nitrogen gas stream and measured for a glass transition temperature (Tg), a stereocomplex phase polylactic acid crystal melting temperature (Tm*), a stereocomplex phase polylactic acid crystal melting enthalpy (ΔHms), and a homo-phase polylactic acid crystal melting enthalpy (ΔHmh).

The above-described measurement sample was quickly cooled and subsequently subjected to second cycle measurement under the same condition, thereby measuring a crystallization starting temperature (Tc*) and a crystallization temperature (Tc). A stereocomplex crystallization degree (S) is a value determined from the stereocomplex phase and homo-phase polylactic acid crystal melting enthalpies as obtained by the above-described measurement according to the following equation.

S (%)=[ΔHms/(ΔHmh+ΔHms)]×100

(Here, ΔHms is a melting enthalpy of the stereocomplex phase crystal, and ΔHmh is a melting enthalpy of the homo-phase polylactic acid crystal.)

(12) Water resistance evaluation of hydrolysis regulator:

Water resistance evaluation using dimethyl sulfoxide:

2 g of water was added to a system in which 1 g of a sample was dissolved or partially dissolved in 50 mL of dimethyl sulfoxide, the resultant was stirred while refluxing at 120° C. for 5 hours, and thereafter, the obtained sample portion was measured by means of HPLC or ¹H-NMR.

ECA600, manufactured by JEOL Ltd. was used for the NMR. Deuterodimethyl sulfoxide was used as a solvent, and an agent amount after 5 hours was determined from a change amount of the structure (integrated value).

The HPLC was carried out under the following condition, and the agent amount was determined from an area of the agent amount after 5 hours while defining an area of the agent amount at 0 hour as 100%.

Apparatus: Ultra high performance liquid chromatography, “Nexera (registered trademark)”, manufactured by Shimadzu Corporation

UV detector: Manufactured by Shimadzu Corporation, SPD-20A, 254 nm

Column: Manufactured by GL Sciences Inc., Inertsil Ph-33 μm, 4.6 mm×150 mm (or a column equivalent thereto is also usable)

Column temperature: 40° C.

Preparation of sample: A dimethyl sulfoxide solution was diluted 500 times with DMF and used.

Injection amount: 2 μL

Mobile phase: A: methanol, B: water

Flow rate: 1.0 mL/min (0 min: A/B=50/50→10 min: A/B=98/2→kept until 18 min→23 min: A/B=50/50→30 min)

Using the obtained agent amount after 5 hours, the water resistance was determined according to the following equation.

Water resistance (%)=[(Agent amount after treatment for 5 hours)/(Initial agent amount)]×100

Other water resistance evaluation (exemplifying the case where the component B is dissolved in tetrahydrofuran):

2 g of water was added to a system in which 1 g of a sample was dissolved in 25 mL of tetrahydrofuran and 25 mL of dimethyl sulfoxide, the resultant was stirred while refluxing at 120° C. for 5 hours, and thereafter, the obtained dissolved sample portion was measured by means of FT-IR.

The FT-IR was carried out under the following condition, and using areas of one group which does not change by the treatment of the agent (e.g., an alkyl chain portion, etc.) and a carbodiimide group, the agent amount was determined from a quotient of the area of the carbodiimide group and the area of the group which does not change after 5 hours while defining a quotient of the area of the carbodiimide group and the area of the group which does not change at 0 hour as 100.

Using the obtained agent amount after 5 hours, the water resistance was determined according to the foregoing equation.

Apparatus: Nicolet iN10

Measurement method: Microscopic transmission method

Measurement visual field: 50 μm×50 μm

Resolution: 4 cm⁻¹

Measurement wave number: 4,000 to 740 cm⁻¹

Cumulative number: 128 times

Preparation of sample: The dissolved sample was placed on a barium fluoride plate to volatize the solvent.

(13) Reactivity evaluation of hydrolysis regulator with acidic group:

With respect to a resin composition obtained by using polylactic acid “NW3001D”, manufactured by NatureWorks LLC (MW: 150,000, carboxyl group concentration: 22.1 equivalents/ton) as polylactic acid for evaluation, adding it in an amount such that the group of a hydrolysis regulator, reacting with the carboxyl group, was 33.15 equivalents/ton and melt kneading the mixture under a nitrogen atmosphere at a resin temperature of 190° C. and at a rotation rate of 30 rpm for 1 minute by using a Labo Plasto mill (manufactured by Toyo Seiki Seisaku-Sho, Ltd.), a carboxyl group concentration was measured, and the reactivity with an acidic group was determined according to the following equation.

Reactivity (%)=[{(Carboxyl group concentration of polylactic acid for evaluation)−(Carboxyl group concentration of resin composition)}/(Carboxyl group concentration of polylactic acid for evaluation)]×100

(14) Moist heat evaluation in high-temperature hot water:

A closed melting crucible (manufactured by OM Lab-Tech Co., Ltd., MR-28, capacity: 28 mL) preheated at 110° C. was charged with 300 mg of a resin composition and 12 mL of distilled water and hermetically sealed, and the crucible was allowed to stand within a hot air dryer (manufactured by Koyo Thermo Systems Co., Ltd., KLO-45M,) previously kept at a prescribed temperature (150° C., 170° C., or 190° C.)

After allowing the crucible to stand, a time when the temperature in the interior of the crucible reached a prescribed test temperature after the crucible was allowed to stand in the hot air dryer was defined as a point of time of starting the test, and at a point of time when a fixed period of time elapsed from this point of time of starting the test, the crucible was taken out from the hot air dryer.

The crucible taken out from the hot air dryer was air-cooled for 20 minutes and then cooled to ordinary temperature for 10 minutes by means of water cooling, and thereafter, the crucible was opened to recover the sample and water in the interior of the crucible. The sample and water in the interior of the crucible were subjected to filtration using a filter paper (in conformity with JIS P3801:1995, class 5A); the resin composition remaining on the filter paper was dried at 60° C. under a vacuum of 133.3 Pa or less for 3 hours; thereafter, the weight of the resin composition and the carboxyl group concentration were measured. The weight was determined according to the following equation.

Weight (%)=[(Weight of resin composition after treatment for a fixed period of time)/(Weight of resin composition at the initial stage)]×100

The evaluation of the fiber after the treatment with hot water at 170° C. was judged in terms of fused state, shape, and strength according to the following criteria.

### Fusion:

⊚: State where fusion is not observed through microscopic inspection, and dispersion of the slurry is good.

∘: State where fusion is not observed through visual inspection, and dispersion of the slurry is good.

X: State where a molten or fused block is observed through visual inspection.

### Shape:

⊚: State where the shape of the fiber is kept through microscopic inspection.

∘: State where the shape of the fiber is kept through visual inspection.

X: State where the shape of the fiber is collapsed through visual inspection.

### Strength:

⊚: State where even when strongly smashed by fingers, the fiber is not collapsed.

∘: State where when lightly smashed by fingers, the fiber is not collapsed.

X: State where when lightly smashed by fingers, the fiber is collapsed.

### Overall Evaluation:

In the above-described three judgements, the case where the fiber was judged with two or more marks of “⊚” was evaluated as “⊚”; the case where the fiber was judged with even one mark of “X” was evaluated as “X”; and other case was evaluated as “∘”.

Compounds used in the present Examples are hereunder explained.

### <Resin Containing, as a Main Component, a Water-Soluble Monomer and Having Autocatalysis (Component CC)>

The following polylactic acids were produced and used as the resin containing, as a main component, a water-soluble monomer and having autocatalysis (component CC).

### Production Example 5

### Poly(L-Lactic Acid) Resin (AA1)

To 100 parts by weight of L-lactide (manufactured by Musashino Chemical Laboratory, Ltd., optical purity: 100%), 0.005 parts by weight of tin octylate was added; the contents were allowed to react with each other under a nitrogen atmosphere at 180° C. for 2 hours by a reactor equipped with a stirring blade; phosphoric acid of 1.2 times by equivalent relative to the tin octylate was added; and thereafter, the remaining lactide was removed at 13.3 Pa, followed by chipping, thereby obtaining a poly(L-lactic acid) resin.

The obtained poly(L-lactic acid) resin had a weight average molecular weight of 120,000, a melting point (Tmh) of 175° C., and a glass transition point (Tg) of 55° C.

### Production Example 6

### Poly(L-Lactic Acid) Resin (AA2)

A poly(L-lactic acid) resin (AA2) was produced in the same manner as in Production Example 5, except for changing the weight average molecular weight to 200,000 as shown in Table 2.

### Production Example 7

### Poly(L-Lactic Acid) Resin (AA3)

Polylactic acid, “REVODE (registered trademark) 190” (MW: 215,000), manufactured by Zhejiang Haizheng Biological Material Co., Ltd. was designated as “AA3”.

### Production Example 8

### Poly(L-Lactic Acid) Resin (AA4)

A poly(L-lactic acid) resin (AA4) was produced in the same manner as in Production Example 5, except for changing the weight average molecular weight to 300,000 as shown in Table 2.

### Production Example 9

### Poly(L-Lactic Acid) Resin (AA5)

A poly(L-lactic acid) resin (AA5) was produced in the same manner as in Production Example 5, except for changing the weight average molecular weight to 100,000 as shown in Table 2.

### Production Example 10

### Poly(D-Lactic Acid) Resin (BB1)

The same operations as those in Production Example 5 were followed, except that in Production Example 9, D-lactide (manufactured by Musashino Chemical Laboratory, Ltd., optical purity: 100%) was used in place of the L-lactide, thereby obtaining a poly(D-lactic acid) resin.

The obtained poly(D-lactic acid) resin had a weight average molecular weight of 20,000, a melting point (Tmh) of 177° C., and a glass transition point (Tg) of 55° C.

### Production Example 11

### Poly(D-Lactic Acid) Resin (BB2)

The same raw material as in Production Example 7 was subjected to the same operations as in Production Example 5, thereby obtaining a poly(D-lactic acid) resin. The obtained poly(D-lactic acid) resin had a weight average molecular weight of 50,000, a melting point (Tmh) of 175° C., and a glass transition point (Tg) of 55° C.

### Production Example 12

### Poly(D-Lactic Acid) Resin (BB3)

The same raw material as in Production Example 7 was subjected to the same operations as in Production Example 5, thereby obtaining a poly(D-lactic acid) resin. The obtained poly(D-lactic acid) resin had a weight average molecular weight of 80,000, a melting point (Tmh) of 175° C., and a glass transition point (Tg) of 55° C.

### Production Example 13

### Poly(D-Lactic Acid) Resin (BB4)

The same raw material as in Production Example 7 was subjected to the same operations as in Production Example 5, thereby obtaining a poly(D-lactic acid) resin. The obtained poly(D-lactic acid) resin had a weight average molecular weight of 100,000, a melting point (Tmh) of 175° C., and a glass transition point (Tg) of 55° C.

### Production Example 14

### Poly(D-Lactic Acid) Resin (BB5)

The same raw material as in Production Example 7 was subjected to the same operations as in Production Example 5, thereby obtaining a poly(D-lactic acid) resin. The obtained poly(D-lactic acid) resin had a weight average molecular weight of 120,000, a melting point (Tmh) of 175° C., and a glass transition point (Tg) of 55° C.

### <Stereocomplex Polylactic Acid (Component CC)>

100 parts by weight in total of a polylactic acid resin consisting of 50 parts by weight of the poly(L-lactic acid) resin and 50 parts by weight of the poly(D-lactic acid) resin obtained in Production Examples 5 to 9 and Production Examples 10 to 14, respectively were mixed by a blender; thereafter, the mixture was dried at 110° C. for 5 hours and then supplied into a vent type double-screw extruder having a diameter of mmφ (manufactured by The Japan Steel Works, LTD., TEX30XSST); the resultant was melt extruded at a cylinder temperature of 250° C., a screw rotation rate of 250 rpm, a discharge amount of 5 kg/h, and a vent reduced pressure of 3 kPa; and immediately after the kneading zone, liquefied DIPC was added by a side feeder to form pellets thereby obtaining stereocomplex polylactic acid (component C). Various properties are shown in Table 2.

### <Hydrolysis Regulator (Component DD)>

The following additive was used as the hydrolysis regulator (component DD).

DD1: DIPC (carbodiimide compound, manufactured by Kawaguchi Chemical Industry Co., Ltd.)

As for the water resistance and the reactivity with an acidic group of the component DD, one having a water resistance of 95% or more and a reactivity with an acidic group of 50% or more was used for the Examples and Comparative Examples.

### Example 6

The raw materials were mixed in % by weight shown in Table 2 and melt kneaded under a nitrogen atmosphere at a resin temperature of 230° C. and at a rotation rate of 30 rpm for 1.5 minutes by using a Labo Plasto mill (manufactured by Toyo Seiki Seisaku-Sho, Ltd.), thereby obtaining a resin composition. The obtained resin composition was further spun to prepare a resin composition. The obtained resin composition was dehumidified and dried at 40° C. for 8 hours and then melted at 230° C. The resultant was discharged from a nozzle having an aperture of 0.2 mm and stretched 3.5 times at 65° C., followed by crystallization at 180° C. The obtained fiber was cut by a rotary cutter to obtain a short fiber having a fiber diameter of 50 μm and a length 8 mm. The evaluation results are shown in Table 3.

### Example 7

A resin composition was prepared in the same manner as in Example 6, except for changing BB1 to BB2 and evaluated in the same methods. The evaluation results are shown in Table 3.

### Example 8

A resin composition was prepared in the same manner as in Example 6, except for changing BB1 to BB3 and evaluated in the same methods. The evaluation results are shown in Table 3.

### Example 9

A resin composition was prepared in the same manner as in Example 6, except for changing BB1 to BB4 and evaluated in the same methods. The evaluation results are shown in Table 3.

### Example 10

A resin composition was prepared in the same manner as in Example 6, except for changing AA1 to AA4 and BB1 to BB6, respectively and evaluated in the same methods. The evaluation results are shown in Table 3.

### Comparative Example 6

A resin composition was prepared in the same manner as in Example 6, except for changing BB1 to BB5 and evaluated in the same methods. The evaluation results are shown in Table 3.

### Comparative Example 7

A resin composition was prepared in the same manner as in Example 6, except for changing BB1 to BB7 and evaluated in the same methods. The evaluation results are shown in Table 3.

### Example 11

A resin composition was prepared in the same manner as in Example 6, except for changing AA1 to AA2 and evaluated in the same methods. The evaluation results are shown in Table 3.

### Example 12

A resin composition was prepared in the same manner as in Example 6, except for changing AA1 to AA2 and BB1 to BB2, respectively and evaluated in the same methods. The evaluation results are shown in Table 3.

### Example 8

A resin composition was prepared in the same manner as in Example 6, except for changing A1 to A2 and B1 to B3, respectively and evaluated in the same methods. The evaluation results are shown in Table 3.

### Example 9

A resin composition was prepared in the same manner as in Example 6, except for changing AA1 to AA3 and BB1 to BB2, respectively and evaluated in the same methods. The evaluation results are shown in Table 3.

### Example 10

A resin composition was prepared in the same manner as in Example 6, except for changing AA1 to AA4 and BB1 to BB2, respectively and evaluated in the same methods. The evaluation results are shown in Table 3.

### Example 11

A resin composition was prepared in the same manner as in Example 6, except for changing AA1 to AA3 and BB1 to BB2, respectively and changing the amount of DD1 from 5% by weight to 10% by weight, and evaluated in the same methods. The evaluation results are shown in Table 3.

### Example 12

A resin composition was prepared in the same manner as in Example 6, except for changing AA1 to AA3 and BB1 to BB2, respectively and changing the amount of DD1 from 5% by weight to 20% by weight, and evaluated in the same methods. The evaluation results are shown in Table 3.

### Comparative Example 8

A resin composition was prepared in the same manner as in Example 6, except for changing AA1 to AA3 and BB1 to BB2, respectively and evaluated in the same methods. The evaluation results are shown in Table 3.

### Example 13

A resin composition was prepared in the same manner as in Example 6, except for changing AA1 to AA3 and BB1 to AA6, respectively and evaluated in the same methods. The evaluation results are shown in Table 3.

### Comparative Example 9

A resin composition was prepared in the same manner as in Example 6, except for using only AA3 (homopoly(L-lactic acid)) and evaluated in the same methods. The evaluation results are shown in Table 3.

TABLE 2

| | Example | Example | Example | Example | Example | Example | Example | Example | Example |
|---|---|---|---|---|---|---|---|---|---|
| Raw material | 6 | 7 | 8 | 9 | 10 | 11 | 12 | 13 | 14 |

Component AA

| Kind | | AA1 | AA1 | AA1 | AA1 | AA5 | AA2 | AA2 | AA2 | AA3 |
|---|---|---|---|---|---|---|---|---|---|---|
| Mw | | 120000 | 120000 | 120000 | 120000 | 100000 | 200000 | 200000 | 200000 | 215000 |
| Melting point | ° C. | 175 | 175 | 175 | 175 | 175 | 175 | 175 | 175 | 177 |
| Component BB | | | | | | | | | | |
| Kind | | BB1 | BB2 | BB3 | BB4 | BB6 | BB1 | BB2 | BB3 | BB2 |
| Mw | | 20000 | 50000 | 80000 | 100000 | 160000 | 20000 | 50000 | 80000 | 50000 |
| Melting point | ° C. | 168 | 176 | 176 | 176 | 174 | 168 | 176 | 176 | 176 |
| Component CC | | | | | | | | | | |
| AA/BB | wt | 1/1 | 1/1 | 1/1 | 1/1 | 1/1 | 1/1 | 1/1 | 1/1 | 1/1 |
| compounding | | | | | | | | | | |
| ratio | | | | | | | | | | |
| Mw | | 70000 | 85000 | 100000 | 110000 | 130000 | 110000 | 125000 | 140000 | 132500 |
| Melting point | ° C. | 224 | 228 | 226.5 | 225.5 | 224 | 223 | 227 | 224 | 228 |
| S | % | 100 | 100 | 100 | 95 | 90 | 100 | 100 | 95 | 100 |
| Component DD | | | | | | | | | | |
| Addition amount | wt % | 5 | 5 | 5 | 5 | 5 | 5 | 5 | 5 | 5 |

| | | | | | | | | |
|---|---|---|---|---|---|---|---|---|
| | Example | Example | Example | Example | Comparative | Comparative | Comparative | Comparative |
| Raw material | 15 | 16 | 17 | 18 | Example 6 | Example 7 | Example 8 | Example 9 |

Component AA

| Kind | | AA4 | AA3 | AA3 | AA3 | AA1 | AA1 | AA3 | AA3 |
|---|---|---|---|---|---|---|---|---|---|
| Mw | | 300000 | 215000 | 215000 | 215000 | 120000 | 120000 | 215000 | 215000 |
| Melting point | ° C. | 175 | 177 | 177 | 177 | 175 | 175 | 177 | 177 |
| Component BB | | | | | | | | | |
| Kind | | BB2 | BB2 | BB2 | AA6 | BB5 | BB7 | BB2 | — |
| Mw | | 50000 | 50000 | 50000 | 50000 | 120000 | 10000 | 50000 | — |
| Melting point | ° C. | 176 | 176 | 176 | 176 | 176 | 162 | 176 | — |
| Component CC | | | | | | | | | |
| AA/BB | wt | 1/1 | 1/1 | 1/1 | 1/1 | 1/1 | 1/1 | 1/1 | — |
| compounding | | | | | | | | | |
| ratio | | | | | | | | | |
| Mw | | 175000 | 132500 | 132500 | 132500 | 120000 | 65000 | 132500 | 215000 |
| Melting point | ° C. | 227 | 228 | 238 | 177 | 224.5 | 221 | 230 | 177 |
| S | % | 95 | 100 | 100 | — | 80 | 100 | 100 | — |
| Component DD | | | | | | | | | |
| Addition amount | wt % | 5 | 10 | 20 | 5 | 5 | 5 | 2 | 5 |

TABLE 3

| | Example | Example | Example | Example | Example | Example | Example | Example | Example |
|---|---|---|---|---|---|---|---|---|---|
| Item | 6 | 7 | 8 | 9 | 10 | 11 | 12 | 13 | 14 |

Forming condition

| Stretch ratio | Time | 3.5 | 3.5 | 3.5 | 3.5 | 3.5 | 3.5 | 3.5 | 3.5 | 3.5 |
|---|---|---|---|---|---|---|---|---|---|---|
| | s | | | | | | | | | |
| Heat setting | ° C. | 180 | 180 | 180 | 180 | 180 | 180 | 180 | 180 | 180 |
| temperature | | | | | | | | | | |
| Physical properties | | | | | | | | | | |
| Mw | | 70000 | 85000 | 100000 | 110000 | 130000 | 110000 | 125000 | 140000 | 132500 |
| Melting point | ° C. | 221 | 225 | 223.5 | 222.5 | 221 | 220 | 224 | 221 | 225 |
| Melting point in | ° C. | 191 | 195 | 193.5 | 192.5 | 191 | 190 | 194 | 191 | 195 |
| water | | | | | | | | | | |
| S | % | 100 | 100 | 100 | 100 | 100 | 100 | 100 | 100 | 100 |

| Hydrolysis properties | | | | | | | | | | |
|---|---|---|---|---|---|---|---|---|---|---|
| Hot water | Temperature | 170 | 170 | 170 | 170 | 170 | 170 | 170 | 170 | 170 |
| test | | | | | | | | | | |
| Evaluation | Fusion | ◯ | ⊚ | ⊚ | ◯ | ◯ | ◯ | ⊚ | ◯ | ⊚ |
| results | Shape | ◯ | ⊚ | ⊚ | ◯ | ⊚ | ◯ | ⊚ | ◯ | ⊚ |
| | Strength | ◯ | ◯ | ◯ | ◯ | ⊚ | ⊚ | ⊚ | ⊚ | ⊚ |

| | | | | | | | | | |
|---|---|---|---|---|---|---|---|---|---|
| Overall evaluation | ◯ | ⊚ | ⊚ | ◯ | ◯ | ◯ | ⊚ | ◯ | ⊚ |

| | | | | | | | | |
|---|---|---|---|---|---|---|---|---|
| | Example | Example | Example | Example | Comparative | Comparative | Comparative | Comparative |
| Item | 15 | 16 | 17 | 18 | Example 6 | Example 7 | Example 8 | Example 9 |

Forming condition

| Stretch ratio | Time | 3.5 | 3.5 | 3.5 | 3.5 | 3.5 | 3.5 | 3.5 | 3.5 |
|---|---|---|---|---|---|---|---|---|---|
| | s | | | | | | | | |
| Heat setting | ° C. | 180 | 180 | 180 | 180 | 180 | 180 | 180 | 180 |
| temperature | | | | | | | | | |
| Physical properties | | | | | | | | | |
| Mw | | 175000 | 132500 | 132500 | 132500 | 120000 | 65000 | 132500 | 107500 |
| Melting point | ° C. | 224 | 223 | 220 | 173 | 221.5 | 218 | 227 | 173 |
| Melting point in | ° C. | 194 | 193 | 190 | 143 | 191.5 | 188 | 197 | 143 |
| water | | | | | | | | | |
| S | % | 100 | 100 | 100 | 100 | 98 | 100 | 100 | — |

| Hydrolysis properties | | | | | | | | | |
|---|---|---|---|---|---|---|---|---|---|
| Hot water | Temperature | 170 | 170 | 170 | 150 | 170 | 170 | 170 | 150 |
| test | | | | | | | | | |
| Evaluation | Fusion | ⊚ | ⊚ | ⊚ | ◯ | X | X | ◯ | X |
| results | Shape | ⊚ | ⊚ | ⊚ | ◯ | ◯ | ◯ | X | ◯ |
| | Strength | ⊚ | ⊚ | ⊚ | ◯ | ◯ | X | X | X |

| | | | | | | | | |
|---|---|---|---|---|---|---|---|---|
| Overall evaluation | ⊚ | ⊚ | ⊚ | ◯ | X | X | X | X |

From the foregoing results, it is understood that in the case of using the component D satisfying both the water resistance and the reactivity with an acidic group as the hydrolysis regulator, the resin composition can realize the desired performance in high-temperature hot water, namely the resin composition is quickly decomposed after keeping the weight and shape of the resin in high-temperature hot water for a fixed period of time. In addition, it is understood that in the case of using BB3 to BB6, each of which does not satisfy at least one of the water resistance and the reactivity with an acidic group, the decomposition of the resin composition is so quick that the sufficient performance is not obtained.

Incidentally, in the Examples, with respect to the sample in which the weight after the treatment in high-temperature hot water was less than 1%, judging that the decomposition was sufficiently advanced, the measurement of carboxyl group concentration and the moist heat evaluation in high-temperature hot water for along time were not performed. The portion falling under such a case was expressed as “-” in Table 2.

The resin composition of the present invention exhibits a desired performance in the excavation technology in the oil field and can be suitably used as resin molded articles of this application, especially fibers.

1. A resin composition containing polylactic acid containing a stereocomplex crystal phase (component A), an isotactic average chain length (L₁) of which is 50 to 200, in an amount of 70 to 97% by weight on a basis of the whole weight, the resin composition further containing a hydrolysis regulator (component B) in an amount of 3 to 20 parts by weight on a basis of the whole weight and simultaneously satisfying the following requirements (A) to (C):
(A) MFR is in the range of 60 to 300;
(B) a melting point in water (Tmsw) is 188° C. or higher; and
(C) in hot water at 188° C., a weight of a water-insoluble matter of the resin composition after 1 hour is 50% or more, and a weight of a water-insoluble matter of the resin composition after 6 hours is less than 50%.

2. The resin composition according to claim 1, further satisfying the following requirement (D):
(D) a weight average molecular weight of the polylactic acid containing a stereocomplex crystal phase (component A) is in the range of 70,000 to 300,000.

3. The resin composition according to claim 1, wherein a stereocomplex crystallization degree (S) is 5% or more.

4. The resin composition according to claim 1, wherein the polylactic acid containing a stereocomplex crystal phase (component A) is a composition of poly(L-lactic acid) having an optical purity of 98% or more and poly(D-lactic acid) having an optical purity of 98% or more.

5. The resin composition according to claim 1, wherein a stereocomplex crystallization rate (Cs) is 10 to 99.9%.

6. The resin composition according to claim 1, wherein the hydrolysis regulator (component B) is a carbodiimide compound.

7. The resin composition according to claim 6, wherein the hydrolysis regulator (component B) is a carbodiimide compound represented by the following formula: 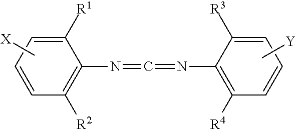
wherein
each of R¹ to R⁴ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure.

8. The resin composition according to claim 7, wherein the hydrolysis regulator (component B) is bis(2,6-diisopropylphenyl)carbodiimide.

9. A molded article comprising the resin composition according to claim 1.

10. The molded article according to claim 9, wherein a shape thereof is a fiber.

11. A resin composition containing a resin containing a water-soluble monomer and having autocatalysis (component CC), which is obtained by mixing, as a high molecular weight component, an aliphatic polyester (component AA) having a weight average molecular weight of 120,000 to 1,000,000 and, as a low molecular weight component, an aliphatic polyester (component BB) having a weight average molecular weight of 20,000 to 100,000 in a compounding ratio of (AA)/(BB) of 90/10 to 10/90, and a hydrolysis regulator (component DD), the resin composition satisfying any one of the following AA1 to AA3:
AA1: in hot water at an arbitrary temperature of 135° C. to 160° C., after 3 hours, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less;
AA2: in hot water at an arbitrary temperature of 160° C. to 180° C., after 2 hours, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less; and
AA3: in hot water at an arbitrary temperature of 180° C. to 220° C., after 1 hour, not only a resin composition-derived acidic group concentration is 30 equivalents/ton or less, but also a weight of a water-insoluble matter of the resin composition is 50% or more, and after 24 hours, the weight of the water-insoluble matter of the resin composition is 50% or less.

12. The resin composition according to claim 11, wherein the component DD has a water resistance at 120° C. of 95% or more and a reactivity with an acidic group at 190° C. of 50% or more.

13. The resin composition according to claim 11, wherein in hot water at an arbitrary temperature of 135° C. to 220° C., after 100 hours, the weight of the water-insoluble matter of the resin composition is 10% or less.

14. The resin composition according to claim 11, wherein a heat deformation temperature of the resin composition is 135° C. to 300° C.

15. The resin composition according to claim 14, wherein a main chain of the component CC is composed mainly of a lactic acid unit represented by the following formula:

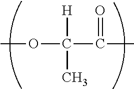

16. The resin composition according to claim 15, wherein the component CC contains a stereocomplex phase formed of poly(L-lactic acid) and poly(D-lactic acid).

17. The resin composition according to claim 16, having a melting point in water of 190° C. or higher.

18. The resin composition according to claim 11, wherein the component DD is a carbodiimide compound.

19. The resin composition according to claim 18, wherein the component DD is a carbodiimide compound represented by the following formula: 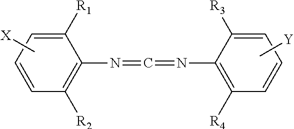
wherein
each of R₁ to R₄ is independently an aliphatic group having 1 to 20 carbon atoms, an alicyclic group having 3 to 20 carbon atoms, an aromatic group having 5 to 15 carbon atoms, or a combination thereof, and may contain a hetero atom; each of X and Y is independently a hydrogen atom, an aliphatic group having 1 to 20 carbon atoms, an alicyclic group having 3 to 20 carbon atoms, an aromatic group having 5 to 15 carbon atoms, or a combination thereof, and may contain a hetero atom; and the respective aromatic rings may be bonded to each other via a substituent to form a cyclic structure.
